(19) United States
(12) Patent Application Publication
(10) Pub. No.: US 2025/0128943 A1
(43) Pub. Date: Apr. 24, 2025

(54) PROCESS FOR THE PRODUCTION OF HYDROGEN AND CARBON BY CATALYTIC NON-OXIDATIVE DECOMPOSITION OF HYDROCARBONS

(71) Applicants: TOTALENERGIES ONETECH, Courbevoie (FR); UNIVERSITÉ DE STRASBOURG-UNISTRA, Strasbourg Cedex (FR); CENTRE NATIONAL DE LA RECHERCHE SCIENTIFIQUE-CNRS, Paris Cedex 16 (FR)

(72) Inventors: Loïc FRANCKE, Pau Cedex (FR); Christophe BENQUET, Pau Cedex (FR); Jean-Pierre DATH, Seneffe (BE); Lai TRUONG PHUOC, Strasbourg (FR); Cuong PHAM-HUU, Strasbourg (FR); Jean-mario NHUT, Plobsheim (FR)

(73) Assignees: TOTALENERGIES ONETECH, Courbevoie (FR); UNIVERSITÉ DE STRASBOURG-UNISTRA, Strasbourg Cedex (FR); CENTRE NATIONAL DE LA RECHERCHE SCIENTIFIQUE-CNRS, Paris Cedex 16 (FR)

(21) Appl. No.: 18/696,059

(22) PCT Filed: Oct. 26, 2022
(86) PCT No.: PCT/EP2022/079902

§ 371 Date: Mar. 27, 2024

(30) Foreign Application Priority Data
Oct. 27, 2021 (EP) 21306495.9

(51) Int. Cl. C01B 3/26; C01B 32/05

(52) U.S. Cl. CPC C01B 3/26; C01B 32/05; C01B 2203/0277; C01B 2203/0855; C01B 2203/1041; C01B 2203/1082; C01B 2203/1235; C01B 2203/1614

(57) ABSTRACT

The present invention relates to a process and a system for the production of hydrogen and carbon by catalytic non-oxidative decomposition of hydrocarbons, such as saturated C₁₊ hydrocarbons, such as methane, in the presence of a fresh or a spent catalyst composition comprising at least one carbon catalyst. The process of the invention is characterised in that the fresh or spent catalyst composition is heated by means of induction heating to a temperature comprised between 500° C. and 1100° C. The catalyst compositions as applied in accordance with the invention comprise, and preferably consist of, (I) a first component, wherein said first component is selected from one or more non-porous carbon catalysts and/or one or more porous carbon catalysts; and (II) optionally, a second component, wherein said second component consists of a non-carbon material, and preferably is a ceramic or zeolitic support material. Further provided are a spent catalyst obtained when carrying out a process of the invention, and uses thereof.

### FIELD OF THE INVENTION

The present invention relates to a process and a system for the production of hydrogen and carbon by catalytic non-oxidative decomposition of light hydrocarbons, in particular decomposition of C₁₋₁₂ hydrocarbons such as saturated C₁₋₁₂ hydrocarbons, and especially methane. The present process and system are characterised in that they involve an endothermic catalytic chemical reaction, wherein the heat required for carrying out the catalytic decomposition reaction is provided by heating a catalyst composition by means of induction heating. The present invention is further characterised in that the catalytic decomposition reaction is carried out in the presence of catalyst compositions comprising one or more porous and/or non-porous carbon catalysts, optionally in combination with a non-carbon material, such as a ceramic or zeolitic support material.

### BACKGROUND

Hydrogen is one of the most requested chemical compounds today, in view of its wide-spread application in various technical fields including the chemical and pharmaceutical industry. Hydrogen may be mixed with natural gas, typically in amounts of between 6 and 55%, for use in domestic heating applications. Recently there also has been increased interest in the use of hydrogen as fuel in transportation.

There are four main sources for the commercial production of hydrogen: natural gas, oil, coal, and electrolysis. The majority of hydrogen is produced from fossil fuels by steam reforming of natural gas, partial oxidation of methane, and coal gasification. Other methods of hydrogen production include biomass gasification, methane pyrolysis, and electrolysis of water.

Many conventional hydrogen production processes applied today are disfavoured because they emit significant amounts of carbon dioxide; for instance due to the use of fossil fuel feedstocks. For instance, at present, hydrogen is mainly produced by means of a steam methane reforming (SMR) process, a production process in which high-temperature steam is used to produce hydrogen from a methane source, such as natural gas. The process consists of heating the gas to between 700-1100° C. in the presence of steam and a nickel catalyst. The resulting endothermic reaction breaks up the methane molecules and forms carbon monoxide CO and hydrogen (H₂). The carbon monoxide gas can then be passed with steam over iron oxide or other oxides and undergo a water gas shift reaction to obtain further quantities of hydrogen. The downside to this process is that its by-products are major atmospheric release of CO₂, CO and other greenhouse gases.

Other methods for producing hydrogen, involve catalytic decomposition or conversion processes of hydrocarbons, such as contained in natural gas, such as methane. Known catalytic decomposition processes include for instance processes that are based on the use of metal-based catalysts supported on a crystalline support, e.g. Mo or Fe on MFI or MWW-zeolite. In such processes, methane, the main component of natural gas, may be broken down into hydrogen, and carbon species are co-formed. However, due to the high thermodynamic stability of hydrocarbons, severe reaction conditions including high temperatures are required to operate such catalytic processes and to ensure obtaining an attractive product yield in these prior art processes. This requires the use of large amounts of gas for gas burners; such that CO₂ emissions remain significant. Moreover, carbon formation and deposits thereof on the catalysts applied during the reaction leads to an irreversible deactivation over time of these catalysts. It is further known that solid carbon deposits produced during conventional methods of catalytic decomposition of gas phase hydrocarbons such as methane may foul reactors, catalysts, and gas handling systems. This shortens useful reactor and catalyst performance lifetimes. Consequently, these prior art conversion processes require catalyst regeneration since catalyst activity is reduced due to blocking of active sites by carbon deposition. Catalyst regeneration processes often involve a need to combust the spent catalyst, typically at high temperatures, to remove the carbon produced, resulting in further CO/CO₂ emissions that are undesired for both economic and environmental reasons. Moreover, currently available metal-based catalysts and/or reaction methods for hydrocarbon decomposition into hydrogen have a number of drawbacks, such as expense, environmental incompatibility, difficulty in separation from the reaction product, complex reaction conditions, lack of selectivity, poor conversion or decomposition rates, etc. The disposal of the end of life metal-based catalysts also poses problems from an environmental point-of-view.

In view of the above, it is an aim of the present invention to provide a more sustainable process for producing hydrogen, which overcomes at least some of the above-mentioned drawbacks of prior art processes.

It is an object of the present invention to provide an improved process for producing hydrogen by means of catalytic decomposition of hydrocarbons, such as saturated C₁₋₁₂ hydrocarbons, and in particular of methane.

It is further an object of the present invention to provide an improved method for producing hydrogen by the catalytic decomposition of a hydrocarbon feed stream with minimal resulting production of carbon oxides.

It is also an object of the present invention to provide an improved catalytic process for producing hydrogen, which requires less energy and/or which has a smaller carbon footprint than prior art hydrogen production processes.

It is also an object of the present invention to provide an improved catalytic process for producing hydrogen and a carbon by-product, wherein the later can be valorised.

### SUMMARY OF THE INVENTION

It has now been found that the above objectives can be attained either individually or in any combination by using the specific and well-defined process as disclosed herein for the production of hydrogen and carbon by catalytic decomposition of hydrocarbon under non-oxidative conditions.

In accordance with the present subject matter there is provided a process for catalytic thermal decomposition over a catalyst composition of light hydrocarbons, such as methane and other light hydrocarbons, to produce a hydrocarbon stream, which is substantially carbon oxide free, and solid carbon.

In accordance with certain embodiments of the present invention, a process is provided for the production of hydrogen, carbon, and optionally hydrocarbons such as C₂₊ hydrocarbons, by catalytic non-oxidative decomposition of a reaction gas comprising a hydrocarbon or mixtures of hydrocarbons, such as a saturated C₁₊ hydrocarbon or mixtures thereof, in the presence of a “fresh” carbon-based catalyst composition, preferably a fresh carbon-based catalyst composition that has been activated as defined herein.

In accordance with certain embodiments of the present invention, a process is also provided for the production of hydrogen, carbon and optionally hydrocarbons such as C₂₊ hydrocarbons, by catalytic non-oxidative decomposition of a reaction gas comprising a hydrocarbon or mixtures of hydrocarbons, such as a saturated C₁₊ hydrocarbon or mixtures thereof, in the presence of a “spent” (recycled) carbon-based catalyst composition, and preferably a spent carbon-based catalyst composition that has been prepared starting from a fresh or from (another) spent catalyst composition as defined herein.

Decomposition Process with a Fresh Catalyst Composition

In a first aspect of the invention, the present invention provides processes for the production of hydrogen and carbon, and optionally hydrocarbons such as C₂₊ hydrocarbon(s), by catalytic non-oxidative decomposition of hydrocarbon(s), such as saturated C₁₊ hydrocarbon(s), in the presence of a catalyst composition, especially a fresh catalyst composition, comprising at least one carbon catalyst as defined herein.

In certain embodiments, the present invention provides a process for the production of hydrogen, carbon and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, wherein the process comprises the steps of:
a) supplying a catalyst composition to a reaction zone, wherein said catalyst composition comprises at least one carbon catalyst;
b) heating said catalyst composition in said reaction zone to a temperature comprised between 500° C. and 1100° C., by means of induction heating;
c) activating said heated catalyst composition by bringing said heated catalyst composition into contact with said reaction gas during an activation period of at least 5 hours, such as at least 6, 8, 10, 12, 15, 20, 25, 30, 35 hours, and
d) decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time.

In certain embodiments of the present invention, the process further comprises the steps of
e) recovering at least a portion of said catalyst composition from said reaction zone after step c) and/or step d), thereby obtaining a spent catalyst, and
f) optionally supplying the spent catalyst as catalyst composition to step a) of said process.

It is preferred that the spent catalyst composition is mechanically treated to reduce the size of the spent catalyst before supply thereof to step a) of said process.

It is also preferred that the spent catalyst is not heated before supply thereof to step a) of said process.

In certain other embodiments, the present invention also provides a process for the production of hydrogen and carbon by catalytic non-oxidative decomposition of saturated C₁₊ hydrocarbons, wherein the process comprises the steps of:
a) supplying a catalyst composition to a reaction zone, wherein said catalyst composition comprises at least one carbon catalyst;
b) heating said catalyst composition in said reaction zone; and
c) bringing a reaction gas comprising saturated C₁₊ hydrocarbons into contact with said heated catalyst composition in said reaction zone, thereby decomposing said saturated C₁₊ hydrocarbons into hydrogen and carbon;
characterised in that said catalyst composition is heated in said reaction zone to a temperature comprised between 500° C. and 1100° C. by means of induction heating.

In certain preferred embodiments of the above process the reaction zone(s) consists of one or more fixed bed reactors.

The processes of the invention provide a sustainable production of hydrogen and carbon, without an excessive production of CO₂, by thermo-catalytic decomposition of light hydrocarbon, in particular saturated C₁₊ hydrocarbons, such as saturated C₁₋₁₂ hydrocarbons, over a catalyst composition comprising one or more carbon catalysts, in the absence of air and/or water.

A process of the invention is in particular characterised in that the catalyst compositions as applied in the thermal decomposition are heated by an inductive heating mode. In other words, in accordance with the present invention, a process is described involving the direct heating of a reaction zone comprising a catalyst composition as defined therein by heating the catalyst composition, contained within this reaction zone, by means of induction heating.

A process of the invention is also characterised in that it is carried out over a specific type of catalyst compositions, i.e. catalyst compositions comprising at least one carbon based catalyst.

In certain embodiments of a process of the invention, a catalyst composition as applied in the present process comprises at least one carbon catalyst, wherein said carbon catalyst has a BET surface area of at most 2500 m²/g, such as at most 2000 m²/g, or at most 1750 m²/g, or at most 1000 m²/g, or between 0.1 and 2000 m²/g, or between 0.1 and 1000 m²/g, or between 0.1 and 700 m²/g, as determined by ASTM-D-3663 (2020).

In certain embodiments of a process of the invention, a catalyst composition as applied in the present process comprises:
(I) A first component, wherein said first component is selected from one or more non-porous carbon catalysts and/or one or more porous carbon catalysts; and
(II) Optionally, a second component, wherein said second component consists of a non-carbon material, and preferably is a ceramic or zeolitic support material.

A preferred embodiment of a catalyst composition for use in a process of the invention, comprises:
(1) A first component, wherein said first component is selected from one or more non-porous carbon catalysts having a BET surface area of at most 5.0 m²/g, and/or one or more porous carbon catalysts having a BET surface area of more than 5.0 m²/g, and
(II) Optionally, a second component, wherein said second component consists of a ceramic or zeolitic support material, and has a BET surface area of between 0.1 and 600 m²/g,
wherein BET surface area is determined by ASTM-D-3663 (2020).

In certain embodiments, the present invention therefore provides a process, wherein the catalyst composition comprises one or more carbon catalyst(s) which is (are) non-porous carbon catalyst(s), as defined herein, and one or more carbon catalyst(s) which is (are) porous carbon catalyst(s), as defined herein.

In certain embodiments, the present invention therefore provides a process, wherein the catalyst composition comprises one or more carbon catalyst(s) which is (are) non-porous carbon catalyst(s), as defined herein, optionally in combination with a second component which is a non-carbon material as defined herein.

In certain embodiments, the present invention therefore provides a process, wherein the catalyst composition comprises one or more carbon catalyst(s) which is (are) porous carbon catalyst(s), as defined herein, optionally in combination with a second component which is a non-carbon material as defined herein.

In accordance with the invention a catalyst composition as defined herein may be provided in a reaction zone or reactor in one or more catalyst beds, such as fixed catalyst bed(s) or moving catalyst bed(s) (e.g. with transported catalyst bed). Preferably, a catalyst composition as applied in the present process is provided in one or more fixed catalyst beds.

In certain embodiments, a catalyst composition as defined herein may be provided in a two (or more) reactors. A catalytic set-up could also be constituted by a double-reactor set-up; in which one reactor is operated in a fixed-bed while in the second reactor is operated with a moving catalyst, or vice versa. Such configuration allows to operate the process with higher safety, in view e.g. of the extremely fast response of the induction heating with respect to the laser pyrometer controller.

The Applicants have shown that in accordance with a process of the invention, it is possible to use induction heating to produce hydrogen and carbon by catalytic non-oxidative decomposition of hydrocarbons such as saturated C₁₊ hydrocarbons, for instance methane, under much milder reaction conditions, of e.g. temperature and pressure that those usually applied in conventional combustive processes. In accordance with the invention, induction heating is directly targeted to the catalyst composition or catalyst bed applied in the process.

This contributes to a reduction of the heat input for the overall process, as compared to combustion processes operated e.g. with gas-fired furnaces wherein heat loss through stepwise transfer is relatively high. Moreover, by using induction heating, electricity-driven process, to perform the thermal decomposition reaction, the process yields much lower CO/CO₂ emissions than conventional combustive processes.

The combination of the inductive heating technology with the use of a catalyst composition as defined herein, is particularly beneficial, as it allows to carry out the decomposition reaction at a high selectivity towards hydrogen production. A process of the invention further advantageously permits to use diverse hydrocarbon sources, e.g. mono-component gases, as well as gas mixtures such as fossil natural gas and/or renewable sources of natural gas.

Moreover, the Applicants have surprisingly shown that using an inductive heating mode to heat the catalyst compositions as applied in the present process permits to increase the catalytic performance of the applied catalyst compositions. Hence, in contrast to conventional prior art processes, the process carried out in accordance with the present invention and using induction heating to perform thermal decomposition does not lead to a deactivation over time of the used catalyst compositions.

During the decomposition reaction of the invention, carbon formed by decomposition of the hydrocarbon, will be fixed to the surface or in the porosity of the catalyst applied in the catalyst composition. The present invention has advantageously shown that it is possible to exploit this formed/deposited carbon, e.g., directly as metal-free catalysts for the targeted process.

Therefore, a process according to the invention for the production of hydrogen and carbon by catalytic non-oxidative decomposition of hydrocarbons such as saturated C₁₊ hydrocarbons may comprise the further step of recovering at least a portion of said catalyst composition from said reaction zone, preferably after said activation period, thereby obtaining a spent catalyst, and optionally supplying said spent catalyst to step a) of a process according to the invention.

The Applicants have found that the carbon that is formed/deposited on the macroscopic structure of the catalyst composition applied in the process gives beneficial properties to the spent catalyst, especially in terms of catalytic performance. It was shown in this invention that a spent catalyst, recovered from a process as defined herein, can immediately be used as effective and highly active carbon-based catalyst in a hydrocarbon decomposition process without having to subject the spent catalyst to a chemical and/or thermal pre-treatment after its recovery, prior to its use. In certain embodiments, a mechanical pre-treatment of the spent catalyst may be done to further improve its catalytic performance. The present process thus allows a spent catalyst to be recycled in the reaction, e.g. by using the spent catalyst itself as a carbon catalyst in a hydrocarbon decomposition reaction.

The implementation of the particular type of catalyst compositions as defined herein, in combination with the inductive heating mode applied to heat these catalyst compositions, has lead in the present invention to a decomposition process for producing hydrogen which is particularly effective from an energetic point of view, e.g. requiring lower reaction temperatures; allowing the use renewable energy sources for providing the required electricity; which is particularly selective towards hydrogen production (high conversion/decomposition yield are obtained), and which is sustainable, e.g. providing less CO/CO₂ emissions, a lower carbon footprint, and allowing to even to re-cycle and re-use the spent catalyst composition in the same process without pre-treatment; thereby also reducing the cost of catalyst supply to the process. For instance, a single batch of carbon catalyst can be used for initiating the process and will be used for the rest of the process without the need for adding large amount of fresh catalyst.

Decomposition Process with a Spent Catalyst Composition

In another aspect, the invention also provides a process for the production of hydrogen and carbon and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent carbon-based catalyst composition, comprising at least one carbon catalyst.

In certain embodiments, the present invention provides a process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
a) supplying a spent catalyst to a reaction zone, said spent catalyst composition comprises at least one carbon catalyst,
b) heating said spent catalyst in said reaction zone to a temperature comprised between 500° C. and 1100° C. by means of induction heating; and
c) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone.

In certain preferred embodiments, the spent catalyst supplied in step a) is prepared by carrying out a process as defined herein, and preferably starting from a fresh catalyst composition as defined herein.

In certain other preferred embodiments, the spent catalyst supplied in step a) is prepared starting from another spent catalyst as defined herein. In other words, the present process also encompasses the recycling of a spent catalyst, as prepared or obtained in accordance with the present invention, as starting component for preparing yet another spent catalyst.

In certain embodiments, the process of the invention involves a process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
a) preparing a spent catalyst by a preparation process comprising the steps of:
   a1) supplying a catalyst composition to a reaction zone, wherein said catalyst composition comprises at least one carbon catalyst;
   a2) heating said catalyst composition in said reaction zone to a temperature comprised between 500° C. and 1100° C. by means of induction heating;
   a3) activating said heated catalyst composition by bringing said heated catalyst composition into contact with said reaction gas during an activation period of at least 5 hours, such as at least 6, 8, 10, 12, 15, 20, 25, 30, 35 hours,
   a4) optionally decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time,
   a5) recovering at least a portion of the catalyst composition from said reaction zone after step a3) and/or a4), thereby obtaining a spent catalyst, and optionally subjecting the spent catalyst to a mechanical treatment to reduce the size of the spent catalyst, and
b) supplying the spent catalyst to a reaction zone;
c) heating the spent catalyst in the reaction zone by means of induction heating to a temperature comprised between 500° C. and 1100° C.; and
d) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone.

In certain preferred embodiments of the above process, the catalyst composition as supplied in step a1) is a fresh catalyst composition as defined herein.

In certain preferred embodiments of the above process, the catalyst composition as supplied in step a1) is a spent catalyst comprising at least one carbon catalyst as defined herein as defined herein In other words, in certain preferred embodiments of the present invention, a spent catalyst as obtained with a process as described herein may be recycled/re-used one or several times, e.g. to prepare further spent catalysts and/or for application in hydrogen decomposition reactions as disclosed herein.

The Applicants found that unexpectedly a spent catalyst as described and prepared herein, shows immediate significant catalyst activity. When applied as a catalyst in a hydrocarbon decomposition reaction as described herein, such spent catalyst is able to catalyse a hydrocarbon (e.g. methane) decomposition into hydrogen and carbon requiring minimal to no catalyst activation. In other words, a decomposition process as provided herein wherein a spent catalyst is applied has limited to no activation period. It is also particularly advantageous that the spent catalyst can immediately be used as effective and highly active carbon-based catalyst in a hydrocarbon decomposition process without the need to subject the spent catalyst to a chemical and/or thermal pre-treatment after its recovery, prior to its use. It is unexpected that a spent catalyst provides instant and even better conversion activities than its fresh counterpart.

In certain preferred embodiments of the above process, the process involves a further step e) comprising the removal of the spent catalyst from the reaction zone after step d), treatment of the removed spent catalyst to reduce the size thereof, and re-supply of the treated spent catalyst to step b) of said process.

In accordance with the invention, the Applicants have also shown that the activity of the spent catalyst during the decomposition reaction does not substantially decrease over time. Hence, a spent catalyst may be used in a process of the invention for a long reaction time. However, it may be advantageous, from an operational point of view to regularly reshape (reduce the size) of the spent catalyst. To that end, the spent catalyst may be removed from the reaction zone, and treated to reduce its size, e.g. by grinding, crushing, breaking it into smaller pieces, etc., before re-supplying it to the reaction zone. Such regular treatment (re-shaping) of the spent catalyst is beneficial to avoid that the catalyst bed would undergo plugging by solid carbon deposit. It may be noted however, that such regular treatment of the spent catalyst to reduce its size is beneficial from a operating point of view (to avoid reactor plugging, and is not triggered by a decrease in catalytic activity.

In certain preferred embodiments of the above process the reaction zone(s) consists of one or more fixed bed reactors.

### Spent Catalyst

In another aspect, the invention relates to a spent catalyst obtained or obtainable by carrying out a process according to the invention.

In certain preferred embodiments, a spent catalyst according to the invention has a metal concentration which is less than 5000 ppm, or less than 3000 ppm, or less than 2000 ppm, or less than 1000 ppm, or less than 500 ppm, or less than 300 ppm, or less than 100 ppm, or less than 50 ppm based on the total weight of the spent catalyst.

In certain preferred embodiments, a spent catalyst according to the invention has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the spent catalyst.

Preferably the spent catalyst is metal-free.

In certain preferred embodiments, a spent catalyst according to the invention has a BET surface area of between 0.1 and 100 m²/g, preferably of between 0.1 and 50 m²/g, as determined by ASTM-D-3663 (2020).

In certain preferred embodiments, a spent catalyst according to the invention has a Raman spectrum, as determined by Raman Spectroscopy using an excitation wavelength of about 532 nm and exciting laser power of about 100 milliwatt (mW); showing a first peak (D peak) at a wavenumber of about 1350 cm⁻¹ and a second peak (G peak) at a wavenumber from about 1585 to about 1600 cm⁻¹, and wherein said spent catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.

In certain preferred embodiments, a spent catalyst according to the invention has an electric resistivity of between 10⁻⁷ and 10² ohm·m at 20° C. as determined by ASTM C611-98 (2016).

### Use of Spent Catalyst

In yet another aspect, the present invention also relates to the use of a spent catalyst as defined herein, or as obtained by carrying out a process as defined herein, as a carbon catalyst. In preferred embodiments, the invention relates to the use of a spent catalyst as defined herein, or obtained by carrying out a process as defined herein, as a carbon catalyst in a catalytic non-oxidative hydrocarbon decomposition process, preferably in a catalytic non-oxidative hydrocarbon decomposition process for decomposing hydrocarbon or mixtures thereof, such as saturated C₁₊ hydrocarbons, e.g. such as methane, into hydrogen and carbon, and optionally hydrocarbons such as C₂₊ hydrocarbon(s), and more preferably in a catalytic non-oxidative hydrocarbon decomposition process as defined herein.

In another embodiments, the present invention also relates to the use of a spent catalyst as defined herein, or as obtained by carrying out a process as defined herein, for preparing another spent catalyst. System

In still another aspect, the present invention also provides a system for producing hydrogen and carbon by catalytic non-oxidative decomposition of hydrocarbons as defined herein, such as saturated C₁₊ hydrocarbons, wherein the system comprises:
at least one reaction zone configured to receive a catalyst composition, and preferably comprising a fixed and/or moving catalyst bed for containing said catalyst composition;
at least one inlet line for feeding a reaction gas comprising of hydrocarbons as defined herein, such as saturated C₁₊ hydrocarbons, and preferably comprising methane, into said reaction zone;
at least one flow controlling means for controlling reaction gas flow rate to the reaction zone;
at least one outlet line for recovering the reaction product stream and for separation of hydrogen from the unreacted hydrocarbon or some other hydrocarbons formed during the process and present in this stream;
at least one outlet line for recovering hydrogen from said reaction zone;
at least one induction heating device configured for inductively heating a catalyst composition contained within said reaction zone to a reaction temperature effective for the non-oxidative decomposition of hydrocarbons as defined herein, such as saturated C₁₊ hydrocarbons into hydrogen and carbon in the presence of said catalyst composition;
at least one temperature setting device for regulating the set temperature of the reaction;
optionally, at least one temperature measuring device for determining the reaction temperature;
optionally, at least one heating device for pre-heating the reaction gas before entering said reaction zone; and
optionally, at least one recovery unit for recovering from said reaction zone at least a portion of the catalyst composition spent during said non-oxidative decomposition.

The independent and dependent claims set out particular and preferred features of the invention. Features from the dependent claims may be combined with features of the independent or other dependent claims as appropriate.

The present invention will now be further described. In the following paragraphs, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE FIGURES

FIG. 1 represents catalytic performance of a porous carbon catalyst (MESOC+; 1 mm) as applied during methane decomposition in accordance with example 1 (first experiment), wherein FIG. 1A represents catalytic activity, expressed as methane conversion, product yields, and selectivity towards hydrogen as a function of the reaction duration, FIG. 1B represents hydrogen production as a function of temperature conditions and reaction time, and FIG. 1C represents hydrogen production and power supplied by the induction heating device with time on stream.

FIG. 2 represents catalytic performance of a porous carbon catalyst (MESOC+; 1 mm) as applied during methane decomposition in accordance with example 1 (second experiment), wherein FIG. 2A represents catalytic activity, expressed as methane conversion, product yields, and selectivity towards hydrogen as a function of the reaction duration, FIG. 2B represents hydrogen production as a function of temperature conditions and reaction time, and FIG. 2C represents hydrogen production and power supplied by the induction heating device with time on stream.

FIG. 3 represents Raman analyses performed on the fresh catalyst (MESOC+; 1 mm) and spent catalyst applied in example 1 (first experiment—35 h) and example 1 (second experiment—26 h).

FIG. 4 represents SEM analyses performed on the spent porous carbon catalyst (MESOC+; 1 mm) as obtained in example 1, i.e. after catalytic methane decomposition at 800° C. FIG. 4A represents a low-resolution SEM image showing the extruded carbon components of the spent catalyst that are interconnected to each other by solid carbon structures that were formed during the decomposition reaction. FIG. 4B-C show solid carbon structures deposited on the surface of the spent catalyst. FIG. 4D-F are SEM images of a section of the spent catalyst (in the form of extruded components) showing a structure which is different from the structure of the solid carbon deposited on the surface of the catalyst during the reaction.

FIG. 5 represents catalytic performance of a spent porous carbon catalyst as applied in example 2 (catalyst R1—recycled spent MESOC+; 1 mm), wherein FIG. 5A represents catalytic activity, expressed as methane conversion, product yields, and selectivity towards hydrogen as a function of the reaction duration, FIG. 5B represents hydrogen production as a function of temperature conditions and reaction time, and FIG. 5C represents hydrogen production and power supplied by the induction heating device with time on stream.

FIG. 6 represents TGA analyses performed on a fresh catalyst (MESOC+; 1 mm), and on the spent catalyst of example 1 (=R0 spent catalyst) and example 2 (=R1 spent catalyst).

FIG. 7 represents catalytic performance of a spent porous carbon catalyst as applied in example 3 (catalyst R2+R2 catalyst was produced by breaking down the R0 spent catalyst of example 1; and the fraction with size between 0.2 to 0.8 mm was used for the experiment in example 3), wherein FIG. 7A represents catalytic activity, expressed as methane conversion, product yields, and selectivity towards hydrogen as a function of the reaction duration, FIG. 7B represents hydrogen production as a function of temperature conditions and reaction time, and FIG. 7C represents hydrogen production and power supplied by the induction heating device with time on stream.

FIG. 8 represents catalytic performance of a catalyst composition (Graphite felt/MESOC+ (1 mm) covered by 2 wt % FLG) as applied during methane decomposition in accordance with example 4, wherein FIG. 8A represents catalytic activity, expressed as methane conversion, product yields, and selectivity towards hydrogen as a function of the reaction duration, FIG. 8B represents hydrogen production as a function of temperature conditions and reaction time, and FIG. 8C represents hydrogen production and power supplied by the induction heating device with time on stream.

FIG. 9 represents SEM analyses taken from the two spent carbon catalysts as applied in example 4. FIG. 9A-C are SEM images of spent catalyst (non-porous graphite felt) as applied in the first catalyst bed. FIG. 9D-F represent SEM images taken from the spent porous catalyst (MESOC+1 mm covered by FLG) as applied in the second catalyst bed.

FIG. 10A represents digital photographs of a catalyst composition as applied in example 5, and consisting of a graphite fabric (non-porous catalyst) rolled on a ceramic support material (Zetex+ fabric). FIG. 10B represents catalytic performance of a catalyst composition as applied during methane decomposition in accordance with example 5 of the invention, and shows catalytic activity, expressed as methane conversion, product yields, and selectivity towards hydrogen as a function of the reaction duration, at a reaction temperature of 750° C.

FIG. 11 represents SEM analyses taken from the spent catalyst composition obtained after the methane decomposition reaction as applied in example 5. FIG. 11A is a low-resolution SEM image showing a homogeneous carbon deposition over the entire spent catalyst composition. FIG. 11B is a SEM image showing the deposit of solid carbon on the graphite fabric and the ceramic material (Zetex fabric). FIG. 11C is a SEM image showing the deposit of solid carbon around the fibers of the Zetex fabric, and illustrates how different fibers are connected by means of the deposited carbon. FIG. 11D is a high-resolution SEM image showing the morphology of deposited carbon.

FIG. 12 represents catalytic performance of a catalyst composition (rolled graphite felt/Zetex+) as applied during methane decomposition in accordance with example 6, wherein FIG. 12A represents catalytic activity, expressed as methane conversion, product yields, and selectivity towards hydrogen as a function of the reaction duration, FIG. 12B represents hydrogen production as a function of temperature conditions and reaction time, and FIG. 12C represents hydrogen production and power supplied by the induction heating device with time on stream.

FIG. 13 represents catalytic performance of a catalyst composition (graphite felt/gamma-Al₂O₃ grains) as applied during methane decomposition in accordance with example 7, wherein FIG. 13A represents catalytic activity, expressed as methane conversion, product yields, and selectivity towards hydrogen as a function of the reaction duration. FIG. 13B represents hydrogen production as a function of temperature conditions and reaction time, and FIG. 13C represents hydrogen production and power supplied by the induction heating device with time on stream.

FIG. 14 represents SEM analyses taken from the catalyst composition after the methane decomposition reaction as applied in example 7. FIG. 14A-C are SEM images of the spent catalyst (non-porous graphite felt) as applied in the first catalyst bed. FIG. 14D-F represent SEM images taken of the alumina-based grains after catalytic decomposition of methane into carbon and hydrogen according to example 7.

FIG. 15 represents SEM analyses of the (fresh) catalyst composition (FLG/Zetex+ fabric) as prepared in example 8. In this example, a Zetex+ fabric was impregnated with an aqueous suspension of FLG (20 g/L) followed by a drying step in an oven at 130° C. for 1 h. The process was repeated twice in order to have a FLG loading of 2 wt %.

FIG. 16 represents catalytic performance of a catalyst composition (FLG/Zetex+ fabric) as applied during methane decomposition in accordance with example 8, wherein FIG. 16A represents catalytic activity, expressed as methane conversion, product yields, and selectivity towards hydrogen as a function of the reaction duration. FIG. 16B represents hydrogen production as a function of temperature conditions and reaction time, and FIG. 16C represents hydrogen production and power supplied by the induction heating device with time on stream.

FIG. 17 represents SEM analyses of the spent catalyst composition (FLG/Zetex+ fabric) as applied in example 8.

FIG. 18 A-D represent scanning electron microscopy images of solid fragments recovered after ultrasonic treatment of the spent catalyst used in example 8 (FLG/Zetex+ fabric) showing the presence of multi-sheet graphene residues decorated with carbon nanofibers that were generated during the methane decomposition reaction.

FIG. 19 represents catalytic performance of a catalyst composition (FLG/MESOC+grains) composition as applied during methane decomposition in accordance with example 9, wherein FIG. 19A represents catalytic activity, expressed as methane conversion, product yields, and selectivity towards hydrogen as a function of the reaction duration. FIG. 19B represents hydrogen production as a function of temperature conditions and reaction time, and FIG. 19C represents hydrogen production and power supplied by the induction heating device with time on stream.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g. from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %”, “vol %”, or “mol %” refers to a weight percentage of a component, a volume percentage of a component, or molar percentage of a component, respectively, based on the total weight, the total volume of material, or total moles, that includes the component.

When describing the present invention, the terms used are to be construed in accordance with the following definitions, unless a context dictates otherwise.

Preferred statements (features) and embodiments and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments, with any other aspect and/or embodiment.
1. A process for the production of hydrogen and carbon by catalytic non-oxidative decomposition of saturated C₁₊ hydrocarbons, wherein the process comprises the steps of:
   a) supplying a catalyst composition to a reaction zone, wherein said catalyst composition comprises at least one carbon catalyst;
   b) heating said catalyst composition in said reaction zone;
   c) bringing a reaction gas comprising saturated C₁₊ hydrocarbons into contact with said heated catalyst composition in said reaction zone, thereby decomposing said saturated C₁₊ hydrocarbons into hydrogen and carbon; and
   d) optionally recovering at least a portion of said catalyst composition from said reaction zone, thereby obtaining a spent catalyst,
   characterised in that said catalyst composition is heated in said reaction zone to a temperature comprised between 500° C. and 1100° C. by means of induction heating.
2. A process for the production of hydrogen, carbon and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, wherein the process comprises the steps of:
   a) supplying a catalyst composition, to a reaction zone, wherein said catalyst composition comprises at least one carbon catalyst;
   b) heating said catalyst composition in said reaction zone to a temperature comprised between 500° C. and 1100° C., by means of induction heating; and
   c) bringing a reaction gas comprising a hydrocarbon or mixtures thereof, and preferably a saturated C₁₊ hydrocarbon or mixtures thereof, into contact with said heated catalyst composition in said reaction zone, thereby decomposing said hydrocarbon or mixtures thereof, preferably said saturated C₁₊ hydrocarbon or mixtures thereof, into hydrogen, carbon, and optionally hydrocarbons such as C₂₊ hydrocarbon(s);
   wherein the process comprises an activation period of at least 5 hours, during which said heated catalyst composition is brought into contact with the reaction gas.
3. A process for the production of hydrogen, carbon and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, wherein the process comprises the steps of:
   a) supplying a catalyst composition to a reaction zone, wherein said catalyst composition comprises at least one carbon catalyst;
   b) heating said catalyst composition in said reaction zone to a temperature comprised between 500° C. and 1100° C., by means of induction heating;
   c) activating said heated catalyst composition by bringing said heated catalyst composition into contact with said reaction gas during an activation period of at least 5 hours, such as at least 6, 8, 10, 12, 15, 20, 25, 30, 35 hours, and
   d) decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time.
4. Process according to any one of the previous statements, wherein the activation period is at least 5 hours, preferably at least 6, 8, 10, 12, 15, 20, 25, 30, 35 hours.
5. Process according to any one of the previous statements, wherein said reaction zone consists of one or more fixed bed reactors.
6. Process according to any one of the previous statements, wherein the catalyst composition is heated by generating an alternating electromagnetic field within the reaction zone containing said catalyst composition upon energization by a power source supplying alternating current, where the alternating electromagnetic field passes through the reaction zone thereby generating an electric current in said catalyst composition and heating the catalyst composition.
7. Process according to any one of the previous statements, wherein said catalyst composition is heated by means of an induction heating device, which is configured to surround (at least part of) said catalyst composition, and capable of generating an electromagnetic field in said catalyst composition.
8. Process according to any one of the previous statements, wherein said reaction gas comprises at least 50.0 mol % of said saturated C₁₊ hydrocarbons, and preferably at least 75.0 mol % or preferably at least 90.0 mol % or preferably at least 95.0 mol % or preferably at least 99.0 mol % of saturated C₁₊ hydrocarbons.
9. Process according to any one of the previous statements, wherein said saturated C₁₊ hydrocarbons comprise saturated C₁-C₁₂ hydrocarbons, preferably saturated C₁-C₁₀ hydrocarbons, preferably saturated C₁-C₈ hydrocarbons, preferably saturated C₁-C₆ hydrocarbons, preferably saturated C₁-C₄ hydrocarbons, preferably methane.
10. Process according to any one of the previous statements, wherein said reaction gas comprises at least 80.0 mol %, such as at least 85.0 mol %, or at least 90.0 mol %, or at least 99.0 mol % of methane.
11. Process according to any one of the previous statements, wherein said reaction gas comprises:
   from 80.0 to 100 mol % of methane, and preferably from 85.0 to 100 mol % of methane,
   from 0 to 5.0 mol % of nitrogen, or from 0 to 3.0 mol % of nitrogen; and
   from 0 to 20.0 mol % of hydrogen, or from 0 to 10.0 mol % of hydrogen.
12. Process according to any one of the previous statements, wherein said reaction gas comprises:
   from 80.0 to 100 mol % of methane, and preferably from 85.0 to 100 mol % of methane,
   from 0 to 15.0 mol % of ethane, such as from 0 to 10.0 mol % of ethane, or from 0 to 5.0 mol % of ethane, and
   from 0 to 15.0 mol % of propane, such as from 0 to 10.0 mol % of propane, or from 0 to 5.0 mol % of propane, or from 0 to 3.0 mol % of propane, and
   from 0 to 5.0 mol %, or from 0 to 3.0 mol % of butane, and
   from 0 to 5.0 mol %, or from 0 to 3.0 mol % of pentane, and
   from 0 to 5.0 mol % of nitrogen, or from 0 to 3.0 mol % of nitrogen.
   from 0 to 20.0 mol % of hydrogen, or from 0 to 10.0 mol % of hydrogen.
13. Process according to any one of the previous statements, wherein said reaction gas comprises a natural gas, preferably wherein said natural gas is of fossil origin, of renewable origin or a combination thereof.
14. Process according to any one of the previous statements, wherein said reaction gas comprises a mixture of hydrocarbons.
15. Process according to any one of the previous statements, wherein said reaction gas comprises or consists of methane.
16. Process according to any one of the previous statements, wherein said reaction gas is supplied to said reaction zone at a temperature which is lower than the reaction temperature.
17. Process according to any one of the previous statements, wherein said reaction gas is heated prior to being supplied to said reaction zone.
18. Process according to any one of the previous statements, wherein said reaction gas is not heated prior to being supplied to said reaction zone.
19. A process according to any one of the previous statements, for the production of hydrogen and carbon by catalytic non-oxidative decomposition of methane, wherein the process comprises the steps of:
   a) supplying a catalyst composition to a reaction zone, wherein said catalyst composition comprises at least one carbon catalyst;
   b) heating said catalyst composition in said reaction zone;
   c) bringing a reaction gas comprising, or essentially consisting of methane, into contact with said heated catalyst composition in said reaction zone, thereby decomposing said methane into hydrogen and carbon; and
   d) optionally recovering at least a portion of said catalyst composition from said reaction zone, thereby obtaining a spent catalyst,
   characterised in that said catalyst composition is heated in said reaction zone to a temperature comprised between 500° C. and 1100° C. by means of induction heating.
20. A process for the production of hydrogen, carbon and optionally hydrocarbons such as C₂₊ hydrocarbon(s), according to any one of the previous statements by catalytic non-oxidative decomposition of methane, wherein the process comprises the steps of:
   a) supplying a catalyst composition to a reaction zone, wherein said catalyst composition comprises at least one carbon catalyst;
   b) heating said catalyst composition in said reaction zone to a temperature comprised between 500° C. and 1100° C., by means of induction heating;
   c) activating said heated catalyst composition by bringing said heated catalyst composition into contact with a reaction gas comprising, or essentially consisting of methane during an activation period of at least 5 hours, such as at least 6, 8, 10, 12, 15, 20, 25, 30, 35 hours, and
   d) decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time.
21. A process for the production of hydrogen, carbon and optionally hydrocarbons such as C₂₊ hydrocarbon(s), according to any one of the previous statements by catalytic non-oxidative decomposition of methane, wherein the process comprises the steps of:
   a) supplying a catalyst composition to a reaction zone, wherein said catalyst composition comprises at least one carbon catalyst;
   b) heating said catalyst composition in said reaction zone to a temperature comprised between 500° C. and 1100° C., by means of induction heating; and
   c) bringing a reaction gas comprising, or essentially consisting of methane, into contact with said heated catalyst composition in said reaction zone, thereby decomposing said methane into hydrogen, carbon, and optionally hydrocarbons such as C₂₊ hydrocarbon(s);
   wherein the process comprises an activation period of at least 5 hours, preferably at least 6, 8, 10, 12, 15, 20, 25, 30, 35 hours, during which said heated catalyst composition is brought into contact with the reaction gas comprising, or essentially consisting of methane.
22. Process according to any one of the previous statements, wherein said catalyst composition is heated in said reaction zone by means of induction heating to a temperature comprised between 50° and 900° C. or between 60° and 800° C.
23. Process according to any one of the previous statements, wherein said process is carried out at a reaction pressure comprised between 0.1 and 30.0 bar, such as between 0.1 and 20.0 bar, or between 1.0 and 5.0 bar, or between 1.0 and 2.0 bar.
24. Process according to any one of the previous statements, wherein said reaction gas is supplied to said reaction zone at a gas hourly space velocity (GHSV) of between 1 and 30 m³/kg/h, or of between 1 and 15 m³/kg/h.
25. Process according to any one of the previous statements, wherein said hydrogen is produced at a yield of at least 50.0%, and preferably of at least 70.0%, or of at least 80.0%, or of at least 90.0%.
26. Process according to any one of the previous statements, wherein the catalyst composition comprises at least one carbon catalyst having BET surface area of at most 2500 m²/g, such as at most 2000 m²/g, or at most 1750 m²/g, or at most 1000 m²/g, or between 0.1 and 2000 m²/g, or between 0.1 and 1000 m²/g, or between 0.1 and 700 m²/g, as determined by ASTM-D-3663 (2020).
27. Process according to any one of the previous statements, wherein the catalyst composition comprises at least one carbon catalyst having a total pore volume of between 0.0005 and 1.0 ml/g, and preferably of between 0.01 and 0.50 ml/g.
28. Process according to any one of the previous statements, wherein said carbon catalyst in said catalyst composition comprises at least 75.0 wt %, preferably at least 80.0 wt %, more preferably at least 85.0 wt %, more preferably at least 90.0 wt %, more preferably at least 95.0 wt %, more preferably at least 96.0 wt %, more preferably at least 97.0 wt %, more preferably at least 98.0 wt %, more preferably at least 99.0 wt %, more preferably at least 99.5 wt %, more preferably at least 99.9 wt % of carbon, based on the total amount of said carbon catalyst.
29. Process according to any one of the previous statements, wherein said carbon catalyst has a metal concentration which is less than 5000 ppm, or less than 3000 ppm, or less than 2000 ppm, or less than 1000 ppm, or less than 500 ppm, or less than 300 ppm, or less than 100 ppm), or less than 50 ppm, based on the total weight of the carbon catalyst.
30. Process according to any one of the previous statements, wherein said carbon catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the carbon catalyst.
31. Process according to any one of the previous statements, wherein said carbon catalyst is metal-free.
32. Process according to any one of the previous statements, wherein said carbon-based catalyst consists of carbon.
33. Process according to any one of the previous statements, wherein said carbon catalyst is characterised by a Raman spectrum, as determined by Raman Spectroscopy using an excitation wavelength of about 532 nm and exciting laser power of about 100 milliwatt (mW); showing a first peak (D peak) at a wavenumber of about 1350 cm⁻¹ and a second peak (G peak) at a wavenumber from about 1585 to about 1600 cm⁻¹, and wherein said carbon catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.
34. Process according to any one of the previous statements, wherein said carbon catalyst has an electric resistivity of between 10⁻⁸ and 10² ohm·m, or between 10⁻⁷ and 10² ohm·m at 20° C. as determined by ASTM C611-98 (2016).
35. Process according to any one of the previous statements, wherein said catalyst composition comprises:
   (1) A first component, wherein said first component is selected from one or more non-porous carbon catalysts and/or one or more porous carbon catalysts; and
   (II) Optionally, a second component, wherein said second component consists of a non-carbon material, and preferably is a ceramic or zeolitic support material.
36. Process according to any one of the previous statements, wherein said catalyst composition comprises one or more carbon catalyst(s) which is (are) non-porous carbon catalyst(s).
37. Process according to any one of the previous statements, wherein said non-porous carbon catalyst has a BET surface area of at most 5.0 m²/g, such as from 0.10 to 5.0 m²/g, or from 0.5 to 3.0 m²/g, such as from 1.0 to 5.0 m²/g, or from 1.0 to 3.0 m²/g, as determined by ASTM-D-3663 (2020).
38. Process according to any one of the previous statements, wherein said non-porous carbon catalyst has a total pore volume lower than 0.050 ml/g, and preferably lower than 0.001 ml/g.
39. Process according to any one of the previous statements, wherein said non-porous carbon catalyst is selected from the group consisting of graphite (G), carbon felt (CF), graphite felt (GF), expanded graphite (EG), carbon fabric, graphite fabric, carbon cloth, graphite cloth, graphene, and any combinations thereof.
40. Process according to any one of the previous statements, wherein said non-porous carbon catalyst has a metal concentration which is less than 5000 ppm, or less than 3000 ppm, or less than 2000 ppm, or less than 1000 ppm, or less than 500 ppm, or less than 300 ppm, or less than 100 ppm), or less than 50 ppm, based on the total weight of the non-porous carbon catalyst.
41. Process according to any one of the previous statements, wherein said non-porous carbon catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the non-porous carbon catalyst.
42. Process according to any one of the previous statements, wherein said non-porous carbon catalyst is metal-free.
43. Process according to any one of the previous statements, wherein said catalyst composition comprises one or more carbon catalyst(s) which is (are) porous carbon catalyst(s).
44. Process according to any one of the previous statements, wherein said porous carbon catalyst has a BET surface area of more than 5.0 m²/g, such as from 10.0 to 2000 m²/g, or from 10.0 to 1000 m²/g, or from 100 to 700 m²/g, or from 200 to 600 m²/g, as determined by ASTM-D-3663 (2020).
45. Process according to any one of the previous statements, wherein said porous carbon catalyst has a total pore volume of at least 0.05 ml/g, and preferably at least 0.10 ml/g.
46. Process according to any one of the previous statements, wherein said porous carbon catalyst is selected from the group consisting of mesoporous carbon, carbon black, acetylene black, active carbon, carbon nanofiber (CNF), carbon nanotubes (CNTs), and any combinations thereof.
47. Process according to any one of the previous statements, wherein said porous carbon catalyst has a metal concentration which is less than 5000 ppm, or less than 3000 ppm, or less than 2000 ppm, or less than 1000 ppm, or less than 500 ppm, or less than 300 ppm, or less than 100 ppm), or less than 50 ppm, based on the total weight of the porous carbon catalyst.
48. Process according to any one of the previous statements, wherein said porous carbon catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the porous carbon catalyst.
49. Process according to any one of the previous statements, wherein said porous carbon catalyst is metal-free.
50. Process according to any one of the previous statements wherein said non-carbon material is a ceramic or zeolitic support material.
51. Process according to any one of the previous statements, wherein said non-carbon material has a BET surface area of at most 2000 m²/g, or at most 1000 m²/g, or between 1.0 and 1000 m²/g, or between 0.1 and 700 m²/g, or between 0.1 and 600 m²/g, or between 0.1 and 500 m²/g, or between 5.0 and 300, or between 50.0 and 600 m²/g, as determined by ASTM-D-3663 (2020).
52. Process according to any one of the previous statements, wherein said non-carbon material has a total pore volume of at least 0.1 ml/g, and preferably at least 0.2 ml/g.
53. Process according to any one of the previous statements, wherein non-carbon material is selected from the group consisting of zeolites, silicon carbide, silica, quartz, silica wool, quartz wool, and zirconia.
54. Process according to any one of the previous statements, wherein said catalyst composition comprises:
   (1) A first component, wherein said first component is selected from one or more non-porous carbon catalysts having a BET surface area of at most 5.0 m²/g, and/or one or more porous carbon catalysts having a BET surface area of more than 5.0 m²/g, and
   (II) Optionally, a second component, wherein said second component consists of a ceramic or zeolitic support material, and has a BET surface area of between 0.1 and 600 m²/g,
   wherein BET surface area is determined by ASTM-D-3663 (2020).
55. Process according to any one of the previous statements 35 to 54, wherein said catalyst composition is formed by applying said first component on said second component.
56. Process according to any one of the previous statements 35 to 54, wherein said catalyst composition is formed by applying a non-porous carbon catalyst on a surface of a porous carbon catalyst.
57. Process according to any one of the previous statements 35 to 54, wherein said catalyst composition is formed by applying a non-porous carbon catalyst on a surface of a non-carbon material.
58. Process according to any one of the previous statements 35 to 54, wherein said catalyst composition is formed by applying a porous carbon catalyst on a surface of a non-carbon material.
59. Process according to any one of the previous statements 35 to 54, wherein said catalyst composition is formed by enrolling said first component with said second component or said second component with said first component to form a layered material.
60. Process according to any one of the previous statements 35 to 54, wherein said catalyst composition is formed by impregnating said porous carbon catalyst with a non-porous carbon catalyst.
61. Process according to any one of the previous statements 35 to 54, wherein said catalyst composition is formed by impregnating said non-carbon material with a non-porous carbon catalyst.
62. Process according to any one of the previous statements 35 to 54, wherein said catalyst composition is formed by impregnating said non-carbon material with a porous carbon catalyst.
63. Process according to any one of the previous statements 35 to 54, wherein said catalyst composition is formed by separately arranging said non-porous carbon catalyst(s) and said porous carbon catalyst(s) in series, wherein said non-porous carbon catalyst(s) is(are) arranged upstream of said porous carbon catalyst(s).
64. Process according to any one of the previous statements 35 to 54 and 63, wherein said non-porous carbon catalyst(s) and said porous carbon catalyst(s) are provided in separate catalyst beds, or in separate sections of a single catalyst bed, and preferably wherein said non-porous carbon catalyst(s) is(are) arranged upstream of said porous carbon catalyst(s).
65. Process according to any one of the previous statements 35 to 54, wherein said catalyst composition is formed by separately arranging said non-porous carbon catalyst(s) and said non-carbon material in series, wherein said non-porous carbon catalyst(s) is(are) arranged upstream of said non-carbon material
66. Process according to any one of the previous statements 35 to 54 and 65 wherein said non-porous carbon catalyst(s) and said non-carbon material are provided in separate catalyst beds, or in separate sections of a single catalyst bed, and preferably wherein said non-porous carbon catalyst(s) is(are) arranged upstream of said non-carbon material.
67. Process according to any one of the previous statements 1 to 66, wherein said catalyst composition is a fresh catalyst composition.
68. Process according to any one of the previous statements 1 to 66, wherein said catalyst composition is a spent catalyst.
69. Process according to any one of the previous statements 1 to 68, wherein said catalyst composition is provided in the reaction zone in a fixed reactor bed.
70. Process according to any one of the previous statements 1 to 68, wherein said catalyst composition is provided in the reaction zone in a moving reactor bed.
71. Process according to any one of the previous statements, further comprising the step of supplying a susceptor material to said reaction zone comprising said catalyst composition, wherein said susceptor material, is capable of responding to an electromagnetic field by generating heat, and is capable of transferring said heat to said catalyst composition, and preferably wherein said susceptor material is physically separated from said catalyst composition.
72. Process according to any one of the previous statements, comprising the further steps of
   e) recovering at least a portion of said catalyst composition from said reaction zone after step c) and/or step d), thereby obtaining a spent catalyst, and
   f) optionally supplying the spent catalyst as catalyst composition to step a) of said process.
73. Process according to any one of the previous statements, wherein said spent catalyst is subjected to a mechanical treatment, for instance grinding, to reduce the size of the spent catalyst, before supply thereof to step a) of a process of any one of the previous statements.
74. Process according to any one of the previous statements, wherein said spent catalyst is not subjected to a treatment to remove carbon deposited thereon before supply thereof to step a) of a process of any one of the previous statements.
75. Process according to any one of the previous statements, wherein said spent catalyst is not heated before supply thereof to step a) of a process according to any one of the previous statements.
76. A process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
   a) supplying a spent catalyst to a reaction zone,
   b) heating said spent catalyst in said reaction zone to a temperature comprised between 500° C. and 1100° C. by means of induction heating; and
   c) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone, preferably wherein the spent catalyst supplied in step a) is prepared by carrying out a process according to any one of the previous statements.
77. A process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
   a) preparing a spent catalyst by a preparation process comprising the steps of:
      a1) supplying a catalyst composition to a reaction zone, wherein said catalyst composition comprises at least one carbon catalyst;
      a2) heating said catalyst composition in said reaction zone to a temperature comprised between 500° C. and 1100° C. by means of induction heating;
      a3) activating said heated catalyst composition by bringing said heated catalyst composition into contact with said reaction gas during an activation period of at least 5 hours, such as at least 6, 8, 10, 12, 15, 20, 25, 30, 35 hours,
      a4) optionally decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time,
      a5) recovering at least a portion of the catalyst composition from said reaction zone after step a3) and/or a4), thereby obtaining a spent catalyst, and optionally subjecting the spent catalyst to a mechanical treatment to reduce the size of the spent catalyst, and
   b) supplying the spent catalyst to a reaction zone;
   c) heating the spent catalyst in the reaction zone by means of induction heating to a temperature comprised between 500° C. and 1100° C.; and
   d) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone.
78. Process for preparing a spent carbon-based catalyst comprising the steps of
   a1) supplying a catalyst composition to a reaction zone, wherein said catalyst composition comprises at least one carbon catalyst;
   a2) heating said catalyst composition in said reaction zone to a temperature comprised between 500° C. and 1100° C. by means of induction heating;
   a3) activating said heated catalyst composition by bringing said heated catalyst composition into contact with said reaction gas during an activation period of at least 5 hours, such as at least 6, 8, 10, 12, 15, 20, 25, 30, 35 hours,
   a4) optionally decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time, and
   a5) recovering at least a portion of the catalyst composition from said reaction zone after step a3) and/or a4), thereby obtaining a spent catalyst, and optionally subjecting the spent catalyst to a mechanical treatment to reduce the size of the spent catalyst.
79. Process according to any one of the previous statements 77 to 78, wherein the catalyst composition as supplied in step a1) is a fresh catalyst composition, having the features as defined in any one of previous statements.
80. Process according to any one of the previous statements 77 to 79, wherein the catalyst composition as supplied in step a1) is a spent catalyst comprising at least one carbon catalyst, and preferably a spent catalyst having the features as defined in any one of previous statements.
81. Process according to any one of the previous statements 77 to 80, wherein the preparation process for preparing the spent catalyst is a process according to any one of the previous statements.
82. Process according to any one of the previous statements 77 to 81, wherein the catalyst composition is supplied to a reaction zone that consists of one or more fixed bed reactors.
83. Process according to any one of the previous statements 77 to 82, wherein the spent catalyst is supplied to a reaction zone that consists of one or more fixed bed reactors.
84. Process according to any one of the previous statements 77 to 83, wherein the catalyst composition is heated in said reaction zone by means of induction heating to a temperature comprised between 50° and 900° C. or between 60° and 800° C.
85. Process according to any one of the previous statements 77 to 84, wherein the spent catalyst is heated in said reaction zone by means of induction heating to a temperature comprised between 50° and 900° C. or between 60° and 800° C.
86. Process according to any one of the previous statements 77 to 85, wherein the catalyst composition is heated by generating an alternating electromagnetic field within the reaction zone containing said catalyst composition upon energization by a power source supplying alternating current, where the alternating electromagnetic field passes through the reaction zone thereby generating an electric current in said catalyst composition and heating the catalyst composition.
87. Process according to any one of the previous statements 77 to 86, wherein the spent composition is heated by generating an alternating electromagnetic field within the reaction zone containing said spent catalyst upon energization by a power source supplying alternating current, where the alternating electromagnetic field passes through the reaction zone thereby generating an electric current in said spent catalyst and heating the spent catalyst.
88. Process according to any one of the previous statements 77 to 87, wherein the process is carried out at a reaction pressure comprised between 0.1 and 30.0 bar.
89. Process according to any one of the previous statements 77 to 88, wherein said reaction gas is as defined in any one of the previous statements, and preferably comprises at least 80.0 mol %, such as at least 85.0 mol %, or at least 90.0 mol %, or at least 99.0 mol % of methane.
90. Process according to any one of the previous statements 77 to 89, wherein said reaction gas is supplied to said reaction zone at a gas hourly space velocity (GHSV) of between 1 and 30 m³/kg/h, or of between 1 and 15 m³/kg/h.
91. Process according to any one of the previous statements 77 to 90, wherein at least a portion of the spent catalyst is recovered after the decomposition step and re-cycled in said process.
92. Process according to statement 91 wherein said spent catalyst is mechanically treated, e.g. grinded, prior to recycling thereof in said process.
93. Process according to statement 91 or 92 wherein said spent catalyst is not heated prior to recycling thereof in said process.
94. Process according to any one of previous statements 77 to 93, wherein said spent catalyst has a metal concentration which is less than 5000 ppm, or less than 3000 ppm, or less than 2000 ppm, or less than 1000 ppm, or less than 500 ppm, or less than 300 ppm, or less than 100 ppm), or less than 50 ppm, based on the total weight of the spent catalyst.
95. Process according to any one of previous statements 77 to 93, wherein said spent catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the spent catalyst.
96. Process according to any one of previous statements 77 to 95, wherein said spent catalyst is metal-free.
97. Process according to any one of previous statements 77 to 96, wherein the spent catalyst has a BET surface area of between 0.1 and 100 m²/g, preferably of between 0.1 and 50 m2/g, as determined by ASTM-D-3663 (2020).
98. Process according to any one of previous statements 77 to 97, wherein the spent catalyst has a Raman spectrum, as determined by Raman Spectroscopy using an excitation wavelength of about 532 nm and exciting laser power of about 100 milliwatt (mW); showing a first peak (D peak) at a wavenumber of about 1350 cm⁻¹ and a second peak (G peak) at a wavenumber from about 1585 to about 1600 cm⁻¹, and wherein said spent catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.
99. Process according to any one of previous statements 77 to 98, wherein said spent catalyst has an electric resistivity of between 10⁻⁷ and 10² ohm·m at 20° C. as determined by ASTM C611-98 (2016).
100. Spent catalyst obtained or obtainable by carrying out a process of any one of the previous statements.
101. Spent catalyst according to previous statement, wherein said spent catalyst has a metal concentration which is less than 5000 ppm, or less than 3000 ppm, or less than 2000 ppm, or less than 1000 ppm, or less than 500 ppm, or less than 300 ppm, or less than 100 ppm, or less than 50 ppm, based on the total weight of the spent catalyst.
102. Spent catalyst according to any one of the previous statements, wherein said spent catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the spent catalyst.
103. Spent catalyst according any one of the previous statements, wherein the spent catalyst is metal-free.
104. Spent catalyst according any one of the previous statements, wherein the spent catalyst has a BET surface area of between 0.1 and 100 m²/g, preferably of between 0.1 and 50 m²/g, as determined by ASTM-D-3663 (2020).
105. Spent catalyst according any one of the previous statements, wherein the spent catalyst has a Raman spectrum, as determined by Raman Spectroscopy using an excitation wavelength of about 532 nm and exciting laser power of about 100 milliwatt (mW) showing a first peak (D peak) at a wavenumber of about 1350 cm⁻¹ and a second peak (G peak) at a wavenumber from about 1585 to about 1600 cm⁻¹, and wherein said spent catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.
106. Spent catalyst according any one of the previous statements, wherein said spent catalyst has an electric resistivity of between 10⁻⁷ and 10² ohm·m at 20° C. as determined by ASTM C611-98 (2016).
107. Use of a spent catalyst according any one of the previous statements, as a carbon catalyst.
108. Use of a spent catalyst according any one of the previous statements, as a carbon catalyst in a catalytic non-oxidative hydrocarbon decomposition process, preferably in a catalytic non-oxidative hydrocarbon decomposition process for decomposing saturated C₁₊ hydrocarbons, such as methane, into hydrogen and carbon, and more preferably in a catalytic non-oxidative hydrocarbon decomposition process as defined in any one of the previous statements.
109. Use of a spent catalyst according any one of the previous statements, as a susceptor material, for instance in a process as defined in any one of the previous statements.
110. Use of a spent catalyst according any one of the previous statements, as catalyst supply in a process as defined in any one of the previous statements.
111. System for producing hydrogen and carbon by catalytic non-oxidative decomposition of saturated C₁₊ hydrocarbons, wherein the system comprises:
   at least one reaction zone configured to receive a catalyst composition, and preferably comprising a fixed and/or moving catalyst bed for containing said catalyst composition;
   at least one inlet line for feeding a reaction gas comprising saturated C₁₊ hydrocarbons, and preferably comprising methane, into said reaction zone;
   at least one flow controlling means for controlling reaction gas flow rate to the reaction zone;
   at least one outlet line for recovering hydrogen from said reaction zone;
   at least one outlet line for recovering the reaction product stream exciting the reaction zone, and for separation of hydrogen from the unreacted hydrocarbon or some other hydrocarbons formed during the process (and present in said reaction product stream);
   at least one induction heating device configured for inductively heating a catalyst composition contained within said reaction zone to a reaction temperature effective for the non-oxidative decomposition of saturated C₁₊ hydrocarbons into hydrogen and carbon in the presence of said catalyst composition;
   at least one temperature setting device for regulating the set temperature of the reaction;
   optionally, at least one temperature measuring device for determining the reaction temperature;
   optionally, at least one heating device for pre-heating the reaction gas before entering said reaction zone; and
   optionally, at least one recovery unit for recovering from said reaction zone at least a portion of the catalyst composition spent during said non-oxidative decomposition.
112. System according to the previous statement, wherein said induction heating device comprises
   at least one induction element, such as an induction coil or an induction ring, positioned to surround said catalyst composition, and
   an alternating current (AC) power supply electrically connected to said induction coil or induction ring and capable of supplying an alternating current having a suitable frequency to said induction coil or induction ring, such as a frequency alternating between 2 and 500 kHz.
113. System according to any one of the previous statements, wherein the induction coil or said induction ring of said induction heating device is positioned inside the reaction zone, and is configured to define a space provided within said induction coil or induction ring capable of receiving said catalyst composition.
114. System according to any one of the previous statements, wherein the induction coil or said induction ring of said induction heating device is positioned in the wall of the reaction zone, and is configured to define a space provided within said induction coil or induction ring capable of receiving said catalyst composition.
115. System according to any one of the previous statements, wherein said induction coil or said induction ring of the induction heating device said induction heating device is positioned outside the reaction zone, and is configured to surround (at least part of) the section of the reaction zone containing the catalyst composition.
116. System according to any one of the previous statements, wherein said reaction zone comprises one or more fixed catalyst beds.
117. System according to any one of the previous statements, wherein said reaction zone comprises one or more moving catalyst beds.
118. System according to any one of the previous statements, wherein said temperature measuring device is a device capable of measuring the reaction temperature within the reaction zone, or within the catalyst bed(s), such as for instance a thermocouple, or a laser pyrometer.
119. System according to any one of the previous statements, wherein said temperature measuring device is a device capable of measuring the temperature at the outer surface of the reaction zone, or within the catalyst bed(s), such as for instance a laser pyrometer.

### Decomposition Process in the Presence of a Fresh Catalyst Composition

The Applicants found a way to decompose/convert hydrocarbons, such as light hydrocarbons including methane, into hydrogen and carbon, and optionally minor amounts of hydrocarbons such as C₂₊ hydrocarbon(s), in an effective and selective manner, and at high decomposition/conversion yield using induction heating technology for providing the necessary reaction heat to the reaction. During catalytic non-oxidative decomposition of hydrocarbons such as saturated C₁₊ hydrocarbons certain amounts of carbonaceous materials (herein also “carbon” or “solid carbon”) are co-formed, and are deposited on the catalyst composition used in the process. The present process provides high selectively towards the formation of hydrogen. The Applicants also found a way to exploit the carbon, deposited on the catalyst composition during the decomposition reaction, as they found a way to re-use (recycle) and hence valorise this carbon-product.

In one aspect, the present invention provides processes for the production of hydrogen and carbon, and optionally hydrocarbons such as C₂₊ hydrocarbon(s), by catalytic non-oxidative decomposition of hydrocarbon(s), such as saturated C₁₊ hydrocarbon(s), in the presence of a catalyst composition, preferably a fresh catalyst composition, comprising at least one carbon catalyst as defined herein.

In certain embodiments of the present invention, a process for the production of hydrogen and carbon and optionally hydrocarbons such as C₂₊ hydrocarbon(s), by catalytic non-oxidative decomposition of hydrocarbons such as saturated C₁₊ hydrocarbons, is provided, wherein the process involves the use of a catalyst composition (herein also denoted as “fresh” catalyst composition), which is heated by means of induction heating. Moreover, in accordance with the invention, the present process has an activation period as defined herein. In other words, a process of the invention involves a period wherein the catalyst composition is activated.

In certain embodiments, the process of the invention for the production of hydrogen, carbon and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, comprises the steps of:
a) supplying a catalyst composition, preferably wherein said catalyst composition is a fresh catalyst composition, to a reaction zone, wherein said catalyst composition comprises at least one carbon catalyst;
b) heating said catalyst composition in said reaction zone to a temperature comprised between 500° C. and 1100° C., by means of induction heating;
c) activating said heated catalyst composition by bringing said heated catalyst composition into contact with said reaction gas during an activation period of at least 5 hours, such as at least 6, 8, 10, 12, 15, 20, 25, 30, 35 hours, and
d) decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time.

It will be understood that in accordance with a process of the invention, the reaction gas will already undergo decomposition during the activating step of the fresh catalyst composition (e.g. at sub-optimal decomposition rates since the catalyst activity is not yet at a steady state, while the decomposition reaction may be continued in the decomposing step for a certain period of time over the activated catalyst, e.g. at higher decomposition rates than during the activation step.

In certain embodiments, a process of the invention for the production of hydrogen, carbon and optionally hydrocarbons such as C₂₊ hydrocarbon(s), by catalytic non-oxidative decomposition of a reaction gas comprising hydrocarbon or mixtures thereof, such as saturated C₁₊ hydrocarbon or mixtures thereof, may comprise the steps of:
a) supplying a catalyst composition, preferably a fresh catalyst composition, to a reaction zone, wherein said catalyst composition comprises at least one carbon catalyst;
b) heating said catalyst composition in said reaction zone to a temperature comprised between 500° C. and 1100° C., by means of induction heating; and
c) bringing a reaction gas comprising hydrocarbon or mixtures thereof, and preferably saturated C₁₊ hydrocarbon or mixtures thereof, into contact with said heated catalyst composition in said reaction zone, thereby decomposing said hydrocarbon or mixtures thereof, preferably said saturated C₁₊ hydrocarbon or mixtures thereof, into hydrogen, carbon, and optionally hydrocarbons such as C₂₊ hydrocarbon(s);

wherein the process comprises an activation period of at least 5 hours, such as at least 6, 8, 10, 12, 15, 20, 25, 30, 35 hours, during which said heated catalyst composition is brought into contact with the reaction gas. In other words, the present invention provides a process wherein the heated catalyst composition is brought into contact with the reaction gas during an activation period of at least 5 hours, such as at least 6, 8, 10, 12, 15, 20, 25, 30, 35 hours during which the catalyst composition is activated.

The present invention further provides processes that are characterised in that during the catalytic decomposition of hydrocarbons such as saturated C₁₊ hydrocarbons, into hydrogen and carbon, over a fresh catalyst composition, a spent catalyst composition is being generated. Hence, in certain embodiments, a process of the invention comprises the further step recovering at least a portion of said catalyst composition from said reaction zone after step c) and/or step d), thereby obtaining a spent catalyst. Optionally, this spent catalyst can be supplied as catalyst composition to a novel/fresh decomposition process as provided in accordance with the invention.

The term “activation period” of a process as applied herein intends to refer to the time period needed for the heated catalyst composition as applied in the process to reach a steady-state catalytic activity. The term “steady state” catalytic activity in that context means that there is no significant change in catalytic activity (within margins of +/−10%) over time.

In certain circumstances, e.g. when using a fresh catalyst composition as defined herein, the heated catalyst composition will first exhibit a decrease in catalytic activity followed by an increase in catalytic activity to reach a steady state. In certain other circumstances, e.g. when using a spent catalyst composition as defined herein, the heated spent catalyst composition will almost instantly reach a steady state catalytic activity, without prior decrease in catalyst activity, such that in such circumstances the activation period is very short or even non-existent. Catalytic activity can be determined by and expressed in terms of hydrocarbon (e.g. methane) conversion.

After this activation period, the decomposition step continues during a suitable period of time. This “suitable period of time” may be defined as the time of operating the process when the catalytic activity (e.g. expressed as decomposition rate or conversion yield) is at the steady-state level. In other words, this period of time refers to the duration of the process after(beyond) an activation period as defined herein. For example, such suitable period of time may be at least 5 hours, such as at least 10, 20, 24, 48, 72 hours. The suitable length of this period may depend on operational considerations.

The term “fresh” catalyst is conventional in the art, and intends to refer to a catalyst that is used for a first time, i.e. that has not been previously subjected to a catalysed reaction or that is not recycled. The term “fresh” catalyst may be understood as a “starting” catalyst, or “initial” catalyst or “original” catalyst in the context of the present invention.

In contrast therewith, the term “spent catalyst composition” or “spent catalyst” is also well known in the art, and in general refers to a catalyst that has been previously used in a catalysed reaction. The terms “spent catalyst” and “spent carbon catalyst” are used herein interchangeably.

In certain embodiments, the present invention also provides a process for the production of hydrogen and carbon by catalytic non-oxidative decomposition of saturated C₁₊ hydrocarbons, wherein the process comprises the steps of:
a) supplying a catalyst composition to a reaction zone, wherein said catalyst composition comprises at least one carbon catalyst;
b) heating said catalyst composition in said reaction zone to a temperature comprised between 500° C. and 1100° C. by means of induction heating;
c) bringing a reaction gas comprising saturated C₁₊ hydrocarbons into contact with said heated catalyst composition in said reaction zone, thereby decomposing said saturated C₁₊ hydrocarbons into hydrogen and carbon.

It may be noted that the sequence of the steps b) and c) is not meant to be limiting. Step b) and c) may happen simultaneously, or step b) may be initiated before step c), or step c) may be initiated before step b).

The Applicants have surprisingly shown that a “fresh” catalyst composition, when applied in a process of the invention, and having an initial catalytic activity, will first display a decrease in this catalytic activity (the catalytic activity may for instance be expressed in terms of methane conversion), followed by re-gain and increase of catalytic activity up to a (steady state) level which is in certain cases is even higher than the initial level of catalytic activity. Thus, contrary to what is expected, the Applicants have shown that when carrying out a process according to the invention even beyond an activation period as defined herein still allows to decompose a reaction gas comprising hydrocarbons or mixtures thereof into hydrogen, carbon, and optionally minor amounts of hydrocarbons such as C₂₊ hydrocarbon(s), in an efficient and selective way at effective conversion rates. Submitting a (fresh) carbon-based catalyst composition as applied in a process of the invention to the reaction gas during a certain period of time (i.e. an activation period of e.g. at least 5, or at least 15, or at least 25 hours) allowed to obtain a catalytic performance, which in certain cases is even higher than the initial catalytic activity.

The Applicants have also surprisingly found that the catalytic activity (and hence the decomposition rate/conversion yield) in a process in accordance with the present invention, and in particular a process in which a “fresh” catalyst composition is applied, remains adequate in the long term (i.e. beyond the activation period). A fresh catalyst composition as defined herein may first show a decrease in catalytic activity as a function of its time on stream after which the catalyst composition re-gains activity, inducing an increase in decomposition rates.

The Applicants also found that unexpectedly a spent catalyst advantageously has significant catalyst activity as well, which is in some instance higher than that of a fresh catalyst, such that the spent catalyst may be advantageously re-used as carbon catalyst, particularly in the process of the invention.

Surprisingly, the Applicants have also shown that the duration of the “activation period” of a process of the invention depends on whether a spent or a fresh catalyst composition as described herein is used in the process. In particular, the Applicants have shown that a decomposition process wherein a spent catalyst composition as described herein is applied requires a shorter activation period, or in some instances even no activation period at all, as compared to a process wherein a fresh catalyst composition is applied.

The invention advantageously allows carbon-based catalyst compositions as applied in the present process to be used for a long period of time, since deactivation of these catalyst composition during the process beyond the activation period is limited. Advantageously, in certain embodiments, a spent catalyst composition can be removed from the reactor zone, subjected to a minimal treatment (e.g. the recycled catalyst composition may undergo a size reduction, but does not need pre-heating), and be re-used in the process of the invention.

Moreover, the Applications have advantageously shown that used (spent) carbon-based catalyst compositions as described herein have a catalyst activity which is similar (with shorter activation period) or even higher than fresh (non-used) carbon-based catalyst composition.

The present invention thus addresses a process for catalytic thermal decomposition of hydrocarbons such as saturated C₁₊ hydrocarbons into hydrogen and carbon, and is in particular directed to a non-oxidative catalytic decomposition process which is carried out in the presence of a specific catalyst composition (fresh or spent) comprising at least one carbon catalyst as defined herein. The present process shows high selectivity for the production of hydrogen. The present process also yields smaller amounts of by-products including C₂₊ unsaturated hydrocarbons, such as e.g. alkenes (olefins), alkynes (acetylenes), or aromatics.

The term “hydrocarbon decomposition” refers to a change in a molecular structure or composition of a hydrocarbon. The terms “hydrocarbon decomposition” and “hydrocarbon conversion” are used herein as synonyms, and intend to refer to a chemical reaction involving removal of hydrogen from an organic molecule.

“Hydrocarbon decomposition” in the present invention is in particular non-oxidative. The term “non-oxidative” as used herein is understood to mean that the hydrocarbon decomposition proceeds in the absence of an oxidizing agent such as oxygen or sulphur. The term “oxygen” in this context intends to include air, O₂, H₂O, CO, and CO₂.

The reaction conditions applied during catalytic non-oxidative decomposition of hydrocarbons in the presence of a catalyst composition as defined herein result in the formation of hydrogen, but also of carbon. “Carbon”, as defined herein, in particular includes solid, carbonaceous materials that are formed during the decomposition reaction, and that are adsorbed on the surface and/or in the pores of the catalyst compositions as used in the present process. In this context, the terms “carbonaceous material”, “carbon deposits” and “carbon” are used herein interchangeably. Carbon deposits may include for instance crystalline graphite, graphitic sheets, graphitic fragments, or other carbon containing structures which are essentially non-volatile solids at the reaction conditions.

Taking methane as the exemplified hydrocarbon, the present process involves a direct decomposition of methane into hydrogen and carbon, and this, without excessive production of CO₂ according to the following reaction equation (Eq. 1)

CH₄(g)↔C(s)+2H₂(g) (Eq.1)

During the reaction, the carbon formed by decomposition of methane, will be fixed to the surface or in the porosity of the catalyst. The deposited carbon can then be recovered from the spent catalyst, or even recycled in the reactor, e.g. by using the spent catalyst to serve itself as a carbon catalyst in the decomposition reaction. The Applicants have advantageously found that the carbon that is formed on the macroscopic structure of a catalyst composition as defined herein, does not require a post-synthesis (chemical/thermal) treatment to prepare it for use as a carbon catalyst.

In accordance with the present invention, catalyst compositions as applied in the present process are operated under a non-contact heating mode based on (electromagnetic) induction heating. In this heating mode, electricity is used to generate heat and to heat the catalyst composition. Hence heat is not generated by classical combustion. The Applicants have shown that catalyst compositions that are heated by means of induction heating can be effectively used in a hydrocarbon decomposition reaction, even if these catalyst compositions are heated to temperatures that are typically lower than those used in with conventional combustion heating processes.

Moreover, reaction set up as described, involving the combined implementation of a specific, carbon-containing catalyst composition that is heated by means of induction heating, shows outstanding selectivity towards hydrogen production, high reaction stability, and the possibility to work under non-oxidative conditions. The present processes allow for a more efficient catalyst use at relative low reaction temperatures with low carbon footprint, high selectivity towards hydrogen carbon and even an increase in catalyst activity over the course of the reaction, as compared to the state-of-the-art metal-based catalysts.

The present invention brings several advantages in terms of process intensification, energy efficiency, product selectively, reactor setup simplification, and safety. By using inductive heating technology, a process as provided herein may advantageously be carried out at reaction temperatures which are distinctly lower than what is used in traditional hydrocarbon production processes, while remaining highly effective. Induction heating technology applied in the present process permits direct and local heat transfer to the catalyst composition, i.e. to the carbon-based catalyst material used in such composition; by generating an alternating electromagnetic field within the reaction zone containing said catalyst composition carbon-based catalyst, an electric current is generated directly in the catalyst composition, i.e. in the carbon-based catalyst, which is thereby locally heated. The generated heat is therefore locally generated and used in the hydrocarbon decomposition reaction; and generation of undesired CO/CO₂ emissions is greatly minimized. Advantageously, using a technology based on electric heating, which is the case for induction heating as provided herein, allows the carbon footprint of a process as described herein to be reduced, e.g., as compared to heating based on gas-fired furnaces

In addition, the Applicants have shown that a catalyst composition as defined herein, is highly active in the present process at the applied reaction conditions, shows high catalyst stability, and retains significant catalyst activity, and may even show increased catalyst activity during the reaction, despite the formation (and deposition) of carbonaceous materials (carbon) on the catalyst composition during the hydrocarbon decomposition reaction.

The amount of carbon deposit during the reaction also influences the power supply of the induction heating device as the higher the amount of carbon deposit inside the reactor, or induction coil, the lower is the power supply by the coil to operate the catalytic system. Such direct relationship is not possible using traditional indirect Joule heating, or through gas burners, as the amount of carbon deposit is completely independent from the power supply for heating the catalyst composition.

A process for the production of hydrogen and carbon as disclosed herein comprises the supply of a reaction gas comprising hydrocarbons, preferably saturated hydrocarbons, having at least one carbon atom, to a reaction zone in which a catalyst composition as defined herein has been provided. Such reaction gas comprising hydrocarbons such as saturated C₁₊ hydrocarbons, is thereby brought into contact with a heated catalyst composition as defined herein, whereby the saturated C₁₊ hydrocarbons are thermally decomposed into hydrogen and carbon.

The term “reaction gas” as used herein includes a gas comprising or consisting of hydrocarbon(s), in particular a saturated hydrocarbon or a mixture of saturated hydrocarbons as defined herein.

The term “hydrocarbon” refers to an organic compound consisting of the elements hydrogen and carbon. Hydrocarbons generally fall into two classes: aliphatic, or straight chain hydrocarbons, and cyclic, or closed ring hydrocarbons, including cyclic terpenes. Examples of hydrocarbon-containing materials for use in the present processes include any form of natural gas or oil.

The term “saturated hydrocarbons” refers to hydrocarbons having no carbon-carbon double bonds. In the present invention, the terms “saturated hydrocarbons” and “saturated C₁₊ hydrocarbons” are used herein interchangeably, and these terms refer to saturated hydrocarbons having at least one carbon atom. Saturated hydrocarbons may be linear or cyclic hydrocarbons.

Preferably, hydrocarbons for use in the present invention include hydrocarbons having 1 to 12 carbon (C) atoms. Also preferably, saturated C₁₊ hydrocarbons for use in the present invention include light hydrocarbons, i.e. hydrocarbons having a carbon (C) number of 12 or less.

In preferred embodiments, “saturated C₁₊ hydrocarbons” for use herein refer to saturated C₁-C₁₂ hydrocarbons, preferably saturated C₁-C₁₀ hydrocarbons, preferably saturated C₁-C₈ hydrocarbons, preferably saturated C₁-C₆ hydrocarbons, preferably saturated C₁-C₄ hydrocarbons, preferably saturated C₁, C₂, C₃, C₄, C₅, or C₆ hydrocarbons. When a subscript is used herein following a carbon atom, the subscript refers to the number of carbon atoms that the named group may contain.

In certain preferred embodiments, saturated C₁₊ hydrocarbons in this invention comprise saturated hydrocarbons selected from the group consisting of methane, ethane, propane, butane, pentane, cyclopropane, cyclopentane, cyclohexane, and any combinations of two or more thereof. In certain preferred embodiments, said saturated C₁₊ hydrocarbons are selected from methane, ethane, propane, or any combinations of two or more thereof. In certain preferred embodiments, said saturated C₁₊ hydrocarbons comprise or consist of methane.

In the present processes, a reaction gas comprising saturated C₁₊ hydrocarbons, as defined hereinabove, is provided to a reaction zone comprising a catalyst composition as defined herein. The reaction gas comprises at least 50.0 mol % of saturated C₁₊ hydrocarbons, as defined hereinabove, such as at least 75.0 mol %, or at least 80.0 mol %, or at least 90.0 mol %, or at least 95.0 mol %, or at least 99.0 mol % of saturated hydrocarbons, or at least 99.5 mol %, or at least 99.9 mol % of saturated hydrocarbons as defined herein, based on the total reaction gas. For instance, the reaction gas comprises from 50.0 to 100 mol % of saturated hydrocarbons as defined herein, or from 75.0 to 99 mol %, or from 80.0 to 97.0 mol % based on the total reaction gas of saturated C₁₊ hydrocarbons as defined herein. In certain embodiments of a process according to the invention, the applied reaction gas comprises a mixture of different saturated hydrocarbons. For instance, in certain embodiments the applied reaction gas comprises a mixture of methane and ethane, or a mixture of methane and propane, or a mixture of ethane and propane, or a mixture of methane, ethane and propane.

In certain other embodiments of a process according to the invention, the applied reaction gas essentially consists of one saturated hydrocarbon species, e.g. only methane, or only ethane, or only propane, or only butane. The term “essentially consists of” as used in this context indicates that said one saturated hydrocarbon species, e.g. methane, or ethane, or propane, makes up at least 90.0 mol %, such as least 92.0 mol %, or at least 95.0 mol %, or at least 97.0 mol %, or at least 99.0 mol % of the total amount of saturated hydrocarbons in said reaction gas. In other words, in certain preferred embodiments, a reaction gas essentially consisting of one saturated C₁₊ hydrocarbon species, e.g. methane, or ethane, or propane, comprises less than 10 mol %, based on the total amount of saturated hydrocarbons in said reaction gas, of saturated C₁₊ hydrocarbons different from said one hydrocarbon species; such as less than 8.0 mol %, or less than 5.0 mol %, or less than 3.0 mol %, or less than 1.0 mol % of saturated C₁₊ hydrocarbons different from of said one saturated hydrocarbon species.

In certain preferred embodiments, the reaction gas applied a process according to the invention consists of one saturated hydrocarbon species, e.g. only methane.

In certain preferred embodiments, said reaction gas comprises at least 80.0 mol %, such as at least 85.0 mol %, or at least 90.0 mol %, or at least 95.0 mol %, or at least 99.0 mol %, of methane.

In certain embodiments, said reaction gas comprises at least 80.0 mol %, such as at least 85.0 mol %, or at least 90.0 mol %, or at least 95.0 mol %, or at least 99.0 mol % of ethane.

In certain embodiments, said reaction gas comprises at least 80.0 mol %, such as at least 85.0 mol %, or at least 90.0 mol %, or at least 95.0 mol %, or at least 99.0 mol % of propane.

In certain embodiments, said reaction gas comprises at least 80.0 mol %, such as at least 85.0 mol %, or at least 90.0 mol %, or at least 95.0 mol %, or at least 99.0 mol % of butane.

Optionally, a reaction gas as applied in a process according to the invention may also comprise minor amounts of other components selected from oxygen, nitrogen, or carbon dioxide. Preferably such other component may be present in an amount lower than 2.0 mol %, such as lower than 1.5 mol %, or lower than 1.0 mol % or lower than 0.5 mol %, based on the total reaction gas.

Optionally, a reaction gas as applied in a process according to the invention may also comprise hydrogen. Preferably, the molar ratio of this optional hydrogen to saturated C₁₊ hydrocarbon in said reaction gas may be in the range from about 1:4 to 0:1.

Optionally, in certain embodiments an inert gas is also fed to the reaction zone comprising a catalyst composition as defined herein. The inert gas may be chosen from the group consisting of helium, nitrogen, argon, and mixtures thereof, and preferably is nitrogen or argon. The inert gas does not comprise water or oxygen species (e.g. carbon monoxide or carbon dioxide).

The reaction gas and the inert gas may be provided to the reaction zone simultaneously or not, preferably simultaneously. An inert gas may be used to dilute the reaction gas. For example, the flow ratio of reaction gas to inert gas may be in the range from about 1:0 to about 1:1, and preferably from about 1:0 to 1:0.2.

Preferably, the reaction gas is substantially free of oxygen, e.g. it contains less than 1.0 mol %, or less than 0.5 mol %, or less than 0.1 mol %, or less than 0.01 mol %, or less than 0.001 mol %, or less than 0.0001 mol %, or less than 0.00001 mol % of oxygen, as defined herein. In an example, the reaction gas is free of oxygen, as defined herein.

Preferably, the reaction gas is substantially free of sulphur species, e.g. it contains less than 1.0 mol %, or less than 0.5 mol %, or less than 0.1 mol %, or less than 0.01 mol %, or less than 0.001 mol %, or less than 0.0001 mol %, or less than 0.00001 mol % of sulphur species. In an example, the reaction gas is free of sulphur species. Sulphur species may for instance be present in the form of H₂S, mercaptans (R-SH), COS, CS₂.

In certain embodiments, the composition of the reaction gas is comparable to the composition of a natural gas, a biogas, or a fuel/off gas stream.

In certain embodiments of a process according to the invention, the applied reaction gas is a natural gas. The term “natural gas” refers to a multi-component gas obtained from a crude oil well (associated gas) or from a subterranean gas-bearing formation (non-associated gas). The composition and pressure of natural gas can vary significantly. A typical natural gas stream contains methane as a significant component. Natural gas may also contain ethane, higher molecular weight hydrocarbons, acid gases (such as carbon dioxide, hydrogen sulphide, carbonyl sulphide, carbon disulphide, and mercaptans), and minor amounts of contaminants such as water, nitrogen, iron sulphide, wax, and crude oil. As used herein, “natural gas” may also include gas resulting from the regasification of a liquefied natural gas, which has been purified to remove contaminates, such as water, acid gases, and most of the higher molecular weight hydrocarbons (e.g. C₁₂+ hydrocarbons). Conventional methods can be used for removing impurities and/or adjusting the relative amount of hydrocarbon compounds present in the reaction gas. The term “biogas” refers to a multi-component gas, primarily consisting of methane and carbon dioxide, produced from raw materials such as but not limited to agricultural waste, manure, municipal waste, plant material, sewage, green waste or food waste. Biogas may be purified to remove oxygen containing compounds, prior to application as reaction gas in the present processes.

In an embodiment, a reaction gas as applied in a process according to the invention may have the following composition:
from 80.0 to 100 mol % of methane, and preferably from 90.0 to 100 mol % of methane
from 0 to 50.0 mol % ethane, and preferably from 0.01 to 25.0 mol % ethane, and
from 0 to 25.0 mol % propane, and preferably from 0.01 to 15.0 mol % propane, and
from 0 to 15.0 mol % butane, and preferably from 0.01 to 5.0 mol % butane.

In another embodiment, a reaction gas as applied in a process according to the invention may have the following composition:
from 80.0 to 100 mol % of methane, and preferably from 90.0 to 100 mol % of methane
from 0 to 15.0 mol % of ethane, such as from 0 to 10 mol % of ethane, or from 0 to 5 mol % of ethane, and
from 0 to 15.0 mol % of propane, such as from 0 to 10.0 mol % of propane, or from 0 to 5.0 mol % of propane, or from 0 to 3.0 mol % of propane, and
from 0 to 5.0 mol %, or from 0 to 3.0 mol % of butane, and
from 0 to 5.0 mol %, or from 0 to 3.0 mol % of pentane, and
from 0 to 5.0 mol % of nitrogen, or from 0 to 3.0 mol % of nitrogen.

One example of a suitable reaction gas for use in a process according to the invention comprises for instance:
3.0 mol % to 70.0 mol % methane;
10.0 mol % to 50.0 mol % ethane;
10.0 mol % to 40.0 mol % propane;
5.0 mol % to 40.0 mol % butane; and
1.0 mol % to 10.0 mol % of C₅-C₉ hydrocarbons.

Another example of a suitable reaction gas for use in a process according to the invention comprises for instance: 94.9 mol % methane; 2.5 mol % ethane; 0.2 mol % propane, 0.06 mol % butane, 0.02 mol % pentane, 0.01 mol % C₆+ alkanes, 1.6 mol % of nitrogen, 0.7 mol % of carbon dioxide, 0.02 mol % of oxygen and traces of hydrogen.

In certain embodiments, said natural gas may be of fossil origin. In certain embodiments, said natural gas may be of renewable origin. Natural gas of renewable origin for instance includes gas produced from existing waste streams and a variety of renewable and sustainable biomass sources, including but not limited to animal waste, crop residuals and food waste, organic waste from dairies and farm, and naturally-occurring biological breakdown of organic waste at facilities such as wastewater treatment plants and landfills. In certain embodiments, said natural gas may comprise a combination of natural gas from fossil origin and from renewable source. In certain instances, small amounts of impurities may be present in the reaction gas, such as H₂S or NH₃, for instance if the processing gas was issued from a methanization reaction.

In a preferred embodiment of the present invention a process is provided for the production of hydrogen and carbon by catalytic non-oxidative decomposition of methane, wherein the process comprises the steps of:
a) supplying a catalyst composition to a reaction zone, wherein said catalyst composition comprises at least one carbon catalyst;
b) heating said catalyst composition in said reaction zone;
c) bringing a reaction gas comprising, or essentially consisting of, or consisting of methane, into contact with said heated catalyst composition in said reaction zone, thereby decomposing said methane into hydrogen and carbon; and
d) optionally recovering at least a portion of said catalyst composition from said reaction zone, thereby obtaining a spent catalyst,

characterised in that said catalyst composition is heated in said reaction zone to a temperature comprised between 500° C. and 1100° C. by means of induction heating, such as from 500 to 900° C. or from 600 to 800° C., wherein said catalyst composition may be a catalyst composition as defined herein.

In accordance with the present processes, a reaction gas as defined herein is supplied to a reaction zone comprising a catalyst composition as defined herein, and is brought into contact with the heated catalyst composition in said reaction zone, whereby the saturated C₁₊ hydrocarbons contained in the reaction gas are decomposed into hydrogen and carbon.

As understood herein, “a reaction zone” may be an individual reactor or may refer to a zone of a reactor that comprises different reaction zones, which are for instance kept at different temperatures. The step of contacting saturated hydrocarbons with a catalyst composition of the invention may be performed in any suitable reactor, as known to a skilled man.

For example, the reactor may be a fixed bed reactor or moving bed reactor. Hence, a catalyst composition as defined herein may be provided in said reaction zone in a (or a series of) fixed reactor bed(s) or in one (or a series of) moving reactor bed(s).

As used herein, the term “fixed bed reactor” or “fixed catalyst bed” refers to a reactor or reactor zone where a catalyst material (e.g. particulate catalyst material) is substantially immobilized within the reactor/reactor zone and reactant(s) flows through the catalyst bed. A fixed bed reactor may include vessel(s) containing the catalyst material. Vessels may be cylindrical or spherical. Vessels may be horizontally oriented or vertically oriented.

As used herein, the term “moving bed reactor” or “moving catalyst bed” refers to a reactor or reactor zone wherein a catalyst material (e.g. particular catalyst material) travels through the reactor and may be removed from the reactor. Typically, the catalyst material enters at one end of the reactor and flows out the opposite end of the reactor. The moving bed reactor may be connected to a regeneration system as to regenerate the spent catalyst. The regenerated catalyst may then be returned to the moving bed reactor for further use in the reaction, as described herein. Preferably a moving bed reactor involves a system in which the catalyst materials are moved by means of mechanical means, such as worm gear driven transfer means.

Preferably, processes as described herein are carried out in one or more fixed bed reactors. In other words, a reaction zone as applied in any of the processes described herein preferably consists of one or more fixed bed reactors.

In certain embodiments of the invention, when using a spent catalyst in a process of the invention, in a moving catalyst bed or in a fixed catalyst bed, it is preferred that the spent catalyst is removed from the reaction zone at a regular time base. The removed spent catalyst can then be treated to reduce its size (by e.g. grinding, crushing, breaking into pieces), before being re-supplied to the reaction zone. Such regular reshaping of the spent catalyst is beneficial to avoid that the catalyst bed would undergo plugging by solid carbon deposit. It may be noted that such regular treatment of the spent catalyst to reduce its size is not triggered by a decrease in catalytic activity, but may be beneficial from a operating point of view (to avoid reactor plugging).

For the implementation of the process, saturated hydrocarbons as defined herein, in pure form or diluted with another gas, containing natural impurities, may be sent into a decomposition reactor, for example in a downward direction or in a horizontal direction, depending on the position of the reactor. Any suitable reactor, as known to a skilled man, may be used in the present process. For instance, the reactor may be an isothermal, adiabatic or hybrid reactor. An example of a suitable reactor for use in the present process is an adiabatic reactor. An “adiabatic reactor” refers to a reactor that does not exchange heat with the external environment, at least for that part of the reactor that contains the catalytic bed.

The reactant gas can be supplied to the reactor or reactor zone in a downwards or upwards direction, preferably in a downwards direction, whereby the reaction products are then withdrawn at the bottom of the reactor. In the case of an incomplete decomposition reaction or in the case that during the decomposition of a reaction gas (e.g. methane, or other light hydrocarbons) besides the hydrogen also other hydrocarbons containing longer carbon chains are produced, such reactant products can be separated by techniques known to the skilled person, e.g. first by condensation, followed by absorption or any other suitable techniques.

Process according to the invention is performed at conditions effective for hydrocarbon decomposition, i.e. the non-oxidative conversion of saturated hydrocarbons (e.g., methane) into hydrogen and carbon. To that end, the reaction zone containing a catalyst composition as defined herein is operated under effective reaction conditions to convert at least a portion of the saturated hydrocarbons in the reaction gas. The term “effective,” as used in the specification and/or claims, means adequate to accomplish a desired, expected, or intended result. The term “effective reaction conditions” as used in the specification and/or claims, means conditions selected from but not limited to reaction temperature, reaction pressure, flow rate(s) of reaction gas, molar ratio of components, amount of catalyst, etc. that are effective to convert at least a portion of saturated C₁₊ hydrocarbons into hydrogen under non-oxidative conditions.

The hydrocarbon conversion of saturated hydrocarbons as described herein is accomplished via endothermic reactions, which present various challenges, such as maintaining sufficient temperatures required for the reactions, including transferring a large amount of heat to the catalyst composition.

In certain embodiments, the present processes comprise heating of the interior of said reaction zone containing said catalyst composition to an effective reaction temperature by heating the catalyst material which is provided inside the reaction zone. Induction heating (IH) technology is thus applied to heat a catalyst composition as defined herein, which is provided within the reaction zone. Thus, in a process according to the invention, a reaction zone containing said catalyst composition is heated by heating the catalyst composition contained in said reaction zone by induction heating.

Induction heating in general involves a process in which a reaction medium (here the reaction gas) is brought into contact with a heating medium (here a catalyst composition) that can be heated by electromagnetic induction. This process enables heat to be generated within the body of the reactor or reaction zone (by heating the catalyst provided in the body of the reactor).

Induction heating is the process of heating an electrically conducting object (here a catalyst composition as defined herein) by magnetic induction, through heat generated in the object by eddy currents (also called Foucault currents) and/or hysteresis loss. An induction heater typically consists of an electromagnet, and an electronic oscillator which passes a high-frequency alternating current (AC) through the electromagnet. The rapidly alternating magnetic field penetrates the object, generating electric currents inside the conductor called eddy currents. The eddy currents flowing through the resistance of the material heat it by Joule heating. Eddy current heating is also denoted ohmic heating. Eddy current heating is thus a process by which the passage of an electric current through a conductor (here the catalyst composition material) releases heat.

In accordance with the invention, a process is provided wherein a catalyst composition, as defined herein, is heated by generating an alternating electromagnetic field within the reaction zone containing said catalyst composition upon energization by a power source supplying alternating current, where the alternating electromagnetic field passes through the reaction zone thereby generating an electric current in said catalyst composition and heating the catalyst composition. Hence, a catalyst composition according to the invention is heated by the action of an induced alternating electromagnetic field. In particular, a process of the invention involves heating of the carbon catalyst comprised within said catalyst composition by inductive heating, wherein such carbon catalyst is heated by generating an alternating electromagnetic field within the reaction zone containing said carbon catalyst upon energization by a power source supplying alternating current, where the alternating electromagnetic field passes through the reaction zone thereby generating an electric current in said at least one carbon catalyst and heating the carbon catalyst.

As indicated above, a catalyst composition of the invention may be arranged in reactor or in a reaction zone, in fixed bed or in moving bed, preferably in a fixed bed. In an example, a bed of a catalyst composition as defined herein is heated in a reaction zone by means of an induction coil or an indication ring surrounding said zone. The heat is generated in the bed itself by passing through said coil or ring an alternating current having a suitable frequency.

In the above embodiments of a process according to the invention; the catalyst composition is heated by induction. This provides the heat necessary for the endothermic chemical conversion reaction. The heating of the reactant(s) in the reaction gas is provided by conduction when the reactant(s) is(are) brought into contact with the catalyst composition, typically by being adsorbed onto the surface of the catalyst composition, as well as by convection prior to the reactant(s) contacting the surface of the catalyst composition.

In according with the present process a catalyst composition as defined herein is heated by means of an induction heating device, which is configured to surround (at least part of) said catalyst composition, and capable of generating an electromagnetic field in said catalyst composition.

The induction heating device (herein also “inductor”) may for instance comprise a helical induction coil extending at least over the thickness of the (fixed) catalytic bed, or comprise an annular element (induction ring), of which the height substantially corresponds to the thickness of the catalytic bed. It will be understood that the shape of the induction heating element (e.g. coil, ring, or the like) can be adapted to the morphology of the catalyst composition or the catalytic bed.

In one embodiment, the induction heating element may be arranged inside the reactor or reactor zone in such a way as to encircle the catalytic bed so that the magnetic field it generates is essentially perpendicular to the thickness of the catalytic bed. According to another embodiment, the induction heating element may be arranged at the level of the catalytic bed but outside or in the wall of the reactor or reactor zone at the level of the catalytic bed. This embodiment has the advantage that the induction heating device is decoupled from the chemical environment of the decomposition reaction, which allows an easier control of the inductor device. However, in this embodiment, it is preferred that the reactor is made from a non-conductive material, such as for instance quartz or a dense waterproof ceramic material.

An important advantage of applying the induction heating process in the present invention is therefore that the heat is generated inside the object itself (i.e. the catalyst), and the catalyst material can be very rapidly heated. Moreover, in view of the set-up of the induction heating device, heat may be generated locally in the reaction zone at the site where the heat is required. A direct heating mode associated with a high heating rate allows to operate endothermic reaction without facing its intrinsic drawback, i.e. temperature loss within the catalyst bed as a function of conversion of the reactant. Fast temperature regulation of induction heating allows to maintain the catalyst bed temperature as close as possible to the targeted one.

When a catalyst composition as defined herein is arranged in a fixed catalyst bed, it will be possible to move either the induction coil/ring or the catalyst composition in the heating zone of the induction heating device, in order to replace the loaded (spent) catalyst by fresh catalyst and thus maintaining the reaction at its optimum level. Replacing spent catalyst by a fresh catalyst may be carried out according to techniques that are well-known to the skilled person.

Another advantage of the induction heating, as applied in the present processes, is that heat transfer is proportional to the amount of conductor (here the catalyst composition) localized within the induction coil/induction ring. In other words, the power supply to maintain the catalyst bed temperature decreases as carbon deposits increase inside the catalyst bed. Thus, the overall power to operate the reaction decreases with time-on-stream where higher amount of carbonaceous species accumulating within the reactor.

Further advantages of operating the process according to the invention using induction heating include:
High efficiency of the induced heat: In this heating mode only the solid, catalyst composition, is heated by interaction with the generated electromagnetic field, and the heat is generated directly in the catalyst composition, therefore significantly reducing heat losses, that are observed by heat transfer phenomena observed when using an external heat source;
Reduction of gas phase side reactions: Induction heating does not heat the reactant gas, and heating of the obtained reaction products is also very limited. This allows to reduce secondary reactions in the gas phase in the catalytic zone, as well as those secondary reactions related to thermal reactions;
Reduced complexity in heat management: In accordance with the present process, the heating zone is limited to the solid constituting a catalyst composition as defined herein, and as a result, the gaseous reactant products, that exit of the catalytic zone, are rapidly cooled, and are available at room temperature a few centimeters downstream of the catalytic bed;
Decentralized process: Inductive heating in accordance with the present invention is operated by electricity, and as a result, the present process and reactor set-up can be easily relocated and operated by direct connection to a local electrical network. For instance, hydrogen can be produced by small on-site units by decomposing natural gas, using existing infrastructure for the transport of natural gas, and thereby reducing risks of long-distance hydrogen transport and the costs associated with the development of new infrastructure.

This also allows to reduce size of reactors according to production needs. It should be noted that for reactors operating via gas burners the size of the reactor is large in order to reduce the costs associated with the burners. Such reactors are difficult to relocate.

Moreover, by using induction heating to heat catalyst compositions as applied in the present process, the present invention further advantageously allows the process to operate with electricity, that may be obtained from renewable energy sources. Indeed, over the past decade, the continuous increase in global energy demand and the collective awareness of the problem of global warming have led to the development of means of producing electrical energy from renewable sources. This massive integration of renewable energy sources into the energy landscape, however, comes up against the problem of managing electricity networks in order to better distribute and avoid losses of the electricity produced. The irregular and localized nature of most of these sources, especially of wind and solar sources of electricity, makes it complicated, when using such sources, to find a balance between production and demand of the electrical energy. When using such renewable sources, it is also complicated to manage the storage of “surplus” electricity, so this such energy may be available later on, in case of a fall in yield of producing electricity from such renewable sources. The process according to the invention may be operated with a renewable energy source, and as such therefore allows to convert excess electricity in a chemical form that can be stored and mobilized for long periods.

According to a preferred embodiment, the process uses a reactor for the direct decomposition of methane (or other light hydrocarbons) which has a fixed catalyst bed, that is subjected to an alternating induced electromagnetic field that causes heating of the catalyst composition without contact thereof with the source of energy. Such inductive heating method direct the energy needed for carrying out the decomposition reaction to the catalyst composition only, while the reaction gas, entering and leaving the catalytic bed, are neither heated nor cooled.

A catalyst composition is heated in the present invention to a reaction temperature of at most 1100° C., such as between 35° and 1100° C. In certain embodiments, a catalyst composition is heated to a reaction temperature which is comprised between 50° and 1100° C., such as between 50° and 900° C., or between 50° and 850° C., or between 50° and 750° C.; or between 60° and 850° C., or between 60° and 800° C.

In certain embodiments of the present process, a catalyst composition may be applied herein may be provided in two or more catalysts beds. In such instances, it will be understood that according to the present invention each of such catalyst beds are preferably heated by induction. The reaction temperature may be the same or different in the different catalytic beds. For instance, in certain instances, the temperature in a second catalyst bed will be lower than in a first catalyst bed, located upstream of the second bed, which is for instance due to the nature of the catalyst contained in each bed, and/or to the location of each catalyst bed with respect to the induction coil of the heating device. For instance, a laser pyrometer for temperature control is set on the catalyst bed with highest hyperthermic response, for example on a first catalyst bed containing a non-porous carbon catalyst, while a second bed is constituted by a porous carbon catalyst, hence, the second catalyst bed is at lower reaction temperature due to a lower hyperthermic response with respect to the induction coil, and also due to the localisation in a different place with respect to the dimensions of the induction coil, e.g. slightly displaced with respect to the middle of the coil (in a horizontal plane). In an example, wherein a second bed is constituted by porous carbon materials (the first bed contains non porous carbon material), the temperature may be about 150° C. lower in the second as compared to the first catalyst bed. In another examples, wherein a second bed is constituted by a ceramic material, which is not active or receptive to induction heating, the temperature may be lower with about 200° C. or even slightly more, in the second as compared to the first catalyst bed.

The reaction gas may be optionally heated prior to supplying it to the reaction zone. It is however preferred that the reaction gas may be supplied to said reaction zone at a temperature which is lower than the reaction temperature. In certain embodiments, it is preferred that the reaction gas is supplied to the reaction zone at a temperature lower than 500° C., or lower than 450° C., or lower than 400° C., or lower than 350° C., or lower than 300° C., or lower than 250° C., or lower than 200° C., or lower than 150° C., or lower than 100° C. It will be understood that suitable temperatures of the reaction gas to be supplied in the reaction zone will depend on the reaction temperature as applied in the process. Depending to the temperature applied to the reactant gas, the real gaseous velocity may be accordingly recalculated.

In certain embodiments, the reaction gas is not heated prior to being supplied to said reaction zone.

In an example, the reaction gas may comprise or consist of a mono-component gas, e.g. methane, or of a mixture of hydrocarbons, e.g. hydrocarbons containing a carbon number less than or equal to 4. The reaction gas can be sent either as is at room temperature and under atmospheric pressure into the reaction zone, or can be preheated to a given temperature before coming into contact with the catalyst composition.

The pressure within the reactor in which the catalyst non-oxidative decomposition is carried out is preferably comprised between 0.1 and 30.0 bar, such as between 0.1 and 20.0 bar, or between 0.1 and 15.0 bar, or between 0.1 and 10.0 bar, or between 0.5 and 5.0 bar, or between 0.1 and 3.0 bar. In certain preferred embodiments, the pressure may be comprised y between 1 and 5 bar, or between 1 and 2 bar. In some preferred embodiments, a process according to the invention can be also operated at atmospheric pressure.

Process according to any one of statements 1 to 15, wherein said reaction gas is supplied to said reaction zone at a gas hourly space velocity (GHSV) of between 1 and 30 m³/kg/h, or of between 1 and 15 m³/kg/h.

The present process shows high selectivity for the production of hydrogen. However, the present process may yield smaller amounts of by-products including C₂₊ unsaturated hydrocarbons, such as e.g. alkenes (olefins), alkynes (acetylenes), as well as some aromatics. A further step in the process therefore may include the separation of hydrogen, formed by the decomposition process, from the other reaction products, e.g. C₂₊ hydrocarbons such as ethylene and acetylene, and/or aromatic compounds, that are obtained. Separating reactants from the obtained hydrogen may be carried out according to gas phase separation techniques that are well known to the skilled person.

An advantage of using induction heating in the present process, is that it allows easy separation of reaction products, without for instance the need for a dedicated condensing unit using a heat exchanger system. Since only the reaction zone/catalytic bed is subjected to heating, the gaseous effluent containing reaction products undergoes a sudden cooling at the outlet of the reactor, causing at least partial condensation of the condensable effluents in the liquid state. The effluent extracted from the reactor can then be sent into a separation unit to separate a gas phase containing methane that has not reacted in the mixture with possibly other heavier hydrocarbons and hydrogen, and a liquid phase consisting of condensable hydrocarbons.

The present process for the production of hydrogen and carbon by catalytic non-oxidative decomposition of saturated C₁₊ hydrocarbons as defined herein involves the use of a particular catalyst composition.

A catalyst composition as applied in the present process is in particular characterized in that it comprises at least one carbon catalyst. The terms “carbon catalyst” or “carbon-based catalyst” are used herein as synonyms and refer to compounds that are—as such—catalytically active, i.e. that act as a catalyst and facilitate a chemical reaction. As generally used herein, the term “carbon-based catalyst” refers to a carbon-containing compound which can enhance the rate and/or efficiency of a chemical reaction process as compared to the rate and/or efficiency of the same chemical reaction process in the absence of the catalyst. Such catalyst materials modify and increase the rate of chemical reactions without being consumed in the process.

The term “carbon-based catalyst” does not refer to metallic compounds or metal-containing catalysts, such as but not limited to zeolites, iron catalysts, metal nitrides, etc.

In some embodiments, a “carbon-based catalyst” or “carbon catalyst” as used herein comprises, and preferably consists of, carbon. For example, a carbon-based catalyst as used herein has a carbon content (mol %) of at least about 75.0, 80.0, 85.0, 90.0, 95.0, 97.0, 99.0, or 99.9 mol % of carbon. In certain preferred embodiments, said carbon-based catalyst is entirely made of carbon. Carbon content of materials may be determined using techniques that are well known in the art, such as quantitative X-Ray fluorescence (XRF) or Induced Coupled Plasma-Mass Spectrometry (ICP-MS) or Thermogravimetry (TG) analysis.

In certain embodiments, a carbon catalyst as applied herein comprises at least 75.0 wt %, preferably at least 80.0 wt %, more preferably at least 85.0 wt %, more preferably at least 90.0 wt %, more preferably at least 95.0 wt %, more preferably at least 96.0 wt %, more preferably at least 97.0 wt %, more preferably at least 98.0 wt %, more preferably at least 99.0 wt %, more preferably at least 99.5 wt %, more preferably at least 99.9 wt %, of carbon, based on the total weight of said carbon catalyst.

In certain preferred embodiments, a carbon catalyst as used in the present process consists of carbon.

In certain embodiments, a carbon catalyst as used in the present process comprises less than 10.0 wt %, preferably less than 5.0 wt %, more preferably as less than 1.0 wt %, more preferably as less than 0.1 wt %, of inorganic oxide(s), based on the total weight of the carbon catalyst.

In certain preferred embodiments, a carbon catalyst as used in the present process does not comprise inorganic oxide(s).

“Inorganic oxides” are well known to the skilled person and refer to binary oxygen compounds where the inorganic component is the cation and the oxide is the anion. Examples of inorganic oxides include for instance silica, alumina, silica-alumina, titania, zirconia, ceria, yttria, and magnesia components, and mixtures thereof. “Inorganic oxides” may include metals (metal oxides); and metalloids (metalloid oxides). Examples of inorganic oxides include for instance Al₂O₃, Ga₂O₃, GeO₂; SiO₂, etc.

The use of a catalyst composition comprising at least one carbon-based catalyst as defined herein in non-oxidative conversion of saturated hydrocarbons as defined herein into hydrogen and carbon, has the important advantages, (i) that carbon/carbonaceous materials formed on the catalyst composition during a process according to the invention do not reduce catalyst activity; (ii) that the catalyst composition having carbonaceous materials deposited thereon may therefore be recycled and re-used; and (iii) that carbon/carbonaceous deposits on the catalyst improve heat harvesting from the induction heating, thus lowering the overall energy input to a process according to the invention as a function of time-on-stream.

In certain embodiments, a carbon-based catalyst as comprised in a catalyst composition provided herein is characterised by its surface area.

In a preferred embodiment, a carbon-based catalyst as used in a catalyst composition provided herein has a BET surface area, as determined by ASTM-D-3663 (2020), of at most 2500 m²/g, such as at most 2000 m²/g, or at most 1750 m²/g, or at most 1000 m²/g, or between 0.1 and 2000 m²/g, or between 0.1 and 1000 m²/g, or between 0.1 and 700 m²/g, as determined by ASTM-D-3663 (2020).

In certain embodiments of the invention, a catalyst composition as applied herein comprises at least one carbon catalyst which has a total pore volume of between 0.0005 and 1.0 ml/g, and preferably of between 0.01 and 0.50 ml/g. The total pore volume of a catalyst composition can be measured according to techniques that are well known in the art.

In certain embodiments of the invention, a catalyst composition as applied herein comprises at least one carbon catalyst which is substantially free of metal, or preferably is free of metal. “Metals” as used in this context refers to metals selected from the group consisting of transition metals, alkali metals and alkaline earth metals. The “metals” also encompass compounds of metal thereof, e.g., metal oxides. In the present invention, the term “transition metal” as used herein refers to any element in the d-block of the periodic table, including the elements of the 3^{rd} to 12^{th} group of the periodic table. The term “transition metal” further includes any element in the f-block of the periodic table, including the elements of the lanthanide and actinide series. In the present invention, the term “alkali metal” as used refers to any element in group 1 excluding hydrogen in the periodic table, including lithium (Li), sodium (Na), potassium (K), rubidium (Rb), Caesium (Cs) and francium (Fr). In the present invention, the term “alkaline-earth metal” as used refers to any element in group 2 in the periodic table, including beryllium (Be), magnesium (Mg), calcium (Ca), strontium (Sr), barium (Ba) and radium (Ra).

“Substantially free of metal” or “substantially metal-free” as used herein refers to a carbon-based catalyst as defined herein that has a concentration of metal (as defined herein above) which is less than 3000 ppm, or less than 2000 ppm, or less than 1000 ppm, based on the total weight of the carbon-based catalyst. In certain preferred embodiments, a carbon-based catalyst as defined herein has a concentration of metal (as defined herein above) of less than 500 ppm. In certain preferred embodiments, a carbon-based catalyst as defined herein has a concentration of metal (as defined herein above) of less than 250 ppm. In certain preferred embodiments, a carbon-based catalyst as defined herein has a concentration of metal (as defined herein above) of less than 100 ppm. In certain preferred embodiments, a carbon-based catalyst as defined herein has a concentration of metal (as defined herein above) of less than 50 ppm. In certain preferred embodiments, a carbon-based catalyst as defined herein has a concentration of metal (as defined herein above) of less than 10 ppm.

In certain preferred embodiments, a carbon-based catalyst as defined herein has a concentration of metal (as defined herein above) of less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the carbon-based catalyst.

In certain preferred embodiments, a carbon-based catalyst as used herein is free of any metal (as defined herein above). A carbon-based material as defined herein has therefore not been impregnated with metals (as defined). Metal content of a carbon-based catalyst as provided herein may be determined by techniques known in the art such as atomic absorption spectroscopy (AAS) or other elemental analysis technique, such as x-ray photoelectron spectroscopy (XPS), or mass spectrometry (e.g., inductively coupled plasma mass spectrometry, or “ICP-MS”) or X-ray fluorescence (XRF). The skilled person is aware of which method to use to determine the level metal in a carbon-based catalyst as used herein. “Free of any metal” in this context is meant to refer to the absence of detection of a metal (as defined) using the most sensitive technique available for that purpose.

Another distinguishing feature of a carbon-based catalyst used in a catalyst composition of the present invention is that it is rich is defects, such as points, lines, interface and/or bulk defects. This feature may be determined by means of Raman spectroscopy. Raman spectroscopy is a well-known, rapid, and quantitative method of analysis that involves measuring the Raman effect or Raman scattering. Preferably a carbon-based catalyst as used herein is characterized by a Raman spectrum having at first peak (herein D peak or D band, disordered carbon) at a wavenumber of about 1350 cm⁻¹ and a second peak (herein G peak or G band, graphitized carbon) at a wavenumber from about 1585 to about 1600 cm⁻¹. It is noted that the frequencies of the Raman spectrum mentioned above are given as Raman shifts abbreviated as cm⁻¹, thus, they are actually differential values between an excitation and a detected wavenumber. Raman spectra can be measured using a conventional laboratory Raman spectrometer (such as a Chromex Sentinel II fiber optic Raman spectrometer, a Horiba Jobin Yvon LabRAM spectrometer or a Horiba Jobin Yvon double or triple Raman spectrometer or a ThermoFisher Scientific ATmega XR Raman spectrometer or any other suitable Raman spectrometer than will provide substantially the same test results) under the conditions that include: an excitation wavelength of about 532 nanometres with an exciting laser power at the sample of about 100 mW. A Raman spectrometer should be capable of a spectral resolution of less than 2 nm/mm. In certain preferred embodiments, a carbon-based catalyst for use in the present invention is characterised by a Raman coefficient I_{D}/I_{G} which is higher than 0.10, such as higher than 0.20, or higher than 0.30, wherein I_{D} corresponds to the intensity of the Raman spectrum in said D peak; and I_{G} corresponds to the intensity of the Raman spectrum in said G peak. Therefore, in certain embodiments of the invention, a catalyst composition as applied herein comprises at least one carbon catalyst which is characterised by a Raman spectrum, as determined by Raman Spectroscopy using an excitation wavelength of about 532 nm and exciting laser power of about 100 milliwatt (mW); showing a first peak (D peak) at a wavenumber of about 1350 cm⁻¹ and a second peak (G peak) at a wavenumber from about 1585 to about 1600 cm⁻¹, and wherein said carbon catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.

In some embodiments of the present invention, a carbon-based catalyst as used herein may be characterised in terms of how it resists electric current. The term “electric resistivity” refers to a parameter with Greek letter p, which is expressed as ohm·m at 20° C. A low resistivity indicates that a material readily allows electric current. In certain preferred embodiments, a carbon-based catalyst as used in the present invention has an electric resistivity comprised between 10⁻⁸ and 10² or comprised between 10⁻⁷ and 10² ohm·m at 20° C. as determined by ASTM C611-98 (2016). Therefore, in certain embodiments of the invention, a catalyst composition as applied herein comprises at least one carbon catalyst which has an electric resistivity of between 10⁻⁷ and 10² ohm·m at 20° C. as determined by ASTM C611-98 (2016).

The term “electric conductivity” is the reciprocal of electrical resistivity and represents a material's ability to conduct electric current. It is commonly signified by the Greek letter σ, and is expressed as Siemens per metre (S/m).

A carbon-based catalyst as used in a catalyst composition of the present invention may have different morphologies. The morphology or form of a carbon catalyst as used herein is not particularly limited and may for instance include grains, beads, an extruded form, e.g. rod-shaped, sticks, particles, the form of a trilobe, ring, felt, fibers, filament, 2D or 3D fabrics, cellular foam, hollow rods, or cylinders, or monoliths, etc. In an example, a carbon catalyst as used herein has various morphologies, such as e.g., grains, spherical, extrudates, trilobes, and has an average particle diameter of at least 0.1 μm, and preferably between 0.1 and 20000 μm; or between 10 and 10000 μm, or between 200 and 2000 μm, as determined by SEM microscopy or by sieving according to ASTM D4513-11.

For instance, in an examples, a carbon-based catalyst as used herein has a fibrous shape, e.g. with aspect ratios of about 1000:1 (i.e. 10-100 nm wide×100-1,000,000 nm long).

In an example, a hydrocarbon decomposition method according to the invention uses a catalyst comprising at least one carbon catalyst, e.g. in the form of fabric, or felt, extruded components, cellular foam, monolith, etc. The carbon catalyst can operate either alone (as such), or in a combination with other (non-carbon) materials, in particular ceramic or zeolitic support materials. The catalyst composition, including at least one carbon catalyst as defined herein, is subjected to contactless heating by electromagnetic induction.

According to preferred embodiments of the present invention, a catalyst composition for use in the present method comprises:
(I) A first component, wherein said first component is selected from one or more non-porous carbon catalysts and/or one or more porous carbon catalysts; and
(II) Optionally, a second component, wherein said second component consists of a non-carbon material, and preferably is a ceramic or zeolitic support material.

In one example, a catalyst composition for use in the present method comprises, or consists of, a first component selected from one or more non-porous carbon catalysts and/or one or more porous carbon catalysts. In another example, a catalyst composition for use in the present method comprises, or consists of, a first component selected from one or more non-porous carbon catalysts. In another example, a catalyst composition for use in the present method comprises, or consists of, a first component selected from one or more porous carbon catalysts. In another example, a catalyst composition for use in the present method comprises, or consists of, a first component selected from one or more non-porous carbon catalysts and one or more porous carbon catalysts. In another example, a catalyst composition for use in the present method comprises, or consists of, a first component selected from one or more non-porous carbon catalysts, and a second component, consisting of a non-carbon material, and preferably a ceramic or zeolitic support material. In another example, a catalyst composition for use in the present method comprises, or consists of, a first component selected from one or more porous carbon catalysts, and a second component, consisting of a non-carbon material, and preferably a ceramic or zeolitic support material. In another example, a catalyst composition for use in the present method comprises, or consists of, a first component selected from one or more non-porous and one or more porous carbon catalysts and a second component, consisting of a non-carbon material, and preferably a ceramic or zeolitic support material. In aforementioned examples, a non-porous and porous carbon catalyst, and a non-carbon material, are as defined herein,

In certain embodiments of the invention, a catalyst composition as applied in the present process consists of one or more carbon catalyst, which may be porous and/or non-porous as defined herein. In other words, in these embodiments, a process according to the invention is carried out in the absence of any other catalyst material which is not a carbon-based catalyst as defined herein. For instance, in such embodiments, a process according to the invention is carried out in the absence of a metal-containing catalyst. A process according to the invention is carried out in the absence of a zeolite catalyst. Hence, the present process may be carried out using a catalyst composition which consists of one or more carbon catalyst(s) which is (are) non-porous carbon catalyst(s), or which consists of one or more carbon catalyst(s) which is (are) porous carbon catalyst(s). In certain embodiments, a catalyst composition as used herein consists of one or more carbon catalyst(s) which is (are) non-porous carbon catalyst(s) and one or more carbon catalyst(s) which is (are) porous carbon catalyst(s). Hence, a catalyst composition as applied in the present process may comprise, or consists of, different types of carbon catalysts, e.g. one or more non-porous carbon catalysts that are combined with one or more porous carbon catalyst. The porous and non-porous catalyst are preferably as defined below. It will be understood that in such embodiments the carbon-based catalyst is meant to be used as such in a process according to the invention, and is not provided on or combined with any support, e.g. not combined with any support material as provided herein. It will also be understood from the present invention that in such embodiments a “carbon catalyst” does not encompass carbon-based material that is used as support material for another catalyst. In such embodiments, the carbon-based catalyst does not refer to a support (used to support another catalyst) comprising or consisting of carbon or carbon material. Consequently, it will also be understood that in such embodiments the carbon-based catalyst refers to a component which is free of any other catalyst material.

In certain other embodiments of the invention, a catalyst composition as applied herein may comprise, or consist of the combination of a first component (selected from non-porous carbon catalysts, porous carbon catalysts, and combinations thereof), and a second component, which consists of a non-carbon material, such as e.g. a ceramic or zeolitic support material. In certain embodiments, a catalyst composition as used herein comprises, or consist of, a first component, wherein said first component is selected from one or more non-porous carbon catalysts; and a second component, wherein said second component consists of a non-carbon material, and preferably is a ceramic or zeolitic support material. In certain other embodiments, a catalyst composition as used herein comprises, or consist of, a first component, wherein said first component is selected from one or more porous carbon catalysts; and a second component, wherein said second component consists of a non-carbon material, and preferably is a ceramic or zeolitic support material.

The terms “non-porous”, “non porous”, and “nonporous” carbon catalyst are used herein interchangeably and is meant to refer to a carbon catalyst (as defined herein) with no or no substantial (significant) internal porosity. Hence, non-porous carbon materials do not have pores within their matrix structure.

In preferred embodiments, a “non-porous carbon catalyst” intends to refer to a carbon catalyst (as defined herein) which has BET surface area of at most 5.0 m²/g, such as from 0.10 to 5.0 m²/g, or from 0.5 to 3.0 m²/g, such as from 1.0 to 5.0 m²/g, or from 1.0 to 3.0 m²/g, as determined by ASTM-D-3663 (2020).

In preferred embodiments a non-porous carbon catalyst may have a total pore volume lower than 0.050 ml/g, and preferably lower than 0.001 ml/g. Total pore volume may be determined by techniques that are known to the skilled person following established standard protocols.

In a preferred embodiment, a non-porous carbon catalyst as applied herein has a metal concentration which is less than 5000 ppm, or less than 3000 ppm, or less than 2000 ppm, or less than 1000 ppm, or less than 500 ppm, or less than 300 ppm, or less than 100 ppm, or less than 50 ppm based on the total weight of the non-porous carbon catalyst.

In certain preferred embodiments, a non-porous carbon catalyst as applied herein has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the non-porous carbon catalyst.

In a preferred embodiment, a non-porous carbon catalyst as applied herein is substantially free of metal, or preferably is free of metal as defined herein above.

In a preferred embodiment, a non-porous carbon catalyst as applied herein is rich is defects, such as points, lines, interface and/or bulk defects. Consequently, in certain preferred embodiments, a non-porous carbon-based catalyst for use in the present invention is characterised by a Raman coefficient I_{D}/I_{G} (as defined herein above) which is higher than 0.10, such as higher than 0.20, or higher than 0.30, wherein I_{D} corresponds to the intensity of the Raman spectrum in said D peak; and I_{G} corresponds to the intensity of the Raman spectrum in said G peak.

In some embodiments of the present invention, a non-porous carbon-based catalyst as used herein may be characterised in that it has an electric resistivity (as defined herein above) comprised between 10⁻⁸ and 10² ohm·m, or between 10⁻⁷ and 10² ohm·m at 20° C. as determined by ASTM C611-98 (2016).

Several forms of carbon can be applied as a non-porous catalyst in the present invention. In some preferred embodiments, said non-porous carbon-based catalyst is selected from the group comprising, or consisting of, graphite (G), carbon felt (CF), graphite felt (GF), expanded graphite (EG), carbon fabric, graphite fabric, carbon cloth, graphite cloth, graphene, and any combinations thereof.

As used herein, the term “graphene” intends to refer to a molecule in which a plurality of carbon atoms (e.g., in the form of five-membered rings, six-membered rings, and/or seven-membered rings) are covalently bound to each other to form a (typically sheet-like) polycyclic aromatic molecule. Consequently, and at least from one perspective, a graphene may be viewed as a single layer of carbon atoms that are covalently bound to each other (most typically sp² bonded). It should be noted that under the scope of this definition, the term “graphene” also includes molecules in which several (e.g., two, three, four, five to ten, one to twenty, one to fifty, or one to hundred) single layers of carbon atoms are stacked on top of each other, preferably to a maximum thickness of about 100 nanometres. Consequently, the term “graphene” as used herein refers to a single layer of aromatic polycyclic carbon as well as to a plurality of such layers having a thickness of preferably of less than about 100 nanometres. The term “few-layer graphene (FLG)” as used herein intends to refer to graphene with about 2 to 30 layers, such as about 2 to 10 layers.

The term “graphite” as used herein, describes the well-known crystalline form of the element carbon with its atoms arranged in a hexagonal structure. A graphitic carbon has the characteristics of an ordered three-dimensional graphite crystalline structure consisting of layers of hexagonally arranged carbon atoms stacked parallel to each other as determined by X-ray diffraction. The term graphite herein used includes both, natural graphite, i.e. essentially in its geologically occurring natural crystalline form) and synthetic graphite, i.e. synthetically prepared or processed graphite. Examples of natural graphite include so-called amorphous (nanocrystalline) graphite, flake graphite, and vein graphite. Examples of synthetic graphite include pyrolytic graphite, highly oriented pyrolytic graphite (HOPG), synthetic graphite flakes. The term “synthetic graphite” as used herein unless further qualified also intends to include non-expanded and expanded forms of graphite (including expanded graphite that has been exfoliated).

The term “expanded graphite” (EG) as used herein refers to graphite or graphite flakes that have been expanded, i.e., increased in volume. Expansion may include exposure to an intercalation agent, formation of a graphite salt between graphite layers, and exposure to a high temperature shock treatment in which the intercalation agent escapes, leaving behind a gap between the graphite layers. Expanded graphite for use in the present processes may be produced by any fabrication method known in the art, including for instance chemical insertion followed by thermal expansion.

For instance, expanded graphite may be formed by heat treatment of expandable graphite. Generally, expanded graphite, differently from expandable graphite, shows an increased interlayer spacing and higher carbon content both due to the heat treatment procedure. The term “expandable graphite” refers to pre-treated graphite in which the layered crystal graphite structure is intercalated with small molecules such as sulphur or nitrogen compounds. The layered, planar structure of graphite allows that atoms or small molecules can intercalate between the carbon layers. Expandable graphite appears as a dry material with a minimal acidity since the intercalant is sealed within its carbon lattice. During this process so-called expandable graphite is produced. Expandable graphite is commercially available, or can be manufactured for example by acid treatment of graphite flake in nitric and sulphuric acid. The expandable graphite still retains the interlayer distance of natural flake graphite, and is chemically stable under air condition and can be easily stored. Graphite, particularly flake graphite, can be treated with acid such as sulphuric acid, nitric acid, or acetic acid to intercalate into the crystal layers of the graphite. The introduction of acid into the graphite layers can be supported by treatment with oxidants or by electrochemical treatment. After the reaction, the expandable graphite can be neutralized, washed, and dried. While the carbon atoms are tightly bound to each other within a layer, the layers themselves can be expanded and separated. When expandable graphite is then exposed to heat treatment an expansion of the intercalated graphite layers is induced. Generally, expanded graphite, differently from expandable graphite, shows an increased interlayer spacing and higher carbon content both due to the heat treatment procedure.

In certain preferred embodiments, said non-porous carbon-based catalyst is graphite felt. The term “graphite felt” (GF) as used herein refers to carbon felt, i.e. a textile material that predominantly comprises randomly oriented and intertwined carbon filaments or fibers, that has been subjected to a graphitisation process, which may involve heat treating the carbon felt at high temperatures, such as in the range of about 2600° C. to about 3300° C. During the graphitising process, the randomly oriented and intertwined carbon filaments or fibers may be converted into a three-dimensionally ordered graphite structure.

In certain preferred embodiments, said non-porous carbon-based catalyst is carbon felt. The term “carbon felt” (CF) as used herein refers to a textile material that predominantly comprises randomly oriented and intertwined carbon filaments or fibers. The term “felt” refers to a non-woven textile formed from natural (e.g., plant (e.g., bamboo) or animal (e.g., wool)) fibers or synthetic (e.g., polyester, polypropylene, fluoropolymers (e.g., PTFE), polyacrylonitrile, any combination thereof, or the like) fibers, wherein the fibers are compressed and matted together until they connect to form a fabric (e.g., cloth). Without limitation, carbon felt suitable for use in the instant invention is commercially available e.g. from Avcarb or Cera Materials. In some embodiments, the carbon felt has a thickness of from about 2 mm to about 20 mm. For example, the carbon felt may have a thickness of from about 4 to about 15 mm, from about 6 to about 10 mm, or from about 2 to about 6 mm. The CF can be also used with different configurations, e.g. as such, or in “rolled” configuration, for giving a different surface contact.

A non-porous carbon catalyst as applied herein as used in the present invention may have different morphologies. The morphology or form of a non-porous carbon catalyst as used herein is not particularly limited and may for instance include grains, felt, fibers, filament, 2D or 3D fabrics, etc. In certain embodiments, a nonporous carbon catalyst as used herein may also have other morphologies, such as extrudates or trilobes, with the proviso that such morphologies do not have pores within the solid matrix, and have a BET specific surface area not exceeding 5 m²/g. For instance, a non-porous carbon catalyst as used herein has various morphologies, and may have an average particle diameter of at least 0.1 μm, and preferably between 0.1 and 20000 μm; or between 10 and 10000 μm, or between 200 and 2000 μm, as determined by SEM microscopy or by sieving according to ASTM D4513-11.

For instance, in certain embodiments, a non-porous carbon carbon-based catalyst as used herein has a fibrous shape, e.g. with aspect ratios of about 1000:1 (i.e. 10-100 nm wide×100-1,000,000 nm long).

A preferred example of a non-porous carbon catalyst for use in the present invention is graphite felt, preferably with the following dimensions: fiber diameter of ca. 10 μm and length up to several millimetres.

As used herein, the term “porous” carbon catalyst refers to carbon catalysts (as defined herein) having mesopores and/or macropores. Mesopores are pores having a diameter within the range of from about 2 nm to about 50 nm. Macropores are pores having a diameter of more than 50 nm. A microporous material is typically defined as a material having pores smaller than 2 nm in diameter.

In preferred embodiments, a “porous carbon catalyst” intends to refer to a carbon catalyst (as defined herein) which has BET surface area of more than 5.0 m²/g, such as from 10.0 to 2000 m²/g, or from 10.0 to 1000 m²/g, or from 100 to 700 m²/g, or from 200 to 600 m²/g, as determined by ASTM-D-3663 (2020).

In preferred embodiments a porous carbon catalyst may have a total pore volume of at least 0.05 ml/g, and preferably at least 0.10 ml/g. Total pore volume may be determined by techniques that are known to the skilled person following established standard protocols.

In a preferred embodiment, a porous carbon catalyst as applied herein has a metal concentration which is less than 5000 ppm, or less than 3000 ppm, or less than 2000 ppm, or less than 1000 ppm, or less than 500 ppm, or less than 300 ppm, or less than 100 ppm, or less than 50 ppm based on the total weight of the porous carbon catalyst.

In certain preferred embodiments, a porous carbon catalyst as applied herein has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the porous carbon catalyst.

In a preferred embodiment, a porous carbon catalyst as applied herein is substantially free of metal, or preferably is free of metal as defined herein above.

In a preferred embodiment, a porous carbon catalyst as applied herein is rich is defects, such as points, lines, interface and/or bulk defects. Consequently, in certain preferred embodiments, a porous carbon-based catalyst for use in the present invention is characterised by a Raman coefficient I_{D}/I_{G} (as defined herein above) which is higher than 0.10, such as higher than 0.20, or higher than 0.30, wherein I_{D} corresponds to the intensity of the Raman spectrum in said D peak; and I_{G} corresponds to the intensity of the Raman spectrum in said G peak.

In some embodiments of the present invention, a porous carbon-based catalyst as used herein may be characterised in that it has an electric resistivity (as defined herein above) comprised between 10⁻⁸ and 10² ohm·m at 20° C., between 10⁻⁷ and 10² ohm·m at 20° C., as determined by ASTM C611-98 (2016).

Several forms of carbon can be applied as a porous catalyst in the present invention. In some preferred embodiments, said porous carbon-based catalyst is selected from the group comprising, or consisting of, mesoporous carbon, carbon black, acetylene black, active carbon, carbon nanofiber (CNF), carbon nanotubes (CNTs), and any combinations thereof.

As used herein, the term “carbon nanofiber” or “CNF” means and includes a carbon-containing material comprising a solid cylindrical shape, with prismatic planes exposure, substantially free of voids (e.g., without a hollow central portion). A carbon nanofiber may be similar to a carbon nanotube (CNT), but may include a solid core rather than a hollow central portion, and prismatic planes exposure instead of basal ones. Carbon nanofibers may exhibit a rod-like shape and may exhibit a greater density than CNTs. In some embodiments, carbon nanofibers may exhibit a greater density than CNTs having the same diameter. Carbon nanofibers may also be in the form of stacked graphene sheets. Carbon nanofibers may be formed through any method known in the art, including deposition from carbon vapour, such as by catalytic chemical vapour deposition (CCVD) wherein carbon is deposited in the presence of a transition metal catalyst on a substrate, or other methods of forming carbon nanofibers known in the art.

In certain embodiment, carbon nanofibers as used herein have a length of about 100-1000 nm, such as about 150-500 nm. In certain embodiment, carbon nanofibers as used herein have the aspect ratio, i.e. the ratio of length to the outer diameter, of preferably more than about 10, such as more than about 50, or more than about 100, or more than about 1000, or more than about 2000.

In certain embodiments, carbon nanofibers as used herein comprise carbon nanofibers having a mean average diameter less than 1000 nm. In certain embodiments, the carbon nanofibers have a mean average diameter less than 500 nm, such as less than 300 nm. For example, carbon nanofibers may have a mean average diameter between about 50 and 300 nm, such as between about 50 and 250 nm.

As used herein, the term “carbon nanotube” or “CNT” means and includes a hollow cylindrical or tube shape carbon molecule, defining a void therein, which may be empty or filled with another material. CNTs may be closed at one or both ends. CNTs may be conceptualized as rolled graphene sheets, having a hexagonal lattice of carbon molecules with basal planes exposure. Depending on the rolling degree and the way the original graphene sheet is formed, carbon nanotubes of different diameter and internal geometry can be formed. Carbon nanotubes formed by rolling up of a single sheet forming the aforementioned cylinder, are called “single-walled” carbon nanotubes. The carbon nanotubes formed by rolling up more than one sheet of graphene with a structure that resembles a series of concentric cylinders of increasing diameters from the centre to the periphery are called “multi-walled” carbon nanotubes. Suitable carbon nanotubes for use in the present invention encompass single-walled carbon nanotubes as well as multi-walled carbon nanotubes. In certain embodiments wherein carbon nanotubes are multi-walled carbon nanotubes, the multi-walled carbon nanotubes comprise include 2 or more, such as from 2 to 5, graphitic layers.

In certain embodiments, carbon nanotubes as used herein have a high aspect ratio, i.e. length-to-diameter ratio, preferably an aspect ratio of between 10 and 10,000,000 to 1, such as between 100 and 10,000 to 1.

In certain embodiments, carbon nanotubes as used herein have an average outer diameter of about 2 to 20 nm, such as about 5 to 15 nm, such as about 8 to 12 nm, such as about 10 nm. The average inner diameter of carbon nanotubes as used herein can be about 0.5 to 100 nm, or about 1 nm to 50 nm.

A porous carbon catalyst as applied herein as used in the present invention may have different morphologies. The morphology or form of a porous carbon catalyst as used herein is not particularly limited and may for instance include grains (particles), an extruded form, e.g. rod-shaped, sticks, particles, the form of a trilobe, ring, cellular foam, monolith.

For instance, in certain embodiments, a porous carbon catalyst as used herein has a cylindrical shape, e.g. with aspect ratios of about 5:1 (i.e. 1 mm diameter×5 mm long). Smaller aspect ratio such as 3:1 or 2:1 could also be used and it is also dependent on the diameter of the material

In certain embodiments, a porous carbon catalyst as used herein has various morphologies, i.e. grains, spherical, extrudates, trilobes, foam or monolith, and may have an average particle diameter of at least 0.1 μm, and preferably between 0.1 and 20000 μm; or between 10 and 10000 μm, or between 200 and 2000 μm, as determined by SEM microscopy or by sieving according to ASTM D4513-11. Examples of suitable forms of porous carbon catalysts include grains (0.1 to 5 mm), extrudates (e.g. with diameter of 1 to 5 mm and lengths up to 2, 3, 4, 5, 6 or more mm), trilobes (diameter ranged between 1 to 5 mm and length between 1 to 10 mm), monolith with ppi (pores per inch) ranged from 60 to 10 ppi and length up to several centimetres.

The present catalyst composition may comprise a non-carbon material, which may be applied as support material from the one or more carbon catalysts in the composition.

The term “non-carbon” or “non-carbon material” in this respect denotes any material that does not contain carbon. A non-carbon material for use in the present catalyst composition may be porous or non-porous (as defined herein). In certain preferred embodiments of the invention, a non-carbon material consists of a zeolitic material. The term “zeolitic material”, “zeolitic support material” are used herein as synonyms and refer to a material made of a zeolite.

In certain preferred embodiments of the invention, a non-carbon material consists of a ceramic material. The term “ceramic” or “ceramic material” or “ceramic support material” as used herein refers to an inert, inorganic and non-metallic material. Hence, in term “ceramic” does not encompass materials containing carbon.

In an example, the non-carbon material may be a porous ceramic material (e.g. alumina) or a zeolitic material (e.g. zeolite). In another example, the non-carbon material may be a non-porous non-carbon material, such as Zetex+, quartz wool, etc.

In preferred embodiments, a “non-carbon material”, preferably a ceramic or zeolitic support material, has BET surface of at most 2000 m²/g, or at most 1000 m²/g, or between 0.1 and 1000 m²/g, or between 0.1 and 700 m²/g, or between 0.1 and 600 m²/g, or between 0.1 and 500 m²/g, or between 5.0 and 300, or between 50.0 and 600 m²/g, as determined by ASTM-D-3663 (2020).

In preferred embodiments, a “non-carbon material”, preferably a ceramic or zeolitic support material, has a total pore volume of at least 0.1 ml/g, and preferably at least 0.2 ml/g. Total pore volume may be determined by techniques that are known to the skilled person following established standard protocols.

Non-carbon materials, for use in the present invention, include but are not limited to for instance alumina such as alpha- and gamma-Al₂O₃; quartz (SiO₂); zirconia such as ZrO₂, zeolites, silica, silicon carbide, silica wool, quartz wool, etc.

The morphology or form in which the non-carbon material is used in the present invention is not particularly limited and may for instance include grains, an extruded form, e.g. rod-shaped, sticks, particles, the form of a trilobe, ring, felt, fibers, filament, 2D or 3D fabrics, cellular foam, monolith, etc. In certain embodiments, a non-carbon material as used herein has various morphologies, i.e. grains, spherical, extrudates, trilobes, foam or monolith, and may have an average particle diameter of at least 0.1 μm, and preferably between 0.1 and 20000 μm; or between 10 and 10000 μm, or between 200 and 2000 μm, as determined by SEM microscopy or by sieving according to ASTM D4513-11. Examples of suitable forms include grains (0.1 to 5 mm), extrudates (e.g. with diameter of 1 to 5 mm and lengths up to 2, 3, 4, 5, 6 or more mm), trilobes (diameter ranged between 1 to 5 mm and length between 1 to 10 mm), monolith with ppi (pores per inch) ranged from 60 to 10 ppi and length up to several centimetres.

In certain preferred embodiments, a catalyst composition for use herein comprises:
(I) A first component, wherein said first component is selected from one or more non-porous carbon catalysts having a BET surface area of at most 5.0 m²/g, and/or one or more porous carbon catalysts having a BET surface area of more than 5.0 m²/g, and
(II) Optionally, a second component, wherein said second component consists of a ceramic or zeolitic support material, and has a BET surface area of between 0.1 and 600 m²/g, wherein BET surface area is determined by ASTM-D-3663 (2020).

In certain preferred embodiments, a catalyst composition for use herein comprises:
(I) A first component, wherein said first component is selected from one or more non-porous carbon catalysts having a BET surface area of at most 5.0 m²/g, and one or more porous carbon catalysts having a BET surface area of more than 5.0 m²/g, and
(II) Optionally, a second component, wherein said second component consists of a ceramic or zeolitic support material, and has a BET surface area of between 0.1 and 600 m²/g.

In certain preferred embodiments, a catalyst composition for use herein comprises:
(I) A first component, wherein said first component is selected from one or more non-porous carbon catalysts having a BET surface area of at most 5.0 m²/g, and
(II) Optionally, a second component, wherein said second component consists of a ceramic or zeolitic support material, and has a BET surface area of between 0.1 and 600 m²/g.

In certain preferred embodiments, a catalyst composition for use herein comprises:
(I) A first component, wherein said first component is selected from one or more porous carbon catalysts having a BET surface area of more than 5.0 m²/g, and
(II) Optionally, a second component, wherein said second component consists of a ceramic or zeolitic support material, and has a BET surface area of between 0.1 and 600 m²/g.

The present invention provides different ways for preparing a catalyst composition for use in the present method.

In certain embodiments, a catalyst composition as defined herein is formed by applying a first component (as defined herein) on a second component (as defined herein), and for instance on a (part of) a surface of said second component. In an example, a catalyst composition as defined herein is formed by applying a non-porous carbon catalyst on a surface of a non-carbon material. In another example, a catalyst composition as defined herein is formed by applying a porous carbon catalyst on a surface of a non-carbon material. In another example, a catalyst composition as defined herein is formed by applying a non-porous carbon catalyst on a surface of a porous non-carbon material. In another example, a catalyst composition as defined herein is formed by applying a non-porous carbon catalyst on a surface of a non-porous non-carbon material. In another example, a catalyst composition as defined herein is formed by applying a non-porous carbon catalyst on a surface of a porous ceramic or zeolitic material. In another example, a catalyst composition as defined herein is formed by applying a non-porous carbon catalyst on a surface of a non-porous ceramic material.

In certain other embodiments, a catalyst composition as defined herein may also be formed by applying a non-porous carbon catalyst on a surface of a porous carbon catalyst.

The term “applying on” in this context may be used as a synonym for “applying on the surface” or “depositing of the surface” or “supporting on”, or “impregnating” or the like. It will be understood that in accordance with the present invention, the resulting catalyst composition, may be used as such or may further processed for instance to obtain a certain 2D or 3D shape. In this way, two types of materials/catalysts may be combined in an integrated way: the two types of catalysts/material, e.g. non-porous carbon/porous carbon, or non-porous carbon/non carbon material, can be implemented directly in a compartment of a reactor, for instance by winding one material on the other.

In certain embodiments, a catalyst composition as defined herein is formed by enrolling said first component (e.g. a non-porous carbon catalyst, or a porous carbon catalyst) with said second component (e.g. a ceramic or zeolitic support material), or by enrolling said second component with said first component, to form a layered material.

In certain embodiments, a catalyst composition as defined herein is formed by impregnating a porous carbon catalyst with a non-porous carbon catalyst. In certain embodiments, a catalyst composition as defined herein is formed by impregnating a non-carbon material with a non-porous carbon catalyst. In certain embodiments, a catalyst composition as defined herein is formed by impregnating a non-carbon material with a porous carbon catalyst.

In certain preferred embodiments in which a catalyst composition as defined is formed by applying (such as impregnating) a nonporous carbon catalyst on a surface of a porous carbon catalyst, or non-carbon material, the resulting catalyst composition is provided in a single catalyst bed, preferably a fixed catalyst bed.

In certain other embodiments, a catalyst composition as defined herein may also formed by separately arranging a first component and a second component as defined herein, in series, wherein said first component is arranged upstream of said second component. In an example, a catalyst composition as defined herein may be formed by separately arranging a non-porous carbon catalyst(s) and a non-carbon material in series, wherein said non-porous carbon catalyst(s) is(are) arranged upstream of said non-carbon material.

In certain other embodiments, a catalyst composition as defined herein may also be formed by separately arranging said non-porous carbon catalyst(s) and said porous carbon catalyst(s) in series, wherein said non-porous carbon catalyst(s) is(are) arranged upstream of said porous carbon catalyst(s). According to such embodiment, a reaction gas first reacts with the non-porous carbon catalyst, thereby generating hydrocarbons, such as C₂₊ hydrocarbons, and hydrogen, and then reacts with the porous carbon catalyst, preferably at a lower temperature, generating hydrogen and solid carbon. The resulting solid carbon may be deposited on the surface or in the porosity of the catalyst composition.

For instance, in embodiments in which a catalyst composition as defined is formed by separately arranging a nonporous carbon catalyst and a porous carbon catalyst, or a ceramic/zeolitic material, separated from each other, in series (tandem) arrangement, the resulting catalyst composition can be provided in a single catalyst bed (having separate zone for each material) or in multiple catalyst beds. Preferably fixed catalyst bed (s) are applied. In this operating way, catalyst compositions are configured such that the hydrocarbon (e.g. methane) stream supplied to the reaction zone, first reacts in a first catalytic bed, with a non-porous carbon catalyst, e.g. such as felt or carbon or graphite fabric, expanded graphite, graphite powder, graphite foam, to generate compounds based on heavier hydrocarbons, such as C₂₊ hydrocarbons and hydrogen. The gaseous effluent leaving the first catalytic bed is then converted, by adsorption/decomposition, into a second catalytic bed on porous materials (carbon or ceramic/zeolitic), as described above, preferably at a lower temperature, to give hydrogen and solid carbon deposited on the surface or in the porosity of the catalyst composition material.

In an example, a non-porous carbon catalyst and a porous carbon catalyst are provided in separate catalyst beds in a reaction zone for carrying out the process of the invention, whereby the non-porous carbon catalyst is arranged upstream of the porous carbon catalyst. In another example, a non-porous carbon catalyst and a porous carbon catalyst are provided in separate sections of a single catalyst bed, which is located in a reaction zone for carrying out the process of the invention, whereby the non-porous carbon catalyst is arranged upstream of the porous carbon catalyst.

In another example, the non-porous carbon catalyst and a non-carbon material such as a ceramic/zeolitic material are provided in separate catalyst beds in a reaction zone for carrying out the process of the invention, whereby the non-porous carbon catalyst is arranged upstream of the porous ceramic material. In another example, the non-porous carbon catalyst and the non-carbon material such as a ceramic/zeolitic material are provided in separate sections of a single catalyst bed, which is located in a reaction zone for carrying out the process of the invention, whereby the non-porous carbon catalyst is arranged upstream of the non-carbon material such as a ceramic/zeolitic material. According to such embodiments, a reaction gas first passes over and reacts with the non-porous carbon catalyst, and then passes over the non-carbon material. Hydrogen and solid carbon are generated during the process, and the resulting solid carbon may be deposited on the surface or in the porosity of the catalyst composition.

In will be understood that in accordance with the present invention, when separate catalyst beds are applied, such bed may be provided in a single reactor, but may also each be provided in a different reactor.

In certain embodiments of the present process, a susceptor material may be further provided to the reaction zone, such as the catalyst bed, comprising a catalyst composition as defined herein, wherein said susceptor material, is capable of responding to an electromagnetic field by generating heat, and is capable of transferring said heat to said catalyst composition.

The presence of such susceptor material in the reaction zone containing the catalyst composition, e.g. the catalytic bed containing the catalyst composition, advantageously improves the induction heating operation.

When subjected to an alternating electromagnetic field, a susceptor material as used herein, is capable of converting the electromagnetic energy into heat and communicates this heat to the catalyst composition. This heat may be the result of hysteresis losses and/or of eddy currents induced in the susceptor material, which depend in particular on electrical and magnetic properties of the susceptor material. Hysteresis losses occur in ferromagnetic or ferrimagnetic susceptor materials and result from the change in magnetic domains inside the material when the material is subjected to the influence of an alternating electromagnetic field. Eddy currents can be induced if the susceptor material is electrically conductive. In the case of an electrically conductive ferromagnetic or ferrimagnetic susceptor, heat can be generated by both eddy currents and hysteresis losses. In this case the heating is carried out essentially on the surface of the susceptor which can then transmit the heat to the surface of the catalyst composition, with which it is in (direct or indirect) contact.

Hence, in certain embodiment of the invention, a process is provided which further comprises the step of supplying a susceptor material to the reaction zone comprising a catalyst composition as defined herein, wherein said susceptor material, is capable of responding to an electromagnetic field by generating heat, and is capable of transferring said heat to said catalyst composition, and wherein said susceptor material is physically separated from said catalyst composition.

Preferably, a susceptor material for use in the present invention is selected from the group consisting of carbon/graphitic materials (for instance mesoporous carbon; activated charcoal, acetylene black); metals or metal alloys such as but not limited to aluminum, iron, copper, bronze, stainless steel, ferritic stainless steel, martensitic stainless steel, and austenitic stainless steel.

Aforementioned materials can be used as susceptors, and thus transfer the heat through conduction to the carbon catalyst used in the process of the invention. It is preferred that such susceptors are physically separated from the catalyst composition applied in the process, e.g. by means of a wall in the reaction zone or catalyst bed comprising the catalyst composition, which is thermally non-insulating so as to allow rapid and homogeneous transfer of heat from the susceptor to the catalyst composition, and in particular from the susceptor to the carbon catalyst in said composition.

The percentage of saturated hydrocarbons in the reaction gas that are decomposed into hydrogen and carbon preferably greater than 5.0%, or greater than 7.0%, or greater than 10.0%, or greater than 15.0%, or greater than 20.0%, or greater than 30.0%, or greater than 40.0%, or greater than 50.0%, or greater than 60.0%, or greater than 70.0%. Conversion percentage is defined as explained in the example section below, taking methane as example. Conversions can be determined by using conventional methods such as gas chromatography or the like. In an example, the amount of methane in the reaction gas converted to hydrogen is preferably greater than 5.0%, or greater than 7.0%, or greater than 10.0%, or greater than 15.0%, or greater than 20.0%, or greater than 30.0%, or greater than 40.0%, or greater than 50.0%, or greater than 60.0%, or greater than 70.0%.

The present invention further allows to produce hydrogen at high yields. Hydrogen yields are defined as explained in the example section below. In certain embodiments, a process according to the invention allows to produce hydrogen at a yield of at least 50.0%, and preferably of at least 60.0%, or at least 70.0%, or of at least 80.0%, or of at least 90.0%, or at least 95.0%.

In certain preferred embodiments, a process of the invention may comprise the additional step of recovering at least a portion of a catalyst composition as defined herein from the reaction zone, after the hydrocarbon decomposition reaction carried out in accordance with a process as described herein, thereby obtaining a spent catalyst.

In the context of the present invention, the terms “spent catalyst composition” or a “modified catalyst composition” or a “spent catalyst” as used herein refer to the catalytic compound that is obtained after the hydrocarbon decomposition reaction, i.e. the used catalyst composition on which carbonaceous materials/carbon has been deposited”. It will be understood that the term “spent catalyst” or its synonyms, refers to a catalytic compound that contains the carbonaceous materials deposited thereon. In certain preferred embodiments a process according to the invention may comprise the further step of subjecting the spent catalyst to a mechanical treatment to reduce the size of the said spent catalyst.

The spent catalyst obtained in a process according to the invention can be used in further downstream processing, e.g. as a (carbon) catalyst or as a source of carbon or to make graphite.

### Decomposition Process in the Presence of a Spent Catalyst Composition

In another aspect, the present invention provides processes for the production of hydrogen and carbon, and optionally hydrocarbons such as C₂₊ hydrocarbon(s), by catalytic non-oxidative decomposition of hydrocarbon(s), such as saturated C₁₊ hydrocarbon(s), in the presence of a spent catalyst composition comprising at least one carbon catalyst as defined herein.

In certain embodiments, the present invention provides a process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
a) supplying a spent catalyst to a reaction zone,
b) heating said spent catalyst in said reaction zone to a temperature comprised between 500° C. and 1100° C. by means of induction heating; and
c) decomposing said hydrocarbon or mixtures thereof, preferably said saturated C₁₊ hydrocarbon or mixtures thereof, into hydrogen, carbon, and optionally hydrocarbons such as C₂₊ hydrocarbon(s); by bringing said reaction gas into contact with said heated spent catalyst composition in said reaction zone,

In certain embodiments, said spent catalyst supplied in step a) is prepared by carrying out a process according to the present invention. In certain embodiments, the spent catalyst supplied in step a) is thus prepared by carrying out a decomposition process over a fresh catalyst as described herein. In certain other embodiments, said spent catalyst supplied in step a) is prepared by carrying a decomposition process over (another) spent catalyst as described herein.

In certain other embodiment of the present invention, a process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
a) preparing a spent catalyst by a preparation process comprising the steps of:
   a1) supplying a catalyst composition to a reaction zone, wherein said catalyst composition comprises at least one carbon catalyst;
   a2) heating said catalyst composition in said reaction zone to a temperature comprised between 500° C. and 1100° C. by means of induction heating;
   a3) activating said heated catalyst composition by bringing said heated catalyst composition into contact with said reaction gas during an activation period of at least 5 hours, such as at least 6, 8, 10, 12, 15, 20, 25, 30, 35 hours,
   a4) optionally decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time,
   a5) recovering at least a portion of the catalyst composition from said reaction zone after step a3) and/or a4), thereby obtaining a spent catalyst, and optionally subjecting the spent catalyst to a mechanical treatment to reduce the size of the spent catalyst, and
b) supplying the spent catalyst to a reaction zone;
c) heating the spent catalyst in the reaction zone by means of induction heating to a temperature comprised between 500° C. and 1100° C.; and
d) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone.

In certain preferred embodiment of the present invention, a process is provided for the production of hydrogen and carbon, and optionally hydrocarbons such as C₂₊ hydrocarbon(s), by catalytic non-oxidative decomposition of a reaction gas in the presence of a spent catalyst, wherein the process comprises an activation period (as defined herein) which is less than 10 hours, preferably less than 5 hours, more preferably less than 1.0 hour even more preferably less than 0.5 hour. In certain particularly preferred embodiments, a process of the invention applying spent catalyst has no activation period. In other words, in such process, the spent catalyst shows immediate significant catalyst activity.

In yet another aspect, the present invention also relates to a process for preparing a spent carbon-based catalyst. In certain embodiments, a process is provided for preparing a spent catalyst comprising the steps of:
a1) supplying a catalyst composition to a reaction zone, wherein the fresh catalyst composition comprises at least one carbon catalyst,
a2) heating said catalyst composition in said reaction zone to a temperature comprised between 500° C. and 1100° C. by means of induction heating; and
a3) bringing, for a period of at least 5 hours, preferably at least 6, 8, 10, 12, 15, 20, 25, 30, 35 hours, a reaction gas comprising a hydrocarbon or mixtures thereof, and preferably a saturated C₁₊ hydrocarbon or mixtures thereof, into contact with said heated fresh catalyst composition in said reaction zone, thereby decomposing said hydrocarbon or mixtures thereof, preferably said saturated C₁₊ hydrocarbon or mixtures thereof, into hydrogen, carbon, and optionally hydrocarbons such as C₂₊ hydrocarbon(s); and generating a spent catalyst.

In certain embodiments, the invention provides a process for preparing a spent catalyst, comprises the steps of:
a1) supplying a catalyst composition to a reaction zone, wherein said catalyst composition comprises at least one carbon catalyst;
a2) heating said catalyst composition in said reaction zone to a temperature comprised between 500° C. and 1100° C. by means of induction heating;
a3) activating said heated catalyst composition by bringing said heated catalyst composition into contact with said reaction gas during an activation period of at least 5 hours, such as at least 6, 8, 10, 12, 15, 20, 25, 30, 35 hours,
a4) optionally decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time, and
a5) recovering at least a portion of the catalyst composition from said reaction zone after step a3) and/or a4), thereby obtaining a spent catalyst, and optionally subjecting the spent catalyst to a mechanical treatment to reduce the size of the spent catalyst.

It is preferred that the catalyst composition as applied in step a1) of the above preparation processes is a “fresh catalyst composition” a having the features as defined herein and comprising at least one carbon catalyst.

However, in certain other embodiments, the catalyst composition as applied in step a1) of the above preparation processes may also encompass a spent carbon-based catalyst, e.g. obtained with a process as described herein.

In certain preferred embodiments of the above preparation processes, the catalyst composition (fresh or spent) in step a), and the spent catalyst in step b) are supplied to a reaction zone that consists of one or more fixed bed reactors.

In certain preferred embodiments of the above preparation processes, induction heating comprises generating an alternating electromagnetic field within the reaction zone containing said catalyst composition upon energization by a power source supplying alternating current, where the alternating electromagnetic field passes through the reaction zone thereby generating an electric current in said catalyst composition and heating the catalyst composition. Preferably, the spent catalyst is heated in step c) to a reaction temperature of at most 1100° C., such as between 35° and 1100° C. In certain embodiments, a spent catalyst is heated to a reaction temperature which is comprised between 50° and 1100° C., such as between 50° and 900° C., or between 50° and 850° C., or between 50° and 750° C.; or between 60° and 850° C., or between 60° and 800° C.

In certain preferred embodiments of the above processes, the process is carried out at a reaction pressure comprised between 0.1 and 30.0 bar.

In certain preferred embodiments of the above processes, the reaction gas is as defined herein, and preferably comprises at least 80.0 mol %, such as at least 85.0 mol %, or at least 90.0 mol %, or at least 99.0 mol % of methane. Preferably said reaction gas is supplied to said reaction zone at a gas hourly space velocity (GHSV) of between 1 and 30 m³/kg/h, or of between 1 and 15 m³/kg/h.

It is further preferred that at least a portion of the spent catalyst is recovered after the decomposition step and re-cycled in said process. In certain embodiments, such recovered spent catalyst is mechanically treated to reduce its size, e.g. by grinding, prior to recycling thereof in said process. In certain embodiments, such recovered spent catalyst is not heated prior to recycling thereof in said process.

It is preferred that the above process involves a further step e) comprising the removal of the spent catalyst from the reaction zone after step d), treatment of the removed spent catalyst to reduce the size thereof, and re-supply of the treated spent catalyst to step b) of said process. Preferably this step e) may be repeated more than once.

In certain embodiments of the above processes, the spent catalyst has a metal concentration which is less than 5000 ppm, or less than 3000 ppm, or less than 2000 ppm, or less than 1000 ppm, or less than 500 ppm, or less than 300 ppm, or less than 100 ppm), or less than 50 ppm, based on the total weight of the spent carbon catalyst.

In certain embodiments of the above processes, the spent catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the spent carbon catalyst.

In certain embodiments of the above processes, the spent catalyst is metal free.

In certain embodiments of the above processes, the spent catalyst has a BET surface area of between 0.1 and 100 m²/g, preferably of between 0.1 and 50 m²/g, as determined by ASTM-D-3663 (2020).

In certain embodiments of the above processes, the spent catalyst has a Raman spectrum, as determined by Raman Spectroscopy using an excitation wavelength of about 532 nm and exciting laser power of about 100 milliwatt (mW); showing a first peak (D peak) at a wavenumber of about 1350 cm- and a second peak (G peak) at a wavenumber from about 1585 to about 1600 cm⁻¹, and wherein said spent catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.

In certain embodiments of the above processes, the spent catalyst has an electric resistivity of between 10⁻⁷ and 10² ohm·m at 20° C. as determined by ASTM C611-98 (2016).

### Use of Spent Catalyst

One way to use the spent catalyst is as a carbon-based catalyst or as a catalyst composition. This is unexpected, as deposition of carbonaceous material on a catalyst applied during a non-oxidative hydrocarbon decomposition process is generally understood to deactivate the catalyst. However, it was found that a spent catalyst obtained in a process of the invention retains relevant catalytic activity, despite the presence of carbon deposited thereon, and even shows improved decomposition activity and increased catalyst activity (as compared to the starting/fresh catalyst). Therefore, in some embodiments, a process according to the invention may comprise the further step of using at least a portion of the spent catalyst as obtained herein as a catalyst composition, or as a carbon-based catalyst.

Preferably, a spent catalyst recovered in a process of the invention is applied as a catalyst composition, or as a carbon-based catalyst without prior treatment to remove carbonaceous material deposited thereon. In other words, in certain embodiments, it is not required to have an expensive, energy consuming (e.g. combustion), and/or polluting (e.g. resulting in unwanted CO and/or CO₂ emissions) treatment of the spent catalyst. The present invention therefore beneficially adopts a closed production process which makes the operation easy, more cost effective, and avoids discharging (polluting) side reaction wastes in the whole process, such as e.g. CO and/or CO₂ emissions. The present invention allows resource recovery, cyclic utilization and environmental protection in the whole operation of the process.

In certain preferred embodiments, at least a portion of spent catalyst recovered in a process of the invention is supplied as a catalyst composition or as a carbon catalyst in a catalytic non-oxidative hydrocarbon decomposition process, preferably in a catalytic non-oxidative hydrocarbon decomposition process for decomposing saturated C₁₊ hydrocarbons, such as methane, into hydrogen and carbon, and more preferably in a catalytic non-oxidative hydrocarbon decomposition process as defined herein.

In a particularly preferred embodiment, a process of the invention encompasses the further step of supplying spent catalyst as defined herein to step a) of the process of the invention. It will be understood that in accordance with the invention, a spent catalyst as obtained in accordance with a process of the invention, is used as catalyst or as carbon-based catalyst in a decomposition reaction as given herein, provided that the deposited carbonaceous materials deposited on the spent catalyst are not removed prior to its use.

In certain embodiments said spent catalyst is subjected to a mechanical treatment to reduce the size of the spent catalyst before supplying it to step a) of the process as defined herein. In certain other embodiments, of the present process said spent catalyst is not subjected to a treatment to remove carbon deposited thereon before supplying it to step a) of the process as defined herein.

In certain embodiments of the present process, a catalyst composition covered by carbon (i.e. a spent catalyst) can be removed from the reactor/reaction zone, and then submitted to a mechanical treatment, e.g., a gentle mechanical shaking, to obtain a separation of the structures constituting the starting catalyst, before re-using it the same process. This mode of operation makes it possible to reduce the cost of catalyst load for the process and to better recycle the catalyst but also the carbon obtained during the process.

In some embodiments, solid carbon deposited on the spent catalyst contributes to an increase of the catalyst size and thus, after a certain time of operation, the spent catalyst can be submitted to a mechanical treatment to breakdown the size of the spent catalyst into some smaller fragments for re-use.

It was shown, see for instance examples 2 and 3 provided below, that re-using mechanically treated spent catalyst allows to obtain a direct decomposition of methane with yields significantly higher than obtained with the fresh catalyst (see e.g. example 1). The carbon structures deposited on the surface of the fresh catalyst, have a particularly suitable structure to produce solid carbon during the decomposition reaction. Hence, an increase in hydrocarbon (methane) decomposition activity into hydrogen and carbon, was observed in when a spent catalyst was reused in the process. Such results are surprising and it is unexpected that for a spent catalyst to provide even better conversion activities than its fresh counterpart.

Mechanical regeneration of the spent catalyst (e.g. by gently shaking to separate fragments, or by crushing or the like), allows to extend the life of the catalyst.

The Applicants unexpectedly found that this spent catalyst shows immediate significant catalyst activity. When applied as a catalyst in a hydrocarbon decomposition reaction as described herein, such spent catalyst is able to catalyse a hydrocarbon (e.g. methane) decomposition into hydrogen and carbon without requiring catalyst activation, or a certain period of time to reach sufficient catalyst activity. In other words, a decomposition process as provided herein wherein a spent catalyst is applied has a limited to no activation period. When using a spent catalyst the “activation period” during which the catalyst activity changes and reaches a steady-state activity is significantly reduced or even is absent.

A spent catalyst can immediately be used as effective and highly active carbon-based catalyst in a hydrocarbon decomposition process without the need to subject the spent catalyst to a chemical and/or thermal pre-treatment after its recovery, prior to its use. Such results are surprising because a skilled person would not expect a spent catalyst to provide instant and even better conversion activities than its fresh counterpart. In certain preferred embodiments of the present process, the recovered spent catalyst is subjected to a mechanical treatment, for instance grinding to reduce the size of the spent catalyst, before supply thereof to step a) of a process as defined herein.

In certain preferred embodiments of the present process, the recovered spent catalyst is not subjected to a treatment to remove carbon deposited thereon before supply thereof to step a) of a process as defined herein.

In certain preferred embodiments of the present process, the recovered spent catalyst is not heated before supply thereof to step a) of a process as defined herein.

In a further aspect of the invention, a spent catalyst as obtained by the present process can be further treated (regenerated) to valorize the carbon that was deposited on its surface. Spent catalyst regeneration should however be carried out in such a way that the deposited carbon is transformed into other volatile compounds apart from CO₂ in order to retain the benefits of the process as discussed above.

One treatment/regeneration method that may be used to treat the spent catalyst includes the reaction of the formed carbon with water vapour according to the below equation (Eq. 2):

C(s)+H₂O(g)↔CO(g)+H₂(g) (Eq. 2)

Such regeneration method may be carried out either directly on a spent catalyst composition of the invention, hence spent catalyst such as a carbon/carbon catalyst composition, or a carbon/non-carbon catalyst composition, thereby converting the deposited carbon into other products with higher added value such as H₂ and CO. The mixture H₂ and CO thus obtained can then be converted either into hydrocarbons by processes known to the skilled person, methanation or Fischer-Tropsch synthesis, for instance by then reacting this CO with water vapor (Eq. 3), to produce additional hydrogen.

CO(g)+H₂O(g)↔CO₂(g)+H₂(g) (Eq. 3)

Regeneration can also be carried out by passing an effluent containing CO₂ over a spent catalyst of the invention, in order to remove the carbon deposited thereon, according to the following Boudouard reaction (Eq. 4):

C(s)+CO₂(g)↔2CO(g) (Eq. 4)

This latter reaction even permits to carry out the process with a negative CO₂ balance since the carbon formed can react again with CO₂ to form CO which can then be used in various downstream reactions.

Given the interaction between the magnetic field induced by the induction heating device, and an electrically conductive carbon deposited thereon, e.g. on the surface of the catalyst in layers of the order of a few micrometers, higher catalyst surface temperatures are obtained during above different regeneration steps. Such higher temperatures allow to initiate gasification reactions from the outer catalyst layers, made-up by deposited carbon, without significantly impacting the catalyst at its core. In addition, it was shown that, seen the structure/morphology of the deposited carbon, a better interaction with the magnetic field is obtained for the spent catalyst, as compared to the fresh catalyst. As a result, in the regeneration methods, the spent will have to be heated at a higher temperature for a given power, and the deposited carbon layer will therefore react faster to water vapor during regeneration.

Another way of using a spent catalyst obtained by carrying out a process as given herein, is as a susceptor material, for instance in a process as defined herein.

In another aspect, the invention therefore also relates to a spent catalyst obtained or obtainable by carrying out a process as defined herein. A spent catalyst as obtained in the present processes may be characterised by a number of features, such as e.g. improved morphology, high electro-resistivity, improved composition, including a higher purity and limited levels of contaminants such as inorganic (e.g. Si, Al) or metallic (e.g. Ni, Mo, etc) contaminants.

In some embodiments, especially when the catalyst composition was based on carbon materials only, a spent catalyst preferably has a metal concentration which is less than 5000 ppm, or less than 3000 ppm, or less than 2000 ppm, or less than 1000 ppm. In a preferred embodiment, a spent catalyst according to the invention has a metal concentration which is less than 3000 ppm, or less than 2000 ppm, or less than 1000 ppm or less than 500 ppm, or less than 300 ppm, or less than 100 ppm, or less than 50 ppm, based on the total weight of the spent catalyst.

Preferably a spent catalyst has a metal concentration which is less than 0.5 wt %, or less than 0.3 wt %, or less than 0.2 wt %, or less than 0.1 wt %, or less than 0.05 wt %, or less than 0.03 wt %, or less than 0.01 wt %, or less than 0.005 wt %, based on the total weight of the spent carbon catalyst.

In certain preferred embodiments, a spent catalyst according to the invention is free of any metal (as defined herein above). Metal content of a spent catalyst as provided herein may be determined by the same techniques as mentioned above, such as e.g. inductive-coupled plasma and mass spectrometry.

In some embodiments, said spent catalyst is characterised by a Raman spectrum, as determined by Raman Spectroscopy using an excitation wavelength of about 532 nm and exciting laser power of about 100 milliwatt (mW); showing a first peak (D peak) at a wavenumber of about 1350 cm⁻¹ and a second peak (G peak) at a wavenumber from about 1585 to about 1600 cm⁻¹, and wherein said catalyst composition has a Raman coefficient I_{D}/I_{G} which is higher than 0.10, such as higher than 0.20, or higher than 0.30, wherein I_{D} corresponds to the intensity of the Raman spectrum in said D peak; and I_{G} corresponds to the intensity of the Raman spectrum in said G peak.

In some embodiments, said spent catalyst has a BET surface area of between 0.1 and 100 m²/g, preferably of between 0.1 and 50 m²/g, as determined by ASTM-D-3663 (2020).

In some embodiments, said spent catalyst according to the present invention may also be characterised in terms of how it resists electric current. In a preferred embodiment, a spent catalyst of the present invention has an electric resistivity of between 10⁻⁷ and 10² ohm·m at 20° C. as determined by ASTM C611-98 (2016).

A spent catalyst as defined herein, or obtained by carrying out a process as defined herein, may advantageously be used as a carbon catalyst. In preferred embodiments, the invention relates to the use of a spent catalyst as defined herein, or a obtained by carrying out a process as defined herein, as a carbon catalyst in a catalytic non-oxidative hydrocarbon decomposition process, preferably in a catalytic non-oxidative hydrocarbon decomposition process for decomposing saturated C₁₊ hydrocarbons, such as methane, into hydrogen and carbon, and more preferably in a catalytic non-oxidative hydrocarbon decomposition process as defined herein.

Another way to use the spent catalyst as defined herein is as a source for making graphite. In certain preferred embodiments, a process according to the invention may comprise the further step of processing the spent catalyst, optionally mechanically pre-treated to reduce its size, into graphite. In other words, the present invention also relates to the use of a spent catalyst according to the invention, or obtained by a process according to the invention, for preparing graphite. Methods for preparing graphite starting are generally known in the art. For instance, graphite may be prepared starting from a spent catalyst according to the invention by calcining/heating the spent catalyst to a temperature which is sufficiently high to produce graphite, e.g. to a temperature of at least 1200° C. or higher.

Another way to use the spent catalyst as defined herein is as a source for making other spent catalyst.

The present invention further provides a system for producing hydrogen and carbon by catalytic non-oxidative decomposition of saturated C₁₊ hydrocarbons, wherein the system comprises:
at least one reaction zone configured to receive a catalyst composition, and preferably comprising a fixed and/or moving catalyst bed for containing said catalyst composition;
at least one inlet line for feeding a reaction gas comprising saturated C₁₊ hydrocarbons, and preferably comprising methane, into said reaction zone;
at least one flow controlling means for controlling reaction gas flow rate to the reaction zone;
at least one outlet line for recovering the reaction product stream exciting the reaction zone, and for separation of hydrogen from the unreacted hydrocarbon or some other hydrocarbons formed during the process (and present in said reaction product stream);
at least one outlet line for recovering hydrogen from said reaction zone;
at least one induction heating device configured for inductively heating a catalyst composition contained within said reaction zone to a reaction temperature effective for the non-oxidative decomposition of saturated C₁₊ hydrocarbons into hydrogen and carbon in the presence of said catalyst composition;
at least one temperature setting device for regulating the set temperature of the reaction;
optionally, at least one temperature measuring device for determining the reaction temperature;
optionally, at least one heating device for pre-heating the reaction gas before entering said reaction zone; and
optionally, at least one recovery unit for recovering from said reaction zone at least a portion of the catalyst composition spent during said non-oxidative decomposition.

For example, an induction heating device (herein also “induction heater” or “inductor”) may be advantageously configured to directly heat the catalyst composition provided within the reaction zone. The induction heating device (induction heater) may for instance extend around a portion of the exterior surface of the reaction zone. The heat from the catalyst composition (acting as susceptor) can advantageously be used to directly heat the reaction gas within the reaction zone. Direct heating of reaction gas within the reaction zone is energetically efficient and allows great control over the rate at which the gas within the reaction zone is heated.

In preferred embodiments of a system as provided herein, said induction heating device comprises
at least one induction element such as an induction coil or induction ring, positioned to surround said catalyst composition, and
an alternating current (AC) power supply electrically connected to said induction coil or induction ring and capable of supplying an alternating current having a suitable frequency to said induction coil or induction ring, such as a frequency alternating between 2 and 500 kHz.

Preferably, the induction heater includes an induction coil or induction ring which is arranged to be powered by a power source supplying alternating current and which is positioned to generate an alternating magnetic field within the reactor zone upon energization by the power source, whereby the catalyst material is heated to a given temperature by means of said alternating magnetic field. An induction heating device for use in the invention may be configured to provide an alternating current having a frequency of at least 2 Khz. The induction heating device may be configured to provide an alternating current having a frequency of up to 0.5 MHz. Preferably, the induction heater may be configured to provide an alternating current between 2 and 500 kHz. The frequency of the alternating current provided by the induction heater is advantageously selected to facilitate uniform and localised heating of the catalyst composition material within the reaction zone in order to obtain a highly efficient process.

The induction coil or induction ring can for instance be placed around the reaction zone containing the catalyst composition. In an example, an induction coil or said induction ring of the induction heating device may be positioned inside the reaction zone or in the wall of the reaction zone, and is configured to define a space provided within said induction coil or induction ring capable of receiving said catalyst composition.

In another example, induction coil or said induction ring of the induction heating device is positioned outside the reaction zone, and is configured to surround at least part of the section of the reaction zone containing the catalyst composition.

In an example, an induction heater (e.g. EasyHeat® 8310, 4.2 kW, Ambrell Ltd) is constituted by a spiral 6-turn induction coil (length was 1.05 m, pure coil resistance was 2.066×10⁻³Ω), cooled by means of an external chiller containing a water/glycerol (10%, v/v) as cooling mixture. A reactor containing the catalyst composition can be housed inside the induction heater coils and temperature real-time control/regulation can be ensured by a manager unit (Proportional Integral Derivative controller, Eurotherm model 3504) connected to a laser pyrometer (Optris®, diameter laser beam: about 500 μm, power <1 mW, located at about 15 cm from the catalyst) C) shot up on the catalyst bed, and working in the 150-1000° C. range with an accuracy ±1°. The heating/cooling rate allowed for the system is for instance 60-80° C. min⁻¹ in the operational temperature range. The catalyst may for instance be housed in a quartz tubular reactor (e.g. inner diameter of 24 mm, length of 800 mm) between quartz wool plugs to ensure the homogeneous flow distribution. The reactor can then be purged with an inert gas, e.g. a pure argon flow at room temperature for 30 minutes, and then the inert gas flow is replaced by the reaction gas. The exit line can be heated with heating tape maintained at e.g. 150° C. to prevent condensation of heavy products before the gas chromatography analyser.

As indicated hereinabove, a reaction zone may be an individual reactor, or a reactor may comprise reaction zones in series or in parallel. Any reactor configured to allow the contact of a reaction gas with the catalyst composition provided in said reaction zone/reactor may be used. For example, reactors with a fixed bed or moving bed may be applied. In an example, and depending on the type of catalyst composition used, the reactor or reaction zone may include a single catalyst bed, e.g. fixed or moving, preferably fixed. In another example, the reactor or reaction zone may comprise one or more fixed catalyst beds and/or one or more moving catalyst beds.

For instance, when using a catalyst composition in the present invention, in which the catalyst composition is formed by separately arranging a non-porous carbon catalyst and a porous carbon catalyst in series, wherein said non-porous carbon catalyst is arranged upstream of said porous carbon catalyst, the non-porous and the porous carbon catalysts can be provided in a single catalyst bed provided in one reactor or in separate catalyst beds that are provided in a same or in different reactors.

In another example, when using a catalyst composition in the present invention, in which the catalyst composition is formed by separately arranging a non-porous carbon catalyst and a non-carbon catalyst in series, wherein said non-porous carbon catalyst is arranged upstream of said non-carbon material, the non-porous and the porous carbon catalysts can be provided in a single catalyst bed provided in one reactor or in separate catalyst beds that are provided in a same or in different reactors.

A system according to the invention may also comprises a temperature measuring device capable of measuring the reaction temperature within the reaction zone, for instance at different points of the catalyst bed, such as a thermocouple.

In another example said temperature measuring device comprises a device capable of measuring the temperature at the outer surface of the reaction zone, such as for instance a laser pyrometer.

A system according to the invention may further comprise a heating device for pre-heating the reaction gas before entering said reaction zone.

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

### EXAMPLES

Below examples report the production of hydrogen and carbon by catalytic non-oxidative decomposition of hydrocarbons, in particular of methane, carried out in the presence of a catalyst composition as defined herein. In all examples, the applied catalyst composition was heated by means of induction heating means. In the following examples the hourly spatial velocities were expressed in relation to the weight of the carbon catalyst used. The weight of a second catalyst is reported where applicable.

### Methods

Catalyst morphology: the morphology of a sample of a catalyst can be explored by utilizing Scanning electron microscopy (SEM) (ZEISS GeminiSEM 500 microscope with a resolution of 5 nm) according to techniques well known in the art. A sample of carbon-based catalyst is deposited onto a double face graphite tape in order to avoid charging effect problems during the analysis.

Catalyst average particle diameter can be determined by scanning electron microscopy (SEM) (ZEISS GeminiSEM 500 microscope with a resolution of 5 nm) according to techniques well known in the art or as by sieving according to ASTM D4513-11.

Catalyst surface area (BET surface area) is determined according to ASTM-D-3663 (2020). The specific surface area of a sample of a carbon catalyst can be calculated from the nitrogen isotherm using the BET method and t-plot method, respectively. The latter was performed on a ASAP2420 (Micromeritics) using N₂ adsorption at 77 K. Before the N₂ adsorption, samples are heated at 250° C. for 3 h under dynamic vacuum to desorb surface impurities.

Practically, in the present examples a porosimeter apparatus Micromeritics ASAP2420 with a commonly automatized program of analysis based on the adsorption-desorption isotherms at relative pressure P/Po of nitrogen at the nitrogen liquid temperature was used. The software will calculate desired parameters such as SBET, pore size distribution, micropore surface area, and total pore volume. The following procedure was applied. Prior to analysis, a sample was degassed to remove physically bonded impurities from the surface of the material. This was accomplished by heating the sample to a temperature of 250° C. under dynamic vacuum for 12 hours in order to desorb moisture and adsorbed impurities on its surface, and nitrogen was used as inert gas. The specific surface area of the analysed material was then determined by the physical adsorption of a nitrogen onto the surface of the sample at liquid nitrogen temperature (77K) at varying relative pressures. The apparatus software deduces from the adsorption-desorption isotherms parameters, including BET surface area (m²/g), micropore surface area (m²/g), total pore volume (cm³/g); catalyst pore size distribution (nm).

The level of defects, such as points, lines, interfaces and/or bulk defects, of a carbon catalyst or graphite derivative according to the invention was determined using Raman spectroscopy. The Raman spectra were recorded using a LabRAM ARAMIS Horiba Raman spectrometer equipped with a Peltier cooled CCD detector. A laser line (532 nm/100 mW (YAG) with Laser Quantum MPC600 PSU) was used to excite the catalyst sample.

Electric-resistivity (in ohm·m) of a carbon catalyst or graphite derivative at room temperature (20° C.) according to the invention is determined according to ASTM C611-98(2016).

Thermogravimetric analyses (TGA) were performed under air (25 mL/min) on a TGA Q5000 Sorption Analyzer (TA Instrument). The temperature was raised to 1000° C. at a heating rate of 10° C./min.

Temperature-programmed reduction of hydrogen (H₂-TPR) can be conducted on a Micromeritics ASAP-2100 setup equipped with a multichannel mass spectrometer (ThermoStar TM GSD 301 T (Pfeiffer Vacuum)). In a typical procedure, 50 mg of the sample was heated for 1 h at 130° C. under an Ar-stream, and then cooled to room temperature. Next, the stream is switched from Ar to a 10% H₂/Ar mixture (50 mL/min), while increasing the sample temperature at a rate of 10° C./min. The evolved species are monitored through the intensities of m/z is 2 (H₂).

Determination of hydrogen, C₁ and C₂ hydrocarbons: detection of hydrogen C₁ and C₂ hydrocarbons was conducted by connecting the reactor outlet to a micro gas chromatography (SRA R3000 SRA Instrument Ltd.).

### Reactor Set-Up

In the below given examples, the reaction was carried out in a tubular quartz reactor with an inner diameter of 24 mm and a length of 800 mm. The non-isolated quartz reactor containing the catalyst composition was placed inside an induction heater coil with an inner diameter of 34 mm. The temperature of the set-up was monitored and controlled with a laser pyrometer, aimed on the outside of the reactor. The induction heating setup (EasyHeat® 8310, 4.2 kW, Ambrell Ltd) is made of a 6-turn spiral induction coil (length was 1.05 m, pure coil resistance was 2.066×10⁻³ ohm), cooled by means of an external chiller containing a water/glycerol (10%, v/v) as cooling mixture. The temperature at the catalyst bed was monitored/controlled/regulated in almost real-time by a PID system (Proportional Integral Derivative controller, Eurotherm model 3504) connected to a laser pyrometer (Optris®, diameter laser beam: about 500 μm, power lower than 1 mW, located at about 15 cm from the catalyst and working in the 150-1000° C. range with an accuracy ±1° C.), shot up on the catalyst/susceptor. The inductor frequency was constantly maintained at 265±5 kHz while the current flowing the induction coils varied from 20 to 650 A. All gas flows were controlled using Brooks 5850TR mass flow controllers. The reactions were carried out at a reference condition of 750° C. with a total flow set to 60 ml/min of CH₄, unless differently specified.

The reaction products were analysed on-line by thermal conductivity detector (TCD) with a micro gas chromatography (R3000 SRA Instrument equipped with MS5A columns for H₂, CH₄ detection and PPU columns for CO₂, C₂H₆, C₂H₄ and C₂H₂ detection). A soap film flowmeter was used to measure the gas flow rate. The molar concentration of every product was determined by standard calibration of gas mixture.

### Conversion Rate and Product Yields

Methane conversion (X_{CH4}), product i selectivity (Sᵢ), product i yield (Yᵢ), hydrogen yield (Y_{H2}) and carbon balance were calculated according to the following equations (1)-(5):

$${X}_{{CH}_{4}} = \frac{{F}_{{CH}_{4} , i n} - {F}_{{CH}_{4} , out}}{{F}_{{CH}_{4} , i n}} \times 100 \% \qquad ( 1 )$$

$${S}_{i} = \frac{{n}_{i} \times {F}_{i , out}}{{F}_{{CH}_{4} , i n} - {F}_{{CH}_{4} , out}} \times 1 \; 00 \% \qquad ( 2 )$$

$${Y}_{i} = \frac{{n}_{i} \times {F}_{i , out}}{{F}_{{CH}_{4} , i n}} \times 1 \; 00 \% \qquad ( 3 )$$

$${Y}_{{H}_{2}} = \frac{2 \times {F}_{{H}_{2} , out}}{4 \times {F}_{{CH}_{4} , i n}} \times 1 \; 00 \% \qquad ( 4 )$$

$$Carbon balance = \frac{\begin{matrix}{F}_{{CH}_{4} , out} + 2 \times {F}_{{C}_{2} {H}_{2} + {C}_{2} {H}_{4} , out} + 6 \times \\ {F}_{{C}_{6} {H}_{6} , out} + 7 \times {F}_{{C}_{7} {H}_{8} , out} + 10 \times {F}_{{C}_{10} {H}_{8} , out}\end{matrix}}{{F}_{{CH}_{4} , i n}} \times 100 \qquad ( 5 )$$

wherein F_{CH4,in/out} is the flow rate of OH₄ in the feed or effluent, F_{i,out} is the flow rate of product i in the effluent, nᵢ is the carbon number of the product i.

The H₂ selectivity is calculate by the formula: S_{H2}=F_{H2,out}/2F_{CH4,in}*100 N %

### Materials

The below table 1 lists a number of examples of carbon and non-carbon materials that can be applied in a catalyst composition for use in a process of the invention. Where applicable, reference to the below examples was made. The indicated parameters can be determined with the methods as given in the method section above.

TABLE 1

| | | | | Micropore | | | |
|---|---|---|---|---|---|---|---|
| | | | BET | surface | Pore | Pore size | |
| | | Material | SSA | area | volume | distribution | Used in |
| Material | Available from | form | (m²/g) | (m²/g) | (ml/g) | (nm) | Example |
| GF | Final Advanced | | 2.25 | nd | 0.005 | 6 | 4; 6; 7 |
| (Graphite felt) | Material | | | | | | |
| MESOC + 1 | SICAT | Extrudates | 232 | 160 | 0.21 | 41 | 1; 4; 9 |
| | (SD0246B1B2W) | (1 × 2 mm) | | | | | |
| MESOC + 3 | SICAT | Extrudates | 304 | 182 | 0.15 | 30 | |
| | (SD0231A1A2W) | (3 × 4 mm) | | | | | |
| AC | NORIT RX3 | | 1624 | 548 | 0.33 | 3 | |
| (Activated | | | | | | | |
| carbon) | | | | | | | |
| Carbon fabric | ECC (NORIT | 204 g · m² | 0.45 | nd | 0.001 | nd | 5 |
| | RX3190230-5) | (Tenax ® | | | | | |
| | | HTA 40 / | | | | | |
| | | 200 tex | | | | | |
| | | (3k)) | | | | | |
| Gamma-Al₂O₃ | Akzo Nobel | Alumina | 234 | 10 | 0.9 | 10 | 7 |
| | (Ketjen CK- | extrudates/ | | | | | |
| | 300B) | Milling & | | | | | |
| | | Sieving 0.2- | | | | | |
| | | 0.8 mm | | | | | |
| Zetex+ | Final Advanced | 1 mm × 2.5 | 0.2 | nd | 0.0005 | nd | 5; 6 |
| | Material | mm × L | | | | | |
| | (ZetexPlus ®) | mm | | | | | |
| FLG | Blackleaf | Graphene | below | nd | 0.13 | 18 | 4; 9 |
| | | 20 g/L in | 30 | | | | |
| | | water | | | | | |
| H-ZSM5 | Zeolyst ™ (CBV | | 463 | 368 | 0.06 | 5.1 | |
| | 3024E CY (1.6)) | | | | | | |

| | | | | | | |
|---|---|---|---|---|---|---|
| Zetex + @FLG | as prepared in example 8 | 0.41 | nd | 0.0015 | 20 | 8 |

Nd = not determined

### Example 1: Decomposition of Methane into Hydrogen and Carbon Using a Porous Carbon Catalyst Heated by Induction

The present example illustrates catalytic decomposition of a reaction gas consisting of methane into hydrogen and carbon in the presence of a porous carbon catalyst.

### Catalyst Composition:

In the present example the reaction was carried out over a catalyst bed consisting of a porous carbon catalyst. The catalyst used in this experiment was MESOC+1, provided in the form of extruded carbon components (carbon extrudates), having a diameter of 1 mm and an average length of 2 mm (i.e. aspect ratio of 2:1). Properties of this catalyst are reported in Table 1.

### Reaction Conditions

The following reaction conditions were applied in this example: catalyst weight was 4 g; methane flux was 60 mL/min, (pure methane); gas hourly spatial velocity (GHSV) was 900 mL/g_{c}/h; 1 Bar; contact time t_{contact} was 6.7 s. Induction heating: the reaction temperature during this example varied between 60° and 800° C.

### Results 1^{st} Experiment:

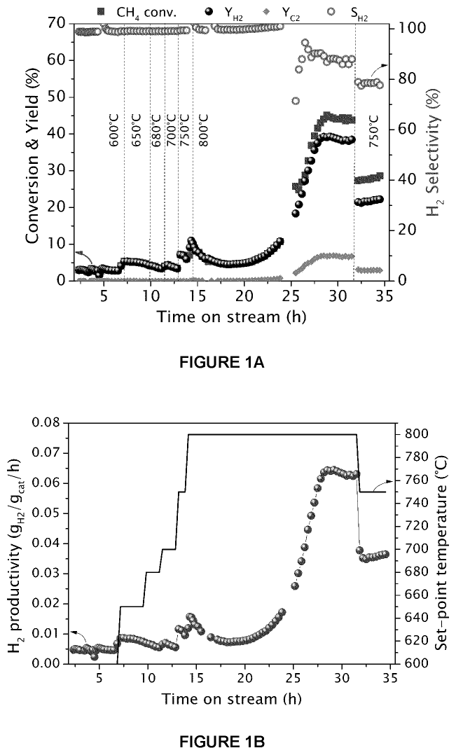

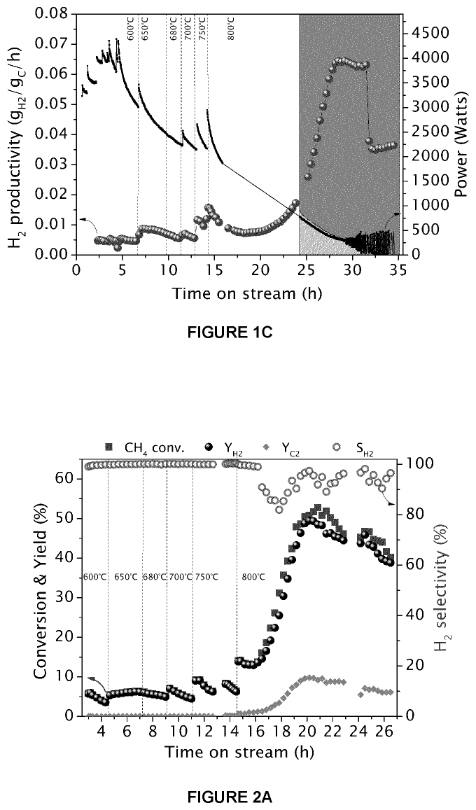

A first experiment was carried out. The decomposition reaction took place for at least 35 hours in this experiment. Results indicate that the decomposition of methane increased with temperature (see FIGS. 1A and B). For all temperatures tested in this example, hydrogen selectivity was greater than 80%. A fraction of C₂ hydrocarbons, containing ethane, ethylene, and traces of acetylene, of around 5-10% is observed at a reaction temperature of 800° C.

When the reaction temperature was increased from 750° C. to 800° C., methane conversion increased slightly to about 14% and then decreased monotonically for about 6 h, up to about 6% conversion, before initiating a slow rise for about 8 hours to reach a methane conversion of about 45% (FIGS. 1A and B). The conversion remained stable at 45% and at 800° C. for about 4 hours. When reducing the temperature to 750° C., it may be observed that methane conversion also decreased, from about 45% to about 25%, but nevertheless remained stable, and there was even a tendency to further increase during the 3 h reaction at 750° C.

FIG. 1C illustrates that as the conversion reaction progressed the power supplied by the induction heating device decreased with time on stream, despite the fact that the reaction temperature remained unchanged.

### Results 2^{nd} Experiment:

A second experiment was carried out under the same conditions as reported above for the first experiment.

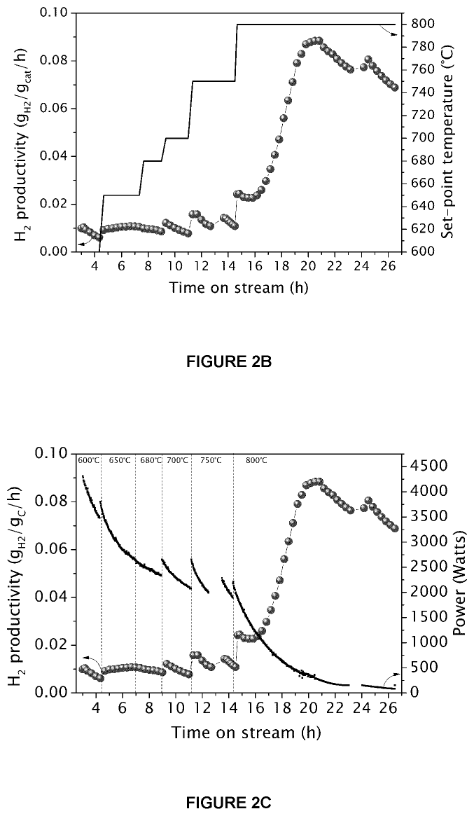

The results of the decomposition process are presented in FIG. 2. FIG. 2 illustrates a decrease in methane conversion followed by a slow activation of the catalyst at 800° C. to achieve a methane conversion rate of about of about 55% after about 5 hours (see FIGS. 2A and B). Methane conversion remained stable for a few hours and then decreased gradually from 55% to 42% after about 7 hours of testing. Hydrogen selectivity remained extremely high at about 95±2% during the experiment.

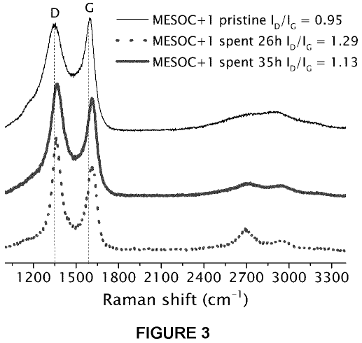

Raman spectra are presented in FIG. 3. Both of the spent catalysts (obtained in experiments 1 (35 h) and 2 (26 h)) exhibited a more graphitic behavior with a lower contribution of amorphous carbon. Graphitization is determined by the ratio in intensity of peak D (peak resulting from defects) to peak G (graphite). The o/I_{G} ratio increased for the spent catalysts (1.29 and 1.13 vs 0.95), with a profile of narrower and sharper peaks, showing that the deposited carbon was more crystallized.

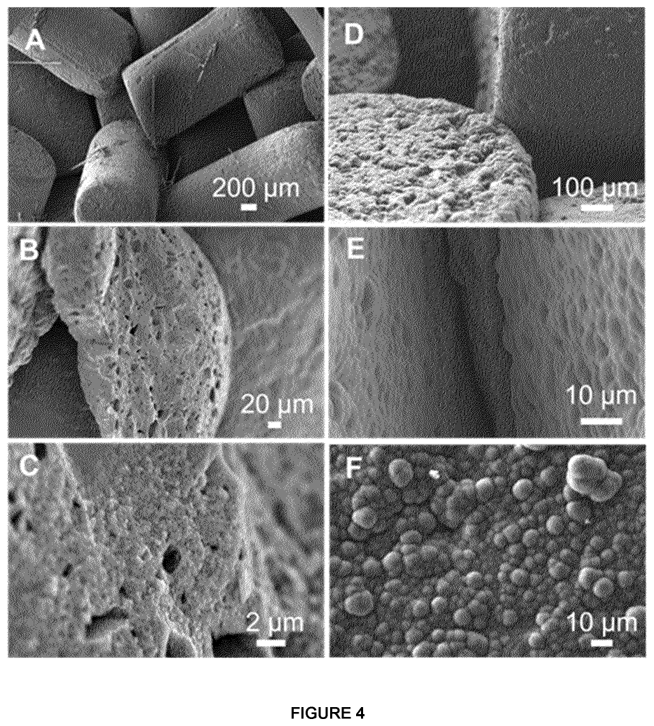

SEM analyses were performed on the spent carbon-based catalyst obtained after catalytic methane decomposition at 800° C. FIG. 4 (A) represents a low-resolution SEM image showing spent catalyst components (extruded carbon components) which are linked to each other by solid carbon “junctions” deposited thereon during the decomposition reaction. FIG. 4 (B and C) shows solid carbon structures deposited on the surface of the spent catalyst. FIG. 4 (D to F) are SEM images of a section of the spent catalyst (extruded component) showing a structure which is different from the structure of the solid carbon deposited on the surface of the catalyst during the reaction. The SEM images thus showed that solid carbon was deposited in different forms on the porous catalyst used in the present example. FIG. 4A shows that solid carbon that was deposited during the reaction induced the formation of “junction points” between carbon extrudates of the spent catalyst. This type of “junction” deposits improve the transfer heat throughout the catalytic bed and consequently permit to reduce the energy required to maintain the catalyst at the desired reaction temperature. SEM images provided in FIGS. 4B and C show the morphology of solid carbon deposited during the decomposition reaction on the surface of the spent catalyst, and shows that the morphology of these deposits is different from that observed inside the spent carbon extrudates (see FIGS. 4 D-F).

Summarised, the above example shows that the use of a porous carbon catalyst presented a high catalytic activity and selectivity towards hydrogen production. The example also demonstrates the formation of carbonaceous species (carbon) during the decomposition reaction, and the deposition thereof, in different morphologies, on the carbon catalyst.

The above experiments showed that during the reaction in the presence of methane at 800° C. carbon was gradually deposited on the surface of the catalyst. First a decrease in catalytic activity as a function of time was observed. After a certain amount of carbon has been deposited on the catalyst, it was observed that the nature of the deposition was modified, by the formation of structural defects in the catalyst matrix and/or by the appearance of a microstructures that are particularly suitable to adsorb methane, resulting in a catalytic active phase for the direct conversion/decomposition of methane into solid carbon and hydrogen. It is surprising that after catalytic deactivation for several hours, the catalyst re-gains activity, inducing an increase in methane decomposition from about 5% to 45% or more.

The deposition of carbon during the reaction leads to a decrease in power provided by the induction heating device and necessary to heat the catalyst bed to the desired reaction temperature. FIG. 1C shows that as from 800° C., the energy required for the reaction amount to about 7.1% of the total energy to produce 73% of total obtained hydrogen (the grey frame). It was found by the Applicants that during catalytic decomposition of methane, energy required for the reaction is directly related to the amount of carbon deposited on the catalyst, and therefore, the more carbon deposited, which is a secondary product of the decomposition of methane into hydrogen, the lower amount of external energy is needed to keep the catalyst at a required reaction temperature. In contrast, in catalytic systems wherein heating is provided by joule effect, the amount of carbon deposits formed on the used catalyst do not influence or have any reducing effect on power supply necessary to maintain the operating temperature. In other words, the methane decomposition reaction operated in accordance with the present invention by induction heating, enables to provide a particularly energy-efficient reactor configuration. The Applicants have shown that there is a direct and positive relationship between the amount of carbon deposited on the catalyst, and catalytic activity for the decomposition of methane into carbon and hydrogen. The makes it possible to operate the decomposition process with less and less energy over time (as the deposits increase) which significantly lowers the carbon footprint of the process.

The experiments provided above illustrate that carbon deposited during the direct decomposition of methane increases the amount of catalytically active material in the induction loop and thus contributes to a better heating efficiency of the catalytic bed. This results in a decrease in the power delivered by the inductor as the reaction progresses while maintaining the reaction temperature invariant, thus reducing the overall energy costs of the process. Based on the above experiments, it was observed that during the reaction in the presence of methane at 800° C., carbon is gradually deposited on the surface of the used catalyst composition. It was observed that first carbon deposits, at 800° C., were not fully reactive, and thus lead to a decrease in catalytic activity as a function of time. However, over time, the nature of the carbon deposits was modified, e.g. by the formation of structural defects in the catalyst matrix, or by the appearance of a new microstructures that are particularly suitable to adsorb methane, thus resulting in a new carbon-based catalytically active phase for the direct decomposition of methane into solid carbon and hydrogen. These results are surprising and unexpected, as a skilled person would not expect that after catalytic deactivation over a certain period of time, catalytic activity is re-activated and a new active catalytic phase is reached, with even improved activity as compared to the initial activity, in the present example going from a methane conversion of about 5% to about 45%, or even more.

### Example 2: Decomposition of Methane Using a Spent Porous Carbon-Based Catalyst

The present example illustrates catalytic decomposition of a reaction gas consisting of methane into hydrogen and carbon in the presence of a spent catalyst. The catalyst used in this example was recovered after the first methane decomposition experiment as carried out in above example 1 (this is catalyst denoted as “R0”).

The spent catalyst obtained in example 1 was collected and carbon extrudates of the spent catalyst, that were sticking to one another after the experiment of example 1 due to deposited solid carbon, were mechanically separated from one another. This recycled catalyst was denoted catalyst R1. The R1 catalyst had a BET surface area of about 14 m²/g, an average pore size of about 12 nm; and a pore volume of about 0.066 ml/g.

### Experiment Using Catalyst R1

Catalyst R1 was applied and same reaction conditions as those described in Example 1 were applied: i.e. R1 catalyst weight was 4 g; methane flux was 60 mL/min, (pure methane); gas hourly spatial velocity (GHSV) was 900 mL/g/h; 1 Bar; contact time t_{contact} was 6.7 s. In this example, the R1 catalyst was heated by induction heating at reaction temperatures that varied between 60° and 800° C.

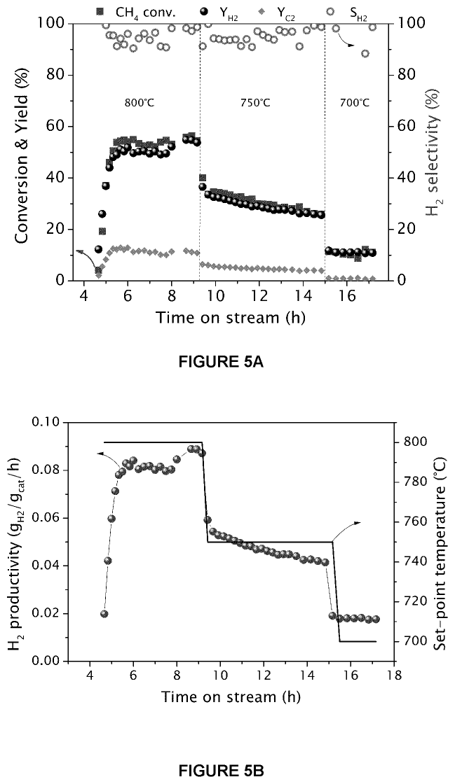

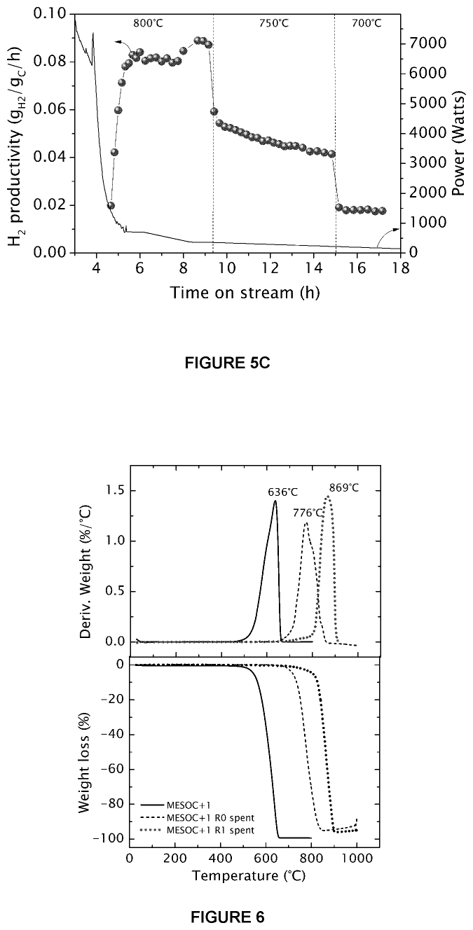

Results obtained with regenerated catalyst R1 are presented in FIGS. 5A and B, in which the different parameters indicative for catalytic performance are plotted as a function of reaction temperature and the time on stream.

R1 displayed an increase in catalytic activity for decomposing methane over time to 800° C., and reaches a decomposition level of around 55% at 800° C. Similar as in example 1, also when using a spent catalyst it was observed that solid carbon, resulting from the decomposition of methane, was deposited on the catalyst surface. These results illustrate the particular advantages of a process according to the present invention from several points of view:
(1) the spent catalyst, having carbon deposited on its surface, can again be used as a carbon catalyst in a process for hydrocarbon (methane) conversion/decomposition reaction. The present example showed that a spent porous catalyst, having solid carbon deposited on its surface, retains its catalytic activity, and may be re-used as a carbon catalyst in a hydrocarbon decomposition process. The spent catalyst derived from R1 had a BET surface area of 5 m²/g, an average pore size of 8 nm; and a total pore volume of 0.017 ml/g.
(2) the use of spent carbon catalysts represents a significant process saving, because it omits the need to supply fresh catalyst, and thus reduces the costs associated with the process. In the present example the power supplied by the induction heating device sharply decreased with time on stream (see FIG. 5C).

Thermogravimetric analysis under air are presented in FIG. 6 and showed a shift of the combustion peaks towards higher temperatures for the pristine R0 (MESOC+1 mm), the spent R0 and spent R1 catalysts. The deposited carbon is more graphitic and its combustion occurs at a higher temperature (+100° C.) than that of the initial porous carbon catalyst applied in this example.

### Example 3: Decomposition of Methane Using a Spent Porous Carbon-Based Catalyst

The present example illustrates catalytic decomposition of a reaction gas consisting of methane into hydrogen and carbon in the presence of a spent catalyst. The spent catalyst used in this example was recovered after the first methane decomposition experiment as carried out in above example 1 (this is spent catalyst R0).

Spent catalyst obtained in example 1 was grinded and sieved to recover a fraction of grains with sizes between 0.2 and 0.8 mm. This recycled catalyst was denoted catalyst R2. This catalyst has a BET surface area of about 6 m²/g, an average pore size of about 7 nm; and a total pore volume of 0.026 ml/g.

### Experiment Using Catalyst R2

In the present experiment, catalyst R2 was applied and the same reaction conditions as those described in Example 1 were applied: i.e. R2 catalyst weight of 4 g; methane flux of 60 mL/min (pure methane); gas hourly spatial velocity (GHSV) of 900 mL/g/h; 1 bar; contact time t_{contact} of 6.7 s. In this example, the R2 catalyst was heated by induction heating at reaction temperatures that varied between 60° and 780° C.

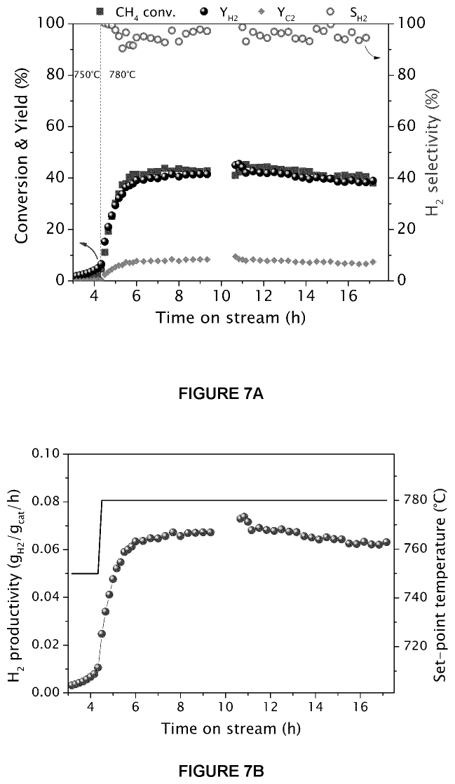

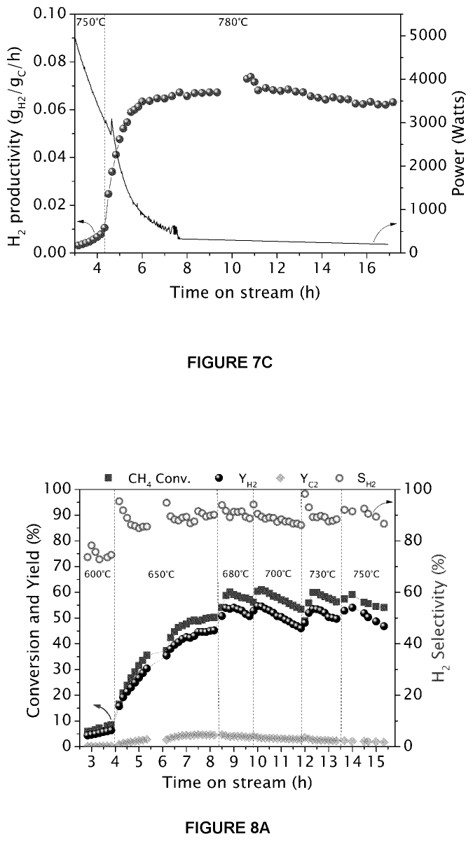

Results obtained with regenerated catalyst R2 are presented in FIGS. 7A and 7B, in which the different parameters indicative for catalytic performance are plotted as a function of reaction temperature and the time on stream.

Spent catalyst R2 displayed an increase in catalytic activity for decomposing methane over time at 750° C., which further increase at 780° C. and reached a decomposition level of around 43%±3%. Similar as in examples 1 and 2, when using this a spent catalyst it was observed that solid carbon, resulting from the decomposition of methane, was deposited on a part of the surface of the catalyst surface. In addition thereto, the spent R2 catalyst also contains carbon from the original catalyst which is now exposed externally after crushing.

The present results are important from several points of view: (1) the spent catalyst with carbon deposited on the surface can again be used as a “fresh” carbon catalyst for in a decomposition reaction of methane. These results also confirm that a mixture of original carbon catalyst with solid carbon deposited on the original catalyst during the reaction forms an active catalyst for the methane decomposition reaction, (2) the results also show that it is possible to re-use in a process according to the invention a spent porous carbon catalysts that have simply been recycled, e.g. by crushing. This represents a significant cost saving for a process according to the invention, as it limits the need for supply of fresh carbon catalyst for carrying out a process of the invention. Moreover, crushing is feasible on an industrial scale and can be performed by methods that are well-known by the skilled person, for example jet-milling, grinding, etc.

In the present example the power supplied by the induction heating device sharply decreased with time on stream (see FIG. 7C). Moreover, results showed that the decomposition reaction using spent R2 carried out at 780° C. was very stable; giving a decomposition level that was maintained for about 12 hours of testing at about 43±3%, and yielding an extremely high hydrogen selectivity of about 96±2%. The R2 spent catalyst has a BET surface area of 0.38 m²/g, an average pore size of 5.8 nm; a total pore volume lower than 0.001 ml/g.

### Example 4: Decomposition of Methane Using Catalyst Composition Combining a Non-Porous Carbon Catalyst with a Porous Carbon Catalyst

The present example illustrates the direct decomposition of methane into hydrogen and solid carbon in the presence of a catalyst composition wherein a non-porous carbon catalyst is used in combination with a porous carbon catalyst.

### Catalyst Composition:

The catalyst composition applied in this example consisted of:
a non-porous carbon catalyst, provided in a first catalyst bed, and consisting of a graphite felt, provided in enrolled form (with diameter of 24 mm, thickness of 13 mm, weight of 0.6 g). Properties of this GF catalyst are indicated in Table 1; and
a porous carbon catalyst, provided in a second catalyst bed, and consisting of mesoporous carbon (grains of 0.2-0.8 mm, weight of 2 g)) covered with 2% of few layer graphene (FLG—obtained from Blackleaf) by impregnation from a suspension 20 g/L in water. The resulting catalyst has a BET surface area of 291 m²/g, an average pore size of 2 nm; and a total pore volume of 0.15 ml/g.

This example therefore illustrates the use of a catalyst composition according to the invention which combines a non-porous carbon catalyst (here a graphite felt) provided in a first (upstream) catalyst bed and a impregnated porous carbon catalyst, as provided a second (downstream) bed. In accordance with the process of the invention, the methane gas is first passed over the first catalyst bed, in which methane is converted into C₂₊ hydrocarbons, such as C₂ to C₁₀ hydrocarbons, and when subsequently passing over the second catalytic bed, the hydrocarbons formed in the first bed are further converted into hydrogen. Solid carbon was deposited on both catalysts during the decomposition reaction.

### Reaction Conditions:

The following reaction conditions were applied in this example: 0.6 g of non porous catalyst in first bed, porous catalyst in second bed: 2 g; methane flux of 60 mL/min (pure methane); gas hourly spatial velocity (GHSV) of 900 mL/g_{c}/h, 1 bar. Induction heating: the reaction temperature during this example varied between 60° and 750° C.

### Results:

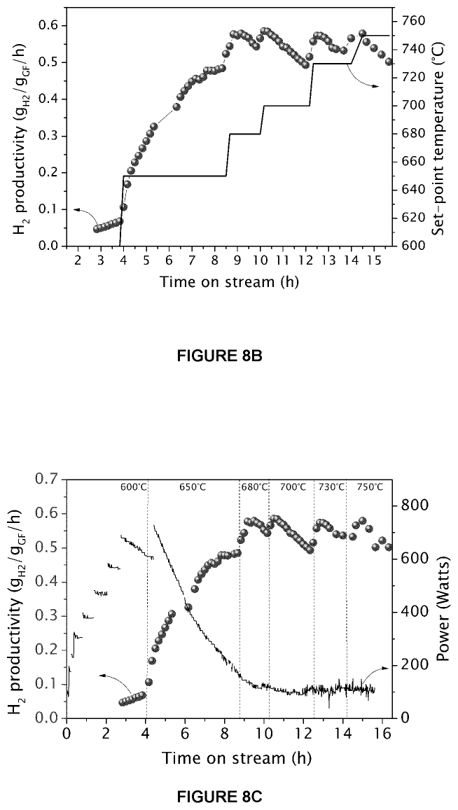

The catalytic activity of the two catalysts arranged in “staged arrangement” in accordance with this example, showed a methane decomposition rate of about 48%. In addition, the catalyst composition as applied in the present example showed good stability in terms of conversion, i.e. being around 45-50% after 7 hours of testing (FIGS. 8A and 8B). Hydrogen selectivity reached about 90%. The high hydrogen decomposition and selectivity level obtained in the present example confirms that there was a combined action of the two carbon catalysts (i.e. the non-porous followed by porous catalyst) for the decomposition of methane.

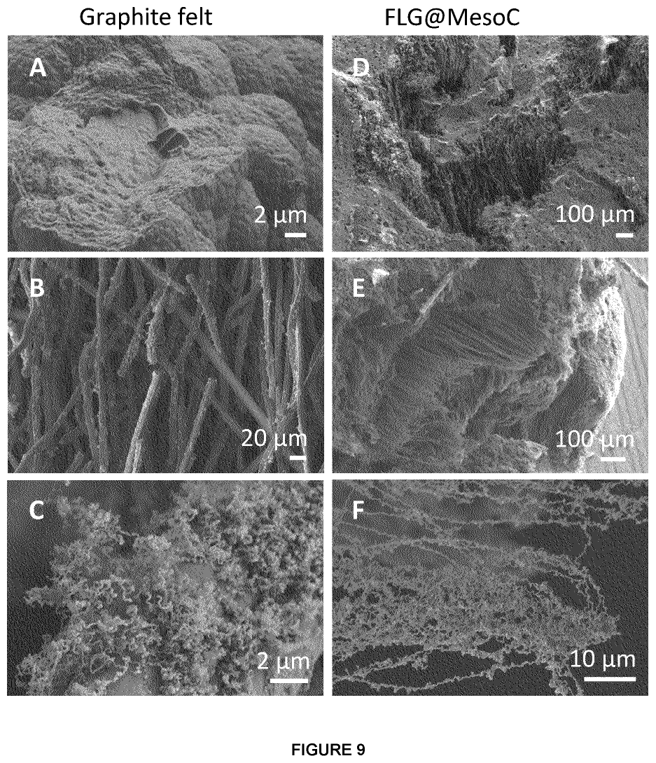

SEM images shown in FIG. 9 were taken on both spent catalysts. The images showed that solid carbon was deposited on both catalysts, i.e. the non-porous graphite felt catalyst, and the porous carbon catalyst, e.g. as a layer of carbon deposit surrounding the initial catalyst structure, or as carbon nanofilaments (CNF, with diameters between 50-200 nm). The SEM images in FIG. 9A-C show that the surface of the spent graphite felt catalyst is covered either by layers of graphite or that carbon nanofilaments are formed on its surface. The SEM images in FIG. 9D-F show the formation of long microfilaments (several tens of micrometers) of graphite that were deposited on the surface of the porous catalyst applied in the second catalyst bed. The formation of long graphite microfilaments on the porous catalyst, applied in a catalyst composition according to the invention, was also observed on the porous catalyst as applied in example 9 of the present invention (see further below).

### Example 5: Decomposition of Methane Using Catalyst Composition Combining a Non-Porous Carbon Catalyst with a Ceramic Support Material

The present example illustrates the direct decomposition (conversion) of methane into hydrogen and solid carbon in the presence of a catalyst composition combining a non-porous carbon catalyst and a ceramic support material.

### Catalyst Composition:

The catalyst composition applied in this example consisted of:
a carbon fabric (a non-porous carbon catalyst; also named graphite fabric herein) having BET surface area of 0.45 m²/g, an average pore size lower than 6 mm, and a total pore volume of 0.001 ml/g, with a thickness of 25 mm, weight of 1.6 g; and
a “quartz-based fabric” (Zetex+, see Table 1) (a non-porous support material) with BET surface area of 0.2 m²/g, an average pore size of <10 nm; total pore volume of 0.0005 ml/g, thickness of this fabric was 25 mm.

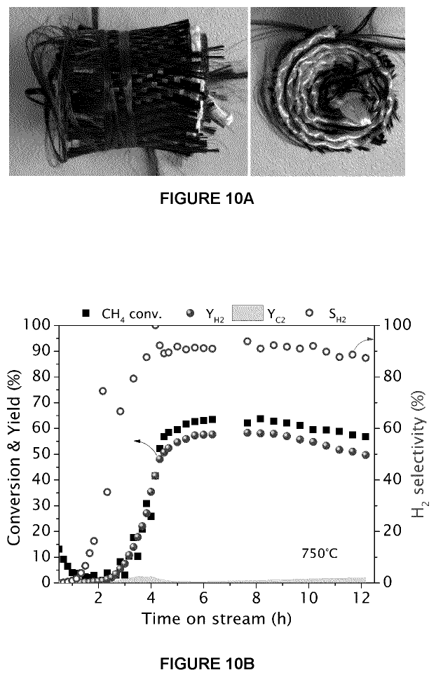

The catalyst bed applied in the present invention comprised a catalyst composition that was prepared by wrapping a layer of said graphite fabric with a quartz-based fabric (Zetex+). Depending on how both fabric materials are wrapped, the carbon fabric layer (i.e. the graphite fabric) can be exposed either to the outside or to the inside. The digital photographs of the obtained catalyst composition are shown in FIG. 10A. The graphite fabric was wrapped outside (see photo in FIG. 10A).

### Reaction Conditions:

The following reaction conditions were applied in this example: weight of catalyst based on graphite fabric of 1.6 g; weight of the insulation of 10 g; methane flux of 24 mL/min, pure methane gas hourly spatial velocity (GHSV) of 900 mL/g_{c}/h, 1 bar. Induction heating: the reaction temperature during this example was 750° C.

### Results:

The catalyst composition of this example was evaluated for methane decomposition under a gradual increase of the reaction temperature, and under pure methane flux. Results obtained showed that decomposition of methane slightly increased over time for each of the tested temperatures.

The catalytic activity in the decomposition of methane into hydrogen and carbon is shown in FIG. 10B in function of reaction time at a temperature of 750° C. Catalytic activity increased over time to reach a maximum followed by a slow decrease up to 12 h of reaction (FIG. 10B. Hydrogen selectivity increases with increasing catalytic activity and then remained relatively stable at about 90% throughout the experiment. It was also observed that methane decomposition was stable under reaction flow at 750° C. for at least 8 hours of testing (see FIG. 10B).

The specific production of H₂ obtained using the catalyst composition of this example was of the order of 0.09 g hydrogen /g_{c}/h at 750° C. The slope of the specific hydrogen production obtained between 8 to 12 hours of reaction allowed to estimate that the deactivation period for the catalyst composition applied in this example was of the order of about 30 hours. Reactant products that were formed at reaction zone output mainly consisted of hydrogen (about 93±5%) and a small fraction of C₂ hydrocarbons (less than about 5% at 750° C.).

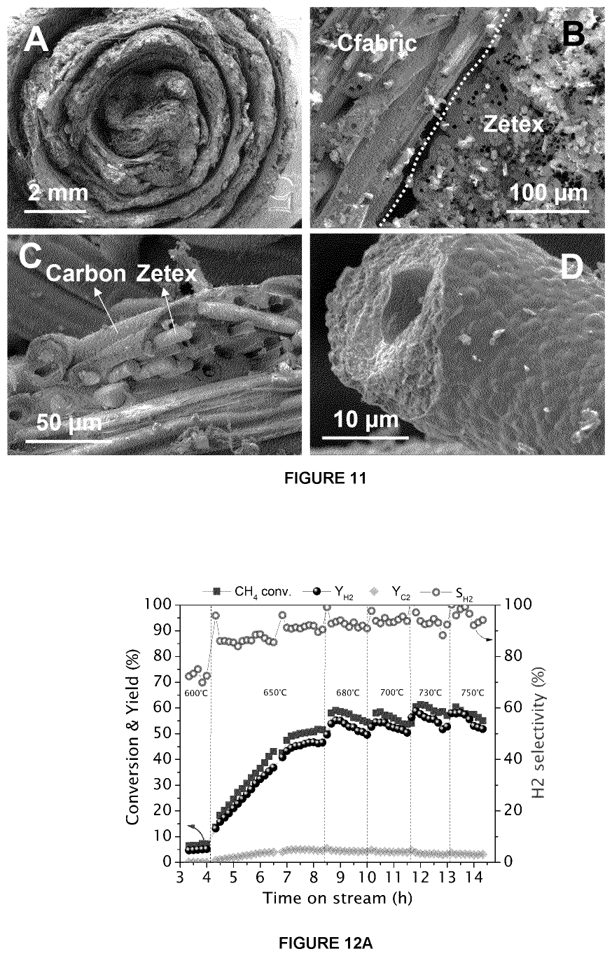

SEM images (FIG. 11) taken on the spent catalyst composition showed that solid carbon was deposited on the two materials, i.e. on the graphite fabric and on the quartz-based fabric (Zetex+), in the form of a layered deposit surrounding the starting material (FIG. 11A). The deposited carbon layer varied depending on the starting material: it consisted of a deposited carbon layer of about 2 to 5 μm on graphite fabric filaments (FIG. 11B) and was thicker on the quartz-based fabric (FIG. 11B-C). FIG. 11D shows a nodule-like morphology of the carbon layer deposited on the Zetex+ material.

These results confirm the possibility of depositing carbon formed during the decomposition of methane on a ceramic material (here, a quartz-based fabric). The deposition on such ceramic material reduces the deposition on the carbon fabric, which advantageously allows to extend the life of the carbon catalyst.

The catalyst arrangement as applied in the present example allowed the presence of a layer of inert material (Zetex fabric) to be present between two layers of the carbon catalyst (graphite fabric), and such layers of inert material were able to “harvest” at least a part of the carbon produced during methane conversion, and thus to reduce deactivation of the carbon catalyst.

Similar methane decomposition results were obtained when the graphite fabric was wrapped with the Zetex fabric layer in order to be exposed at the outside or at the inside of the catalyst composition, indicating that in both cases an improvement of methane decomposition reaction was obtained by alternating the carbon catalyst with a support material, the latter being capable of storing deposited carbon.

SEM analyses indicated that the microstructure of carbon deposition was different depending on the starting material. In the present example, a layered structure was observed on the graphite fabric (acting as conductive material), and a structure or nanoparticles were observed on the support material (Zetex).

These differences may be due to the fact that on the graphite fabric, carbon deposition originated from the direct decomposition of methane at a higher temperature (the carbon catalyst acts as a conductive material); while carbon deposition formed on the support fabric originated from heavier hydrocarbons formed during the decomposition at lower temperatures (the support material acts as insulating substrate). The deposition of carbon on the support fabric led to the formation of a second type of carbon structure, i.e., a filamentous carbon structure, thereby increasing the number of (catalytically) active sites and consequently increasing the activity and stability of the overall catalyst composition.

### Example 6: Decomposition of Methane Using Catalyst Composition Combining a Non-Porous Carbon Catalyst (Graphite Felt) with a Ceramic Support Material (Zetex+ Fabric)

The present example illustrates the direct decomposition (conversion) of methane into hydrogen and carbon in the presence of a catalyst composition combining a non-porous carbon catalyst and a ceramic support material.

### Catalyst Composition:

The catalyst composition applied in this example consisted of:
1. graphite felt (of non-porous carbon catalyst) having a BET surface area of 2.25 m²/g, an average pore size of 6 nm; pore volume of 0.005 ml/g (see Table 1), thickness of 25 mm, and
2. a “quartz-based fabric” (Zetex+, see Table 1) with thickness of this fabric of 25 mm.

The catalyst bed applied in the present invention comprised a catalyst composition that was prepared by wrapping said graphite felt with said quartz-based fabric. Depending on how both materials are wrapped, the graphite felt can be exposed either to the outside or to the inside of the resulting catalyst composition. In the below example the graphite felt is at the outside or at the inside after wrapping.

### Reaction Conditions:

The following reaction conditions were applied in this example: weight of catalyst based on graphite felt was 0.63 g, weight of the porous ceramic material: 6.5 g, methane flux of 63 mL/min, pure methane gas hourly spatial velocity (GHSV) of 6000 mL/g_{c}/h, 1 bar. Induction heating: the reaction temperature during this example varied between 50° and 750° C.

### Results:

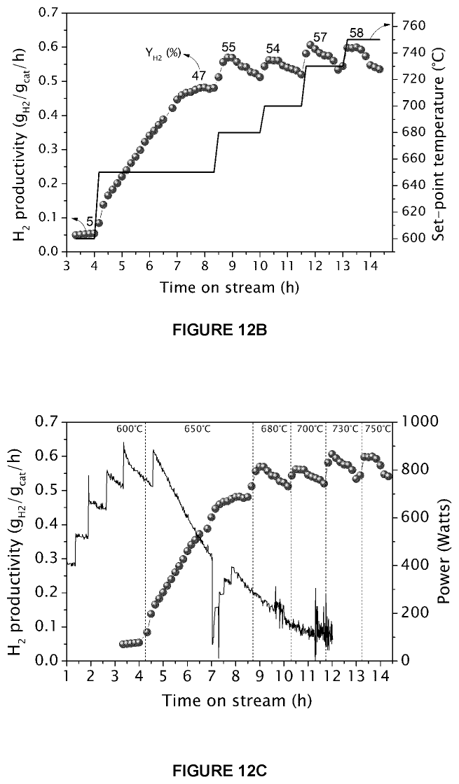

The catalyst composition was activated slowly from 500° C. onwards and achieved a methane decomposition yield of about 52% at 650° C. (FIGS. 12A and 12B). A temperature increase between 680° C. and 750° C. made it possible to maintain a methane decomposition yield of about 55-60%. Hydrogen selectivity for the catalyst composition used in this example was quite high, and of the order of about 87% at 650° C. and about 95% at 750° C. (FIGS. 12A and 12B).

FIG. 12C illustrates that the power supplied by the induction heating device to heat the catalyst decreased with time on stream. The decreased power during the reaction is inversely proportional to the amount of carbon deposited on the surface of the catalyst applied in this example.

### Example 7: Decomposition of Methane Using Catalyst Composition Combining a Non-Porous Carbon Catalyst (Graphite Felt) with a Porous Ceramic Material (Gamma-Al₂O₃ Grains)

The present example illustrates the direct decomposition of methane into hydrogen and solid carbon in the presence of a catalyst composition consisting of a combination of a non-porous carbon catalyst and a porous ceramic material.

### Catalyst Composition

The catalyst composition applied in this example consisted of:
a first non-porous carbon catalyst, provided in a first catalyst bed, and consisting of a graphite felt (see Table 1), provided in enrolled form (with diameter of 24 mm, thickness of 13 mm, weight was 0.66 g), and
porous material consisting of gamma-Al₂O₃ particles (see Table 1 for properties), provided in a second catalyst bed, and having a grain size of 0.2-0.8 mm and weight of 2 g.

This example therefore illustrates the use of a catalyst composition according to the invention which combines a non-porous carbon catalyst (here a graphite felt) provided in a first (upstream) catalyst bed and a ceramic (aluminum based) material (here gamma-Al₂O₃ grains), provided in a second (downstream) catalyst bed. In accordance with the process of the invention, the methane gas was first passed over the first catalyst bed, in which methane was converted into C₂₊ hydrocarbons, such as C₂ to C₁₀ hydrocarbons, and when subsequently passing over the second catalytic bed, the second bed made it possible to adsorb at least a part of hydrocarbons formed in the first bed, and then converted these into deposited solid carbon and hydrogen. It may be noted that solid carbon was deposited on both materials during the decomposition reaction.

### Reaction Conditions:

The following reaction conditions were applied in this example: non-porous graphite felt in first bed was 0.66 g, gamma-Al₂O₃ particles in second bed: 2 g, methane flux was 66 mL/min (pure methane), gas hourly spatial velocity (GHSV) of 6000 mL/g_{c}/h, 1 bar. Induction heating: the reaction temperature during this example varied between 60° and 750° C.

It is noted that reaction temperature was fixed in relation to the first catalyst bed, i.e. graphite felt provided in enrolled (coil) form, while the temperature measured in the second catalytic bed, comprising alumina grains as defined above, was lower, given the fact that aluminum is not heated by induction.

### Results

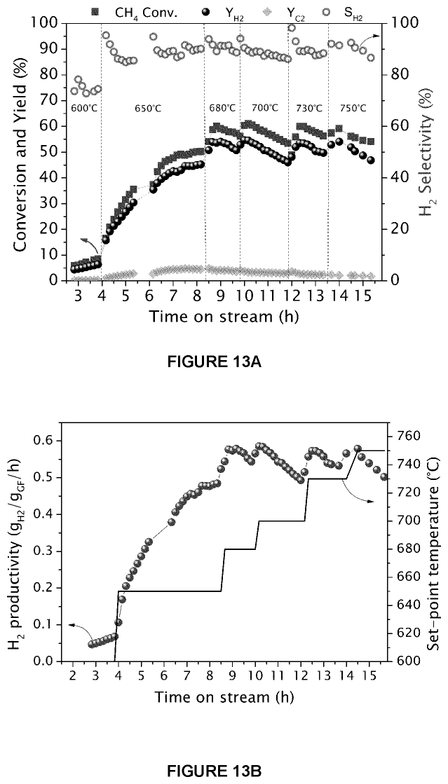

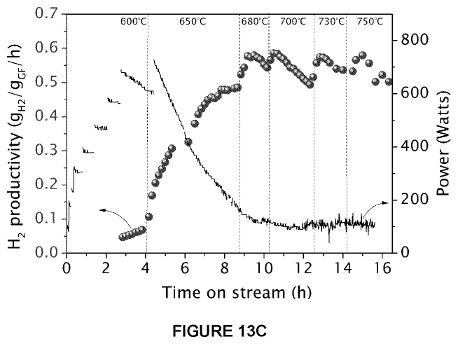

The results in terms of methane decomposition and selectivity to hydrogen are presented in FIG. 13. Low catalytic activity was observed at 600° C., and then increased with increasing reaction temperature (FIGS. 13A and 13B). When the reaction temperature was set at 650° C. there was a gradual increase in the decomposition of methane as a function of time to reach a decomposition yield of about 65% (hydrogen production of the order of 0.6 g H₂/g_{c}/h). Catalytic activity decreased slightly over time to reach a methane decomposition yield of about 52% after about 10 h of reaction (see FIG. 13A). When the temperature was raised again, from 650° C. to 680° C., methane decomposition and hydrogen production increased followed again by a slow decrease as a function of time. The same pattern was observed when the reaction temperature was increased to 700° C. Hydrogen selectivity for reaction temperatures between 650° C. and 700° C. was relatively high, and in the range of about 88 to 90%. FIG. 13C illustrates that the power supplied by the induction heating device to heat the catalyst composition in this example decreased with time on stream. The decreased power during the reaction is inversely proportional to the amount of carbon deposited on the surface of the catalyst applied in this example.

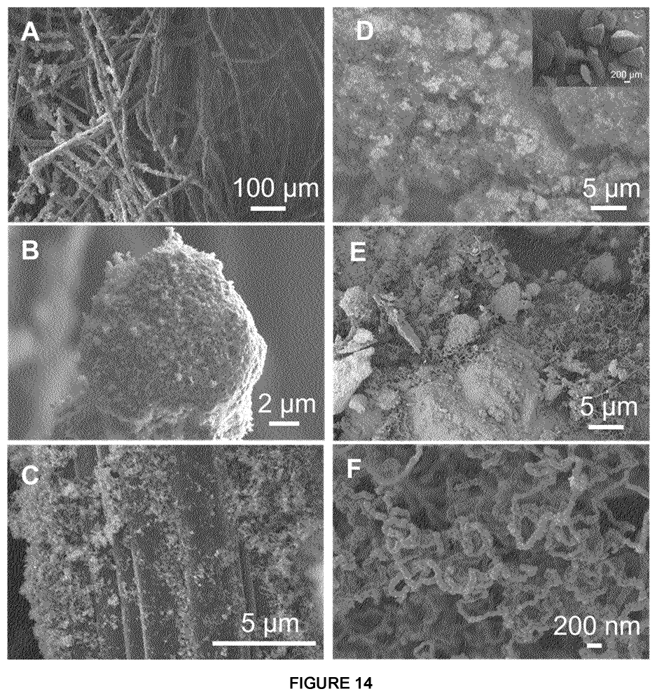

Analyses by scanning electron microscopy on the two catalyst beds, graphite felt and alumina grains, are shown in FIG. 14. FIG. 14A-C are SEM images taken of the spent graphite felt as applied in the first catalyst bed, while FIG. 14D-F are SEM images taken of the spent alumina-based grains as applied in the second catalyst bed. Images of the microfilaments of the graphite felt applied in the first bed show that carbon was deposited in the form of filaments on the surface of the felt. There was little graphite wrapped around the filaments of the spent graphite felt (FIG. 14A-C). The SEM images of the alumina grains, on the other hand, showed the formation of small fibrous structures (FIG. 14D-F) which point to an adsorption of hydrocarbons with more than one carbon atom, followed by decomposition thereof into carbon and hydrogen.

### Example 8: Decomposition of Methane Using a Ceramic Support Material (Zetex+) Impregnated with a Non-Porous Catalyst as Catalyst Composition

The present example illustrates the decomposition of methane into hydrogen and solid carbon in the presence of a catalyst composition involving a fabric support material that was impregnated with graphene.

### Catalyst Composition:

In the present example a catalyst bed comprising graphene-impregnated “quartz-based insulation fabric” (Zetex+).

The “few-layer-graphene material” (“FLG” obtained from Blackleaf—see Table 1) (weight of 0.2 g) was impregnated on 10 g Zetex+(2 wt %) from a suspension, and the catalyst has a BET surface area of 0.41 m²/g, an average pore size of 20 nm; total pore volume of 0.0015 ml/g. The quartz-based insulation fabric” (Zetex+—see Table 1) is an inert material that can be obtained from Final Advanced Material.

Few layer graphene was deposited on the surface of the Zetex+ fabric as follows: a few layer graphene suspension (20 g/L) was deposited by impregnation on the Zetex+ fabric followed by a heat treatment at 130° C. for 2 hours in an oven. The dried solid was wound on itself to form a cylinder that will then be inserted into the quartz tubular reactor for carrying out the reaction.

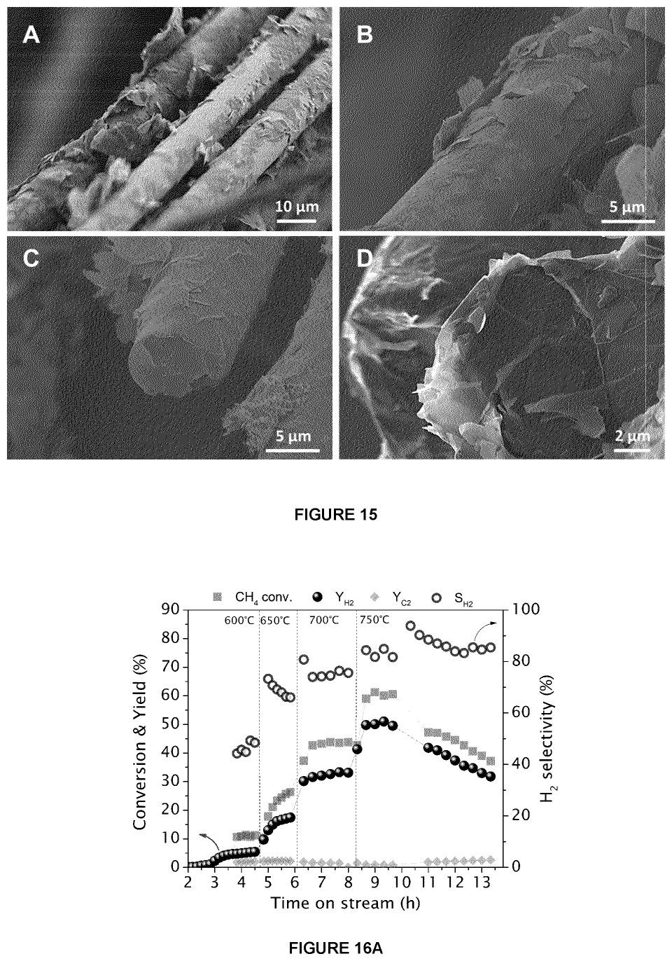

FIG. 15 represents SEM analyses of the catalyst composition as prepared and applied in example 8. These SEM images show that graphene was deposited mainly around the Zetex+ fibers after impregnation and heat treatment at 130° C. in the oven. The low-resolution SEM image (FIG. 15A) shows that the graphene sheets cover the fibers of the Zetex+ fabric in a relatively homogeneous manner. Part of the graphene is also found between the inter-fiber free spaces. Medium and high-resolution images confirm that graphene sheets cover the fibers of the fabric (see FIG. 15B-D). It is also noted in FIG. 15D that the graphene sheets were not plated on the fiber but form defects (“arrets et bordures”) around the fibers.

Deposition of the graphene on the inert fabric increased electrical and thermal conductivity of the inert material (quartz-based fabric), which allowed electromagnetic heating of the catalytic bed. The graphene material was mainly deposited around quartz fibers (see FIG. 15) such that a structure similar to that of carbon filaments forming a graphite felt or graphite fabric is obtained. It was also found that a small amount of graphene deposited on the surface of the inert quartz-based fabric allowed to reduce carbon footprint of the overall catalyst, as energy required to heat the catalytic bed was inversely proportional to the amount of graphene sheets that were deposited.

### Reaction Conditions:

The following reaction conditions were applied in this example: few layers graphene: 0.2 g, quartz-based insulation fabric: 10 g; methane flux of 24.5 mL/min (pure methane); gas hourly spatial velocity (GHSV) of 7350 mL/g_{c}/h, 1 bar. Induction heating: the reaction temperature during this example varied between 50° and 750° C.

### Results

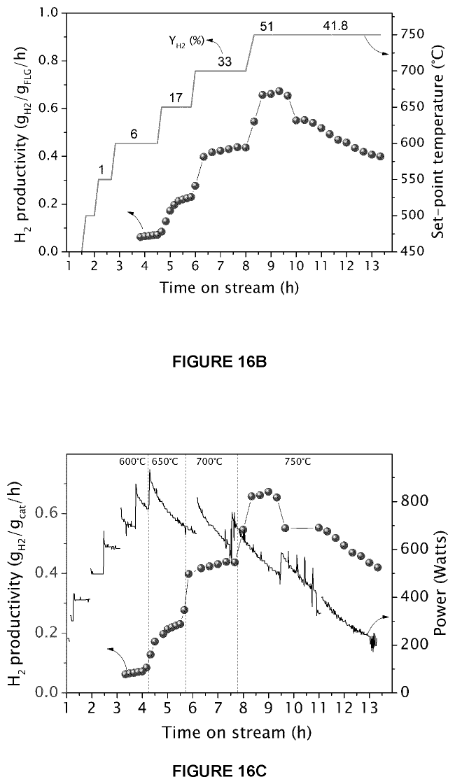

Results obtained as a function of reaction temperature and reaction time are shown in FIG. 16A-C. Methane decomposition reaction started at around 600° C. and then increased with increasing temperatures to reach about 60% decomposition value at 750° C. The level of about 60% at 750° C. remained stable for about 1 h reaction time and then slowed decreased with increasing reaction times to reach a value of about 33% after 13 hours of decomposition reaction. Hydrogen selectivity increased with temperature to reach a maximum value of about 85% at 750° C.

The power supplied by the induction heating device as a function of methane decomposition and reaction time is shown in FIG. 16C. The results indicated that the power supplied gradually decreased during the experiment, going from a maximum value of 950 W for a reaction temperature of 650° C. to about 200 W for a reaction temperature of 750° C. after 13 hours of decomposition reaction. This change in the power supply during the example was explained by the fact that as the reaction progresses, more solid carbon was deposited on the surface of the catalyst and as a result, the amount of carbon in the induction loop was increased. The combination of these two features resulted in a decrease in the power supply needed for carrying out the reaction. The deposited solid carbon not only increased the amount of carbon, a susceptor material, available to convert magnetic radiation into heat, but also created junction points between carbonaceous structures in the catalyst, thereby promoting the circulation of induced currents, that were at the origin of the generated heat.

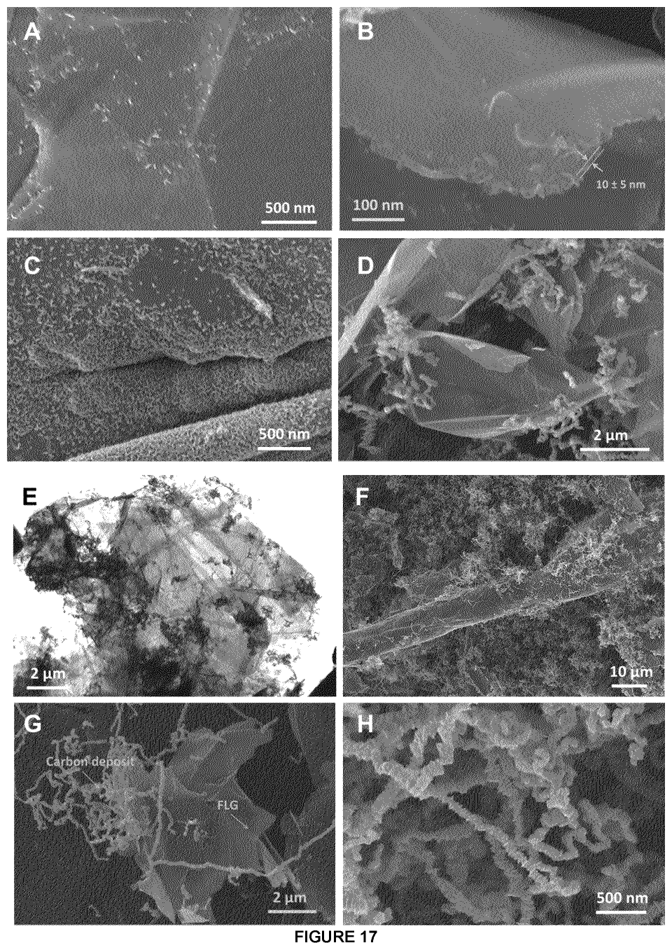

FIG. 17A-C are scanning electron microscopy images of the spent catalyst as applied in the present example, showing the formation of nuclei on the edges of graphene sheets. FIG. 17D-F are scanning microscopy images showing the formation of carbon nanofibers from graphene sheets. FIG. 17G-H are SEM images showing the formation of carbon nanofibers and the microstructure of these nanofibers on the spent catalyst. After the methane decomposition reaction, the graphene sheets were either covered with nuclei on the edges of the sheets or with carbon deposits in the form of nanofibers of about 50 to 100 nm in diameter. The decomposition reaction started at the borders of the graphene sheets (also denoted FLG herein) which explains the formation of the germs at the edges of the sheets (see FIG. 17A-C). As the reaction progressed, carbon was deposited from these germs and took the form of nanofibers, as was observed on the surface of the graphene sheets in the catalyst (see FIG. 17D-F). High-resolution SEM images showed that the nanofibers consisted of a carbon plaques that are connected to one another and stacked onto each other (see FIG. 17G-H).

It was further found that on the few layer graphene-based catalyst as applied in this example, carbon deposits on the spent catalyst, e.g. in the form of nanofibers, could be at least partly recovered by ultrasonic treatment. The nanofiber structure obtained on the graphene sheets was recovered from the spent either in a sonication bath or by a “tip ultrasonication”. Results indicated that the obtained carbon is hydrophobic, preferring less hydrophilic solvents, e.g. propanol-2. No quartz fiber was found; only nanofiber/FLG was dispersed in the obtained suspension. Quartz fibers are larger in diameter (D of about 10 μm) so they remained in solid form, and can be separated by recovering the supernatant only. The SEM analysis of the solid of this suspension showed that a composite of nanofibers was randomly deposited above the graphene sheets.

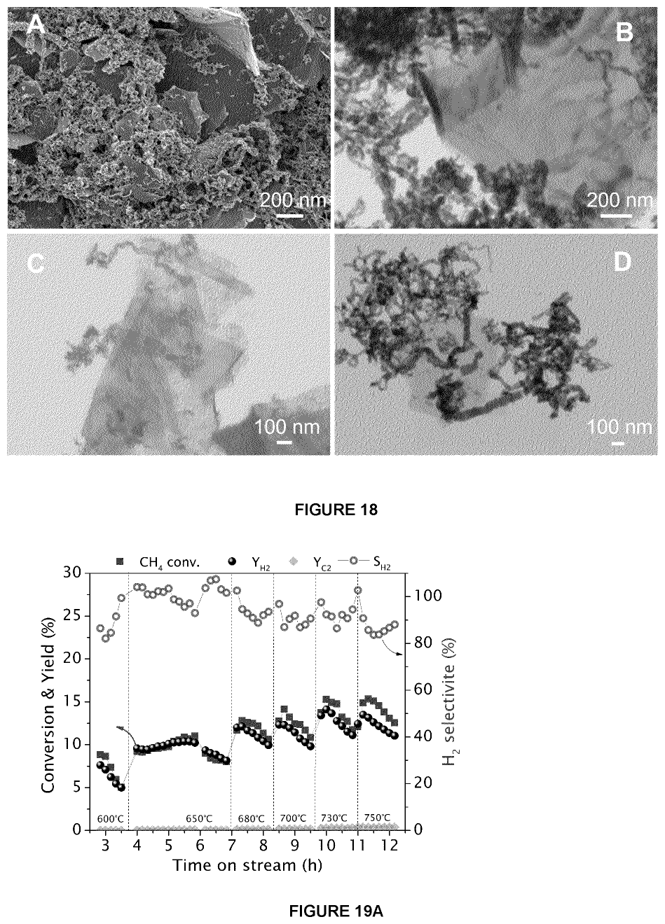

FIG. 18 A-D represent scanning electron microscopy images of solid fragments recovered after ultrasonic treatment of the spent catalyst used in this example 8 showing the presence of multi-sheet graphene residues decorated with carbon nanofibers that were generated during the methane decomposition reaction.

### Example 9: Decomposition of Methane Using a Porous Carbon Catalyst Impregnated with Graphene

The present example illustrates the decomposition of methane into hydrogen and solid carbon in the presence of a catalyst composition involving a porous carbon catalyst that was impregnated with graphene.

### Catalyst Composition:

In the present example a catalyst bed comprising graphene-impregnated mesoporous carbon grains was used.

The mesoporous carbon grains consisted of mesoporous carbon MESOC+(grains of 0.2-0.8 mm, weight was 4 g) obtained from SICAT, (BET surface area was 234 m²/g, an average pore size of was 41 nm; pore volume was 0.21 ml/g). The graphene material (weight was 0.08 g) was impregnated on this MESOC+ as follows: 2 mL of the FLG suspension (20 g/L, obtained from Blackleaf) were dropped on 4 g of MESOC+(0.2-0.8 mm) then the solid was heating at 130° C. for 2 h. A second impregnation was repeated in the same way. The BET surface of this resulting catalyst was 291 m²/g, an average pore size of 2 nm; total pore volume was 0.15 ml/g.

### Reaction Conditions:

The following reaction conditions were applied in this example: non-porous graphene: 0.08 g, mesoporous carbon grains: 4 g; methane flux was 60 mL/min (pure methane); gas hourly spatial velocity (GHSV) was 900 mL/g_{c}/h; 1 bar. Induction heating: the reaction temperature during this example varied between 50° and 750° C.

### Results

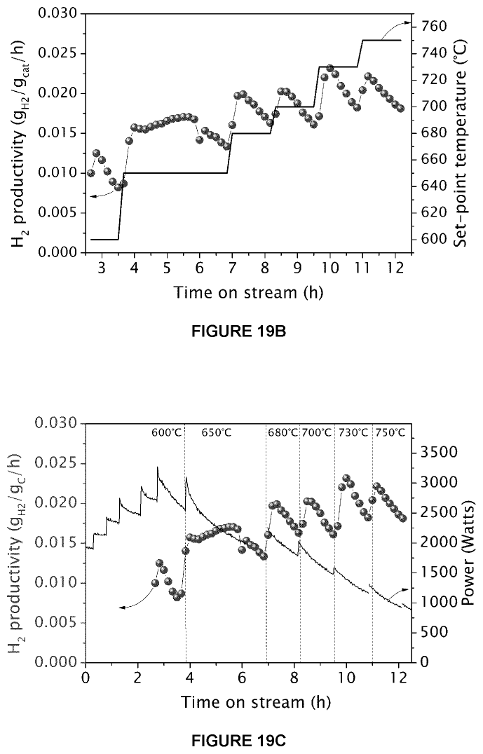

The results in terms of methane decomposition and selectivity to hydrogen are presented in FIG. 19. The presence of graphene on the mesoporous carbon grains improved heating of the catalytic bed to the desired temperature. The methane decomposition reaction, carried out over the catalyst bed of this example, yielded hydrogen and solid carbon, as well as some C₂ to C₁₀ hydrocarbons. At a reaction temperature of 650° C., methane decomposition increased slowly during the reaction time at this temperature (see FIGS. 16A and B), indicating that a certain level of catalytic activity during methane decomposition originates from solid carbon deposited on the catalyst during the reaction. This example further illustrated that catalytic activity, expressed in terms of methane conversion, further slightly increased when the reaction temperature was increased from 650° C. to 750° C. (FIGS. 19A and 19B). The pattern of the power supplied by the induction heating device as a function of methane decomposition and reaction time is shown in FIG. 19C. The pattern observed for the power supply indicated that as the reaction progressed, more solid carbon was deposited on the surface of the catalyst and as a result, the amount of carbon in the induction loop was also increased.

This example illustrates that a graphene-impregnated porous catalyst as applied in the present example may be used as active catalyst in a methane decomposition process. During the reaction, a solid carbon phase was deposited on the catalyst. The catalyst applied in this example was able to adsorb methane and to decompose (convert) the methane into carbon and hydrogen.

1. A process for the production of hydrogen, carbon and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, wherein the process comprises the steps of:
a) supplying a catalyst composition to a reaction zone, wherein said catalyst composition comprises at least one carbon catalyst;
b) heating said catalyst composition in said reaction zone to a temperature comprised between 500° C. and 1100° C., by means of induction heating;
c) activating said heated catalyst composition by bringing said heated catalyst composition into contact with said reaction gas during an activation period of at least 5 hours, and
d) decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time.

2. Process according to claim 1, wherein said catalyst composition is heated by generating an alternating electromagnetic field within the reaction zone containing said catalyst composition upon energization by a power source supplying alternating current, where the alternating electromagnetic field passes through the reaction zone thereby generating an electric current in said catalyst composition and heating the catalyst composition.

3. Process according to claim 1, wherein the catalyst composition comprises at least one carbon catalyst having a BET surface area of at most 2500 m²/g, such as at most 2000 m²/g, or at most 1750 m²/g, or at most 1000 m²/g, or between 0.1 and 2000 m²/g, or between 0.1 and 1000 m²/g, or between 0.1 and 700 m²/g, as determined by ASTM-D-3663 (2020).

4. Process according to claim 1, wherein the catalyst composition comprises:
(I) a first component, wherein said first component is selected from one or more non-porous carbon catalysts and/or one or more porous carbon catalysts; and
(II) optionally, a second component, wherein said second component consists of a non-carbon material, and preferably is a ceramic or zeolitic support material.

5. Process according to claim 4, wherein said non-porous carbon catalyst has a BET surface area of at most 5.0 m²/g, such as from 0.10 to 5.0 m²/g, or from 0.5 to 3.0 m²/g, such as from 1.0 to 5.0 m²/g, or from 1.0 to 3.0 m²/g, as determined by ASTM-D-3663 (2020).

6. Process according to claim 4, wherein said porous carbon catalyst has a BET surface area of more than 5.0 m²/g, such as from 10.0 to 2000 m²/g, or from 10.0 to 1000 m²/g, or from 100 to 700 m²/g, or from 200 to 600 m²/g, as determined by ASTM-D-3663 (2020).

7. Process according to claim 4, wherein said non-carbon material, and preferably said ceramic or zeolitic support material, has a BET surface area of at most 2000 m²/g, or at most 1000 m²/g, or between 0.1 and 1000 m²/g, or between 0.1 and 700 m²/g, or between 0.1 and 600 m²/g, or between 0.1 and 500 m²/g, or between 5.0 and 300, or between 50.0 and 600 m²/g, as determined by ASTM-D-3663 (2020).

8. Process according to claim 4, wherein said non-porous carbon catalyst is selected from the group consisting of graphite (G), carbon felt (CF), graphite felt (GF), expanded graphite (EG), carbon fabric, graphite fabric, carbon cloth, graphite cloth, graphene, and any combinations thereof.

9. Process according to claim 1, wherein said porous carbon catalyst is selected from the group consisting of mesoporous carbon, carbon black, acetylene black, active carbon, carbon nanofiber (CNF), carbon nanotubes (CNTs), and any combinations thereof.

10. Process according to claim 4, wherein non-carbon material is selected from the group consisting of zeolites, silicon carbide, silica, quartz, silica wool, quartz wool, and zirconia.

11. Process according to claim 1, further comprising the step of supplying a susceptor material to said reaction zone comprising said catalyst composition, wherein said susceptor material, is capable of responding to an electromagnetic field by generating heat, and is capable of transferring said heat to said catalyst composition, and preferably wherein said susceptor material is physically separated from said catalyst composition.

12. Process according to claim 1, comprising the further steps of
e) recovering at least a portion of said catalyst composition from said reaction zone after step c) and/or step d), thereby obtaining a spent catalyst, and
f) optionally supplying the spent catalyst as catalyst composition to step a) of said process.

13. Process according to claim 12, wherein the spent catalyst is mechanically treated to reduce the size of the spent catalyst before supply thereof to step a) of said process.

14. Process according to claim 12, wherein the spent catalyst is not heated before supply thereof to step a) of said process.

15. A process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
a) supplying a spent catalyst to a reaction zone, wherein said spent catalyst comprises at least one carbon catalyst;
b) heating said spent catalyst in said reaction zone to a temperature comprised between 500° C. and 1100° C. by means of induction heating; and
c) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone,
preferably wherein the spent catalyst supplied in step a) is prepared by carrying out a process according to claim 12.

16. A process for the production of hydrogen and carbon, and optionally hydrocarbons such as C₂₊ hydrocarbon(s), by catalytic non-oxidative decomposition of a reaction gas comprising a hydrocarbon or mixtures thereof, such as a saturated C₁₊ hydrocarbon or mixtures thereof, in the presence of a spent catalyst, wherein the process comprises the steps of:
a) preparing a spent catalyst by a preparation process comprising the steps of:
a1) supplying a catalyst composition to a reaction zone, wherein said catalyst composition comprises at least one carbon catalyst;
a2) heating said catalyst composition in said reaction zone to a temperature comprised between 500° C. and 1100° C. by means of induction heating;
a3) activating said heated catalyst composition by bringing said heated catalyst composition into contact with said reaction gas during an activation period of at least 5 hours,
a4) optionally decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time, and
a5) recovering at least a portion of the catalyst composition from said reaction zone after step a3) and/or a4), thereby obtaining a spent catalyst, and optionally subjecting the spent catalyst to a mechanical treatment to reduce the size of the spent catalyst, and
b) supplying the spent catalyst to a reaction zone;
c) heating the spent catalyst in the reaction zone by means of induction heating to a temperature comprised between 500° C. and 1100° C.; and
d) decomposing a reaction gas comprising a hydrocarbon or mixtures thereof, such as a saturated C₁₊ hydrocarbon or mixtures thereof, into hydrogen, carbon, and optionally hydrocarbons such as C₂₊ hydrocarbon(s), by bringing said reaction gas into contact with said heated spent catalyst composition in said reaction zone.

17. Process according to claim 16, wherein the catalyst composition as supplied in step a1) comprises at least one carbon catalyst.

18. Process according to claim 16, wherein the spent catalyst is prepared by carrying out a process that comprises the steps of:
a) supplying a catalyst composition to a reaction zone, wherein said catalyst composition comprises at least one carbon catalyst;
b) heating said catalyst composition in said reaction zone to a temperature comprised between 500° C. and 1100° C., by means of induction heating;
c) activating said heated catalyst composition by bringing said heated catalyst composition into contact with said reaction gas during an activation period of at least 5 hours,
d) decomposing said reaction gas into hydrogen, carbon, and optionally hydrocarbons such as C₂₊ hydrocarbon(s), by bringing said reaction gas into contact with said heated and activated catalyst composition in said reaction zone during a suitable period of time,
e) recovering at least a portion of said catalyst composition from said reaction zone after step c) and/or step d), thereby obtaining a spent catalyst, and
f) optionally supplying the spent catalyst as catalyst composition to step a) of said process.

19. Process according to claim 16, wherein the process involves a further step e) comprising the removal of the spent catalyst from the reaction zone after step d), treatment of the removed spent catalyst to reduce the size thereof, and re-supply of the treated spent catalyst to step b) of said process, and preferably said further step e) is repeated more than once.

20. Process according to claim 1, wherein said reaction gas comprises at least 80.0 mol %, such as at least 85.0 mol %, or at least 90.0 mol %, or at least 99.0 mol % of methane.

21. Process according to claim 1, wherein the reaction zone(s) consists of one or more fixed bed reactors.

22. Spent catalyst obtained or obtainable by carrying out a process according to claim 12.

23. Spent catalyst according to claim 22, wherein said spent catalyst is metal-free.

24. Spent catalyst according to claim 22, wherein the spent catalyst has a BET surface area of between 0.1 and 100 m²/g, preferably of between 0.1 and 50 m²/g, as determined by ASTM-D-3663 (2020).

25. Spent catalyst according to claim 22, wherein the spent catalyst has a Raman spectrum, as determined by Raman Spectroscopy using an excitation wavelength of about 532 nm and exciting laser power of about 100 milliwatt (mW); showing a first peak (D peak) at a wavenumber of about 1350 cm⁻¹ and a second peak (G peak) at a wavenumber from about 1585 to about 1600 cm⁻¹, and wherein said spent catalyst has a Raman coefficient I_{D}/I_{G} which is higher than 0.10, such as higher than 0.20 or higher than 0.30, wherein I_{D} corresponds to the intensity of the Raman spectrum in said D peak; and I_{G} corresponds to the intensity of the Raman spectrum in said G peak.

26. Use of a spent catalyst according to claim 22 as a carbon catalyst, preferably as a carbon catalyst in a catalytic non-oxidative hydrocarbon decomposition process for decomposing hydrocarbons, such as saturated C₁₊ hydrocarbons, into hydrogen and carbon, and optionally hydrocarbons such as C₂₊ hydrocarbon(s).

27. Use of a spent catalyst according to claim 22 as a catalyst supply in a process for the production of hydrogen and carbon, and optionally hydrocarbons such as C2+ hydrocarbon(s), by catalytic non-oxidative decomposition of a reaction gas comprising a hydrocarbon or mixtures thereof, such as a saturated C1+ hydrocarbon or mixtures thereof, in the presence of a spent catalyst.
